(19) United States
(12) Patent Application Publication
(10) Pub. No.: US 2026/0112365 A1
(43) Pub. Date: Apr. 23, 2026

(54) ELECTRONIC DEVICE RESPONDING TO USER UTTERANCE, OPERATION METHOD THEREOF, AND RECORDING MEDIUM

(71) Applicant: Samsung Electronics Co., Ltd., Suwon-si (KR)

(72) Inventors: Wonkyu SUNG, Suwon-si (KR); Eunbi LEE, Suwon-si (KR); Jinwook CHUN, Suwon-si (KR); Jongil JEONG, Suwon-si (KR); Sunwoong HAM, Suwon-si (KR); Jungwoo LEE, Suwon-si (KR)

(21) Appl. No.: 19/285,610

(22) Filed: Jul. 30, 2025

Related U.S. Application Data
(63) Continuation of application No. PCT/KR2025/011244, filed on Jul. 29, 2025.

(30) Foreign Application Priority Data
Oct. 23, 2024 (KR) 10-2024-0145978
Nov. 25, 2024 (KR) 10-2024-0169997

(51) Int. Cl. G10L 15/22; G06F 3/01; G06T 7/246; G10L 15/25; H04N 23/60

(52) U.S. Cl. CPC G10L 15/22; G06F 3/013; G06F 3/017; G06T 7/246; G10L 15/25; H04N 23/64; G06T 2207/30201

(57) ABSTRACT

An electronic device is provided. The electronic device includes a housing configured to form an outer surface of the electronic device, a display disposed on a first surface of the housing, a camera disposed in a direction in which the display faces, a microphone, at least one processor including processing circuitry, and memory, comprising one or more storage media, storing instructions, wherein the instructions, when executed by the at least one processor individually or collectively, cause the electronic device to operate in a conversation mode in which a voice agent executed by the electronic device interacts with voice inputs received through the microphone, after receiving a first voice input, identify whether at least one condition for outputting a first response associated with the first voice input is satisfied, based on the at least one condition for outputting the first response being satisfied, output the first response associated with the first voice input, and based on the at least one condition for outputting the first response not being satisfied, receive a second voice input subsequent to the first voice input, instead of outputting the first response, wherein the at least one condition for outputting the first response includes identifying that a gaze of a user of the electronic device, obtained using the camera, moves toward a screen of the display.

### CROSS-REFERENCE TO RELATED APPLICATION(S)

This application is a continuation application, claiming priority under 35 U.S.C. § 365(c), of an International application No. PCT/KR2025/011244, filed on Jul. 29, 2025, which is based on and claims the benefit of a Korean patent application number 10-2024-0145978, filed on Oct. 23, 2024, in the Korean Intellectual Property Office, and of a Korean patent application number 10-2024-0169997, filed on Nov. 25, 2024, in the Koran Intellectual Property Office, the disclosure of each of which is incorporated by reference herein in its entirety.

### TECHNICAL FIELD

The disclosure relates to an electronic device responding to a user utterance, an operation method thereof, and a recording medium, according to an embodiment.

### BACKGROUND ART

With the rapid development of artificial intelligence (AI) technology, various AI agent applications or services are being developed and the related market is growing explosively. Beyond a large language model, AI is expected to be used infinitely in various areas of life, such as not only providing retrieved content, but also generating new content by combining existing data, or being trained with specialized knowledge in a specific field to act as a substitute for actual experts. A user may use an AI agent to obtain what the user wants through conversation. Therefore, this dramatically shortens the time it takes to install an application according to the existing user experience (UX) and find desired content in various applications or websites.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Problem

Aspects of the disclosure are to address at least the above-mentioned problems and/or disadvantages and to provide at least the advantages described below. Accordingly, an aspect of the disclosure is to provide an electronic device responding to a user utterance, an operation method thereof, and a recording medium.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes a housing configured to form an outer surface of the electronic device, a display disposed on a first surface of the housing, a camera disposed in a direction in which the display faces, a microphone, at least one processor including processing circuitry, and memory, comprising one or more storage media, storing instructions, wherein the instructions, when executed by the at least one processor individually or collectively, cause the electronic device to operate in a conversation mode in which a voice agent executed by the electronic device interacts with voice inputs received through the microphone, after receiving a first voice input, identify whether at least one condition for outputting a first response associated with the first voice input is satisfied, based on the at least one condition for outputting the first response being satisfied, output the first response associated with the first voice input, based on the at least one condition for outputting the first response not being satisfied, receive a second voice input subsequent to the first voice input, instead of outputting the first response, and wherein the at least one condition for outputting the first response includes identifying that a gaze of a user of the electronic device, obtained using the camera, moves toward a screen of the display.

In accordance with another aspect of the disclosure, a method performed by an electronic device is provided. The method includes operating in a conversation mode in which a voice agent executed by the electronic device interacts with voice inputs received through a microphone, after receiving a first voice input, identifying whether at least one condition for outputting a first response associated with the first voice input is satisfied, based on the at least one condition for outputting the first response being satisfied, outputting the first response associated with the first voice input, based on the at least one condition for outputting the first response not being satisfied, receiving a second voice input subsequent to the first voice input, instead of outputting the first response, wherein the at least one condition for outputting the first response includes identifying that a gaze of a user of the electronic device, obtained using a camera, moves toward a screen of a display.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include operating in a conversation mode in which a voice agent executed by the electronic device interacts with voice inputs received through a microphone, after receiving a first voice input, identifying whether at least one condition for outputting a first response associated with the first voice input is satisfied, based on the at least one condition for outputting the first response being satisfied, outputting the first response associated with the first voice input, based on the at least one condition for outputting the first response not being satisfied, receiving a second voice input subsequent to the first voice input, instead of outputting the first response, wherein the at least one condition for outputting the first response includes identifying that a gaze of a user of the electronic device, obtained using a camera, moves toward a screen of a display.

Other aspects, advantages, and salient features of the disclosure will become apparent to those skilled in the art from the following detailed description, which, taken in conjunction with the annexed drawings, discloses various embodiments of the disclosure.

### Advantageous Effects

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a block diagram of an electronic device according to an embodiment of the disclosure;

FIG. 2B is a diagram illustrating an electronic device according to an embodiment of the disclosure;

FIG. 2C is a diagram illustrating a generative artificial intelligence system according to an embodiment of the disclosure;

FIG. 3 is a diagram illustrating an operation of an electronic device according to an embodiment of the disclosure;

FIG. 4A is a flowchart of an operation method of an electronic device according to an embodiment of the disclosure;

FIG. 4B is a flowchart of an operation method of an electronic device according to an embodiment of the disclosure;

FIG. 4C is a flowchart of an operation method of an electronic device according to an embodiment of the disclosure;

FIG. 4D is a flowchart of an operation method of an electronic device according to an embodiment of the disclosure;

FIG. 4E is a flowchart of an operation method of an electronic device according to an embodiment of the disclosure;

FIG. 4F is a flowchart of an operation method of an electronic device according to an embodiment of the disclosure;

FIG. 5 is a flowchart of an operation method of an electronic device according to an embodiment of the disclosure;

FIG. 6 is a flowchart of an operation method of an electronic device according to an embodiment of the disclosure;

FIG. 7 is a flowchart of an operation method of an electronic device according to an embodiment of the disclosure;

FIG. 8 is a diagram illustrating an operation of an electronic device according to an embodiment of the disclosure;

FIG. 9 is a flowchart of an operation method of an electronic device according to an embodiment of the disclosure;

FIG. 10 is a flowchart of an operation method of an electronic device according to an embodiment of the disclosure;

FIG. 11 is a diagram illustrating an operation of an electronic device according to an embodiment of the disclosure;

FIG. 12 is a flowchart of an operation method of an electronic device according to an embodiment of the disclosure;

FIG. 13 is a diagram illustrating an operation of an electronic device according to an embodiment of the disclosure;

FIG. 14 is a diagram illustrating an operation of an electronic device according to an embodiment of the disclosure;

FIG. 15 is a diagram illustrating an operation of an electronic device according to an embodiment of the disclosure;

FIG. 16 is a flowchart of an operation method of an electronic device according to an embodiment of the disclosure;

FIG. 17 is a diagram illustrating an operation of an electronic device according to an embodiment of the disclosure;

FIG. 18 is a diagram illustrating an operation of an electronic device according to an embodiment of the disclosure;

FIG. 19 is a diagram illustrating an operation of an electronic device according to an embodiment of the disclosure;

FIG. 20 is a diagram illustrating an operation of an electronic device according to an embodiment of the disclosure;

FIG. 21 is a flowchart of an operation method of an electronic device according to an embodiment of the disclosure;

FIG. 22 is a diagram illustrating an operation of an electronic device according to an embodiment of the disclosure;

FIG. 23 is a flowchart of an operation method of an electronic device according to an embodiment of the disclosure;

FIG. 24 is a diagram illustrating an operation of an electronic device according to an embodiment of the disclosure;

FIG. 25 is a flowchart of an operation method of an electronic device according to an embodiment of the disclosure;

FIG. 26 is a diagram illustrating an operation of an electronic device according to an embodiment of the disclosure;

FIG. 27 is a diagram illustrating an operation of an electronic device according to an embodiment of the disclosure;

FIG. 28 is a flowchart of an operation method of an electronic device according to an embodiment of the disclosure;

FIG. 29 is a diagram illustrating an operation of an electronic device according to an embodiment of the disclosure;

FIG. 30 is a diagram illustrating an operation of an electronic device according to an embodiment of the disclosure;

FIG. 31 is a diagram illustrating an operation of an electronic device according to an embodiment of the disclosure;

FIG. 32 is a diagram illustrating an operation of an electronic device according to an embodiment of the disclosure; and

FIG. 33 is a diagram illustrating an operation of an electronic device according to an embodiment of the disclosure.

The same reference numerals are used to represent the same elements throughout the drawings.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

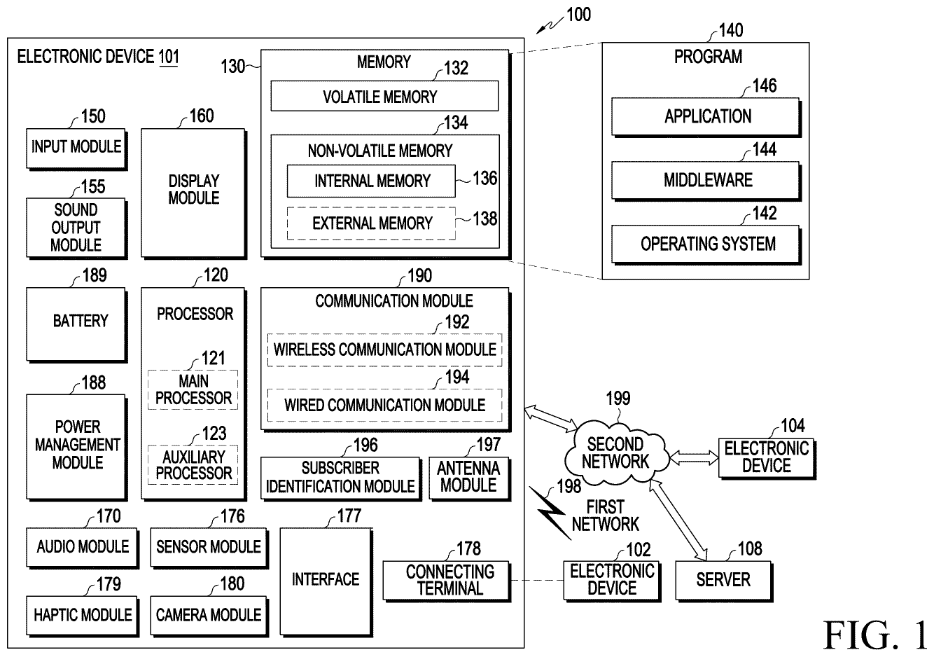

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. According to an embodiment, the sensor module 176 may include sensor circuitry. According to an embodiment, the sensor module 176 mat include a first, a second, or a third sensor. According to an embodiment, sensor circuitry may include a first, a second, or a third sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

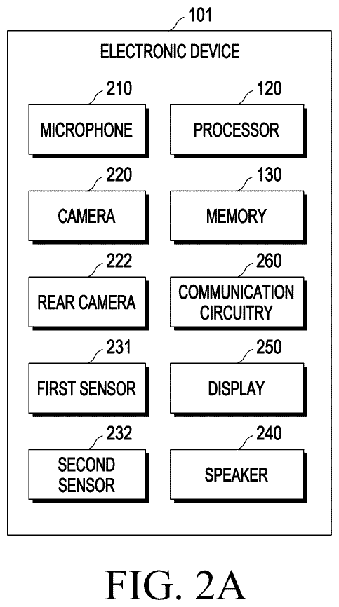

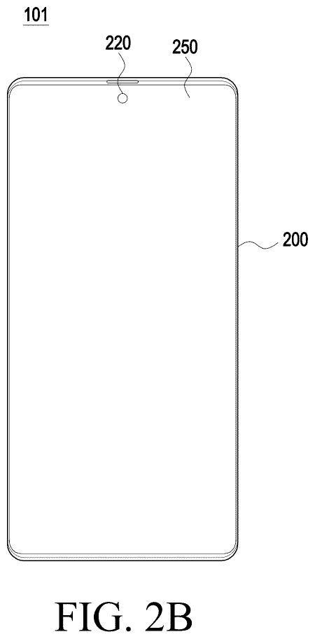

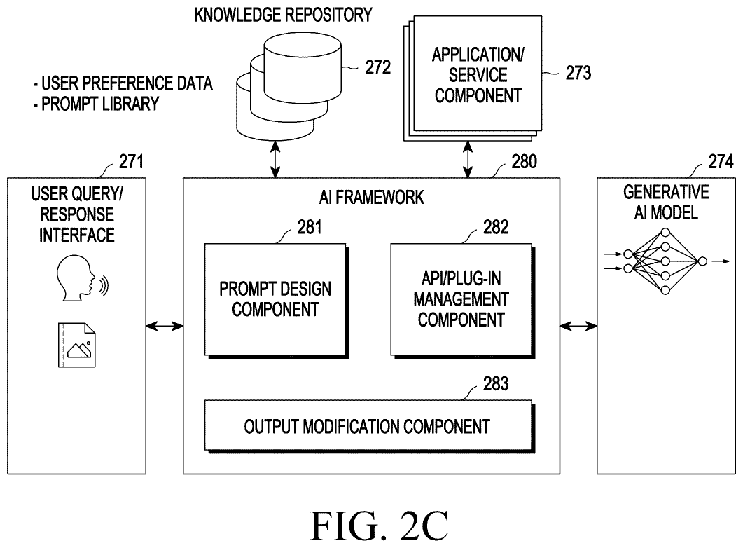

The operations of the electronic device 101 may be described in detail with reference to the above-described embodiments (e.g., the embodiments of FIG. 1) and the embodiments described below (e.g., the embodiments of FIGS. 2A to 2C, 3, 4A to 4F, and 5 to 33). Each of the embodiments is disclosed in a separate drawing and a separate paragraph, but this is only for the convenience of description, and at least some of the above-described embodiments and at least some of the embodiments described below may be applied together. At least some of the above-described embodiments and at least some of the embodiments described below may be omitted.

In this document, performing a specific operation by the electronic device 101 may mean that various hardware included in the electronic device 101, for example, the processor 120, such as a micro controlling unit (MCU), a field programmable gate array (FPGA), an application specific integrated circuit (ASIC), a microprocessor, or an application processor (AP), performs a specific operation. According to an embodiment, the processor 120 may include processing circuitry. Performing a specific operation by the electronic device 101 may mean that the processor 120 controls other hardware to perform a specific operation. Performing a specific operation by the electronic device 101 may also mean that at least one instruction stored in a storage circuit (e.g., the memory 130) of the electronic device 101 and configured to perform a specific operation is executed, thereby causing the processor 120 or other hardware to perform a specific operation. At least one instruction stored in the memory 130 of the electronic device 101, when executed by the processor 120 individually or collectively, may cause the electronic device 101 to perform at least one operation.

A function related to artificial intelligence according to the disclosure may be operated through the processor 120 and the memory 130. The processor 120 may be configured by one or more processors 120. In this case, the one or more processors 120 may be a general-purpose processor such as a CPU, an AP, or a digital signal processor (DSP), a graphics-dedicated processor such as a GPU or a vision processing unit (VPU), or an artificial intelligence-dedicated processor such as an NPU. The one or more processors 120 control input data to be processed according to an artificial intelligence model or a predefined operation rule stored in memory 130. Alternatively, if the one or more processors 120 are artificial intelligence-dedicated processors, the artificial intelligence-dedicated processors may be designed with a hardware structure specialized for processing a specific artificial intelligence model.

The predefined operation rule or the artificial intelligence model may refer to something that has been generated through training. Here, being generated through training means that a base artificial intelligence model is trained using multiple pieces of training data by a learning algorithm, so that a predefined operation rule or an artificial intelligence model configured to perform a desired characteristic (or objective) is generated. The artificial intelligence model may include a plurality of neural network layers. Each of the plurality of neural network layers has a plurality of weight values, and performs a neural network operation through the operation between the plurality of weight values and an operation result of a previous layer. Such training may be performed on a device itself on which artificial intelligence according to the disclosure is performed, or may be performed through a separate server (e.g., the server 108 of FIG. 1) and/or system. Examples of learning algorithms include supervised learning, unsupervised learning, semi-supervised learning, or reinforcement learning, but are not limited to the above-described example.

The plurality of weight values possessed by the plurality of neural network layers of the artificial intelligence model may be optimized based on a training result of the artificial intelligence model. For example, the plurality of weight values may be updated so that a loss value or a cost value obtained from the artificial intelligence model during a training process is reduced or minimized. An artificial neural network may include a deep neural network (DNN), and may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or deep Q-networks, but is not limited to the above-described examples.

In an operation method of an electronic device 101 according to the disclosure, the electronic device 101 may recognize voice. According to an embodiment, the electronic device 101 may recognize voice of a user by receiving a voice signal, which is an analog signal, through the input module 150 (e.g., a microphone), and may interpret the intent of an utterance included in the recognized voice. According to an embodiment, the electronic device 101 may recognize audio included in an image, and interpret the intent of voice included in the recognized audio. The electronic device 101 may convert a voice part into computer-readable text by using an automatic utterance recognition (ASR) model. The converted text may be interpreted using a natural language understanding (NLU) model to obtain the intent of an utterance. Here, the ASR model or the NLU model may be an artificial intelligence model. The artificial intelligence model may be processed by the processor 120 (e.g., an artificial intelligence-dedicated processor) designed with a hardware structure specialized for processing the artificial intelligence model. The artificial intelligence model may be generated through training. Linguistic understanding is a technology for recognizing and applying/processing human language/characters, and includes natural language processing, machine translation, a dialog system, question answering, speech recognition/synthesis, etc.

In the operation method of the electronic device 101 according to the disclosure, the electronic device 101 may recognize an image. According to an embodiment, the electronic device 101 may use image data as input data of the artificial intelligence model to obtain output data obtained by recognizing the image. The artificial intelligence model may be generated through training. Visual understanding is a technology for recognizing and processing an object in a manner similar to human vision, and includes object recognition, object tracking, image retrieval, human recognition, scene recognition, spatial understanding (3D reconstruction/localization), image enhancement, etc.

FIG. 2A is a block diagram of an electronic device according to an embodiment of the disclosure.

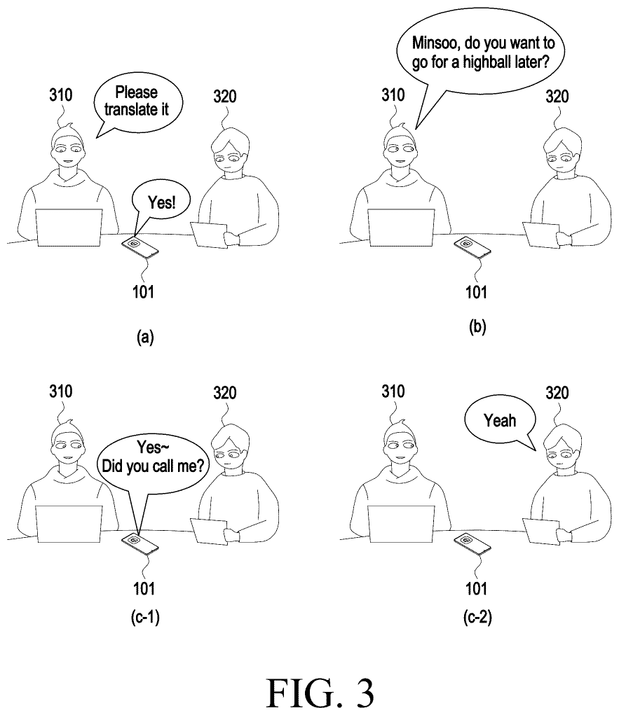

FIG. 2A may be explained based on the embodiments of FIG. 1, the embodiments of FIG. 2B, the embodiments of FIG. 2C, the embodiments of FIG. 3, and the embodiments described below.

FIG. 2B is a diagram illustrating an electronic device according to an embodiment of the disclosure.

FIG. 2C is a diagram illustrating a generative artificial intelligence system according to an embodiment of the disclosure.

FIG. 3 is a diagram illustrating an operation of an electronic device according to an embodiment of the disclosure.

Referring to FIG. 2A, as described above, the electronic device 101 may include the processor 120 and the memory 130.

Referring to FIG. 2B, according to an embodiment, the electronic device 101 may include a housing 200 which forms an outer surface of the electronic device 101. For example, the components (e.g., the components of FIG. 1 and the components of FIG. 2A) of the electronic device 101 may be arranged in the housing 200.

Referring to FIG. 2A, according to an embodiment, the electronic device 101 may include a microphone 210 (e.g., a microphone of the input module 150 of FIG. 1). The microphone 210 may be configured to acquire voice data. The electronic device 101 may acquire voice data through the microphone 210. The voice data may include data on voice of one speaker or may include data on voices of multiple speakers, and there is no limitation on the type of voice data and the type of information included in the voice data. There is no limitation on the number and positions of microphones 210. According to an embodiment, the electronic device 101 may measure a distance between the electronic device 101 and a speaker by using multiple microphones 210. For example, the electronic device 101 may measure the distance between the electronic device 101 and the speaker, based on a difference in time points at which the multiple microphones 210 receive a voice. According to an embodiment, the electronic device 101 may also measure the distance between the electronic device 101 and the speaker by using a sensor (e.g., a second sensor 232), as described below. According to an embodiment, the electronic device 101 may identify a direction from the electronic device 101 to the location of the speaker by using the multiple microphones 210. For example, the electronic device 101 may identify the direction from the electronic device 101 to the location of the speaker, based on the difference in the time points at which the multiple microphones 210 receive a voice.

Referring to FIG. 2A, according to an embodiment, the electronic device 101 may include a display 250 (e.g., a display of the display module 160 of FIG. 1). The display 250 may be configured to display a screen. The electronic device 101 may control the display 250 to display the screen. The display 250 may be configured to receive an input (e.g., a touch input). The electronic device 101 may receive an input (e.g., a touch input) through the display 250. According to an embodiment, referring to FIG. 2B, the display 250 (e.g., the display of the display module 160 of FIG. 1) may be disposed on a first surface (e.g., a front surface) of the housing 200. For example, the electronic device 101 may include the display 250 (e.g., the display of the display module 160 of FIG. 1) disposed on the first surface (e.g., the front surface) of the housing 200. For example, a direction in which the display 250 (e.g., the display of the display module 160 of FIG. 1) faces may be defined as a front surface of the electronic device 101. As a user faces the front surface of the electronic device, the user may gaze at the display 250 (e.g., the display of the display module 160 of FIG. 1) disposed on the first surface (e.g., the front surface) of the housing 200.

Referring to FIG. 2A, according to an embodiment, the electronic device 101 may include a camera 220 (e.g., a camera of the camera module 180 of FIG. 1). The camera 220 may be configured to acquire image data. There is no limitation on the number of cameras 220. The electronic device 101 may acquire image data through the camera 220. The image data may include data of one image frame or may include consecutive data for a plurality of image frames. The image data may include information on the user's eye, mouth, face, gesture, and/or facial expression, and there is no limitation on the type of image data and the type of information included in the image data. According to an embodiment, the camera 220 (e.g., a front camera) may be configured to acquire an image in the direction in which the display 250 (e.g., the display of the display module 160 of FIG. 1) faces. For example, the camera 220 (e.g., the front camera) may be disposed in the direction in which the display 250 (e.g., the display of the display module 160 of FIG. 1) faces. For example, the camera 220 (e.g., the front camera) may be configured to acquire an image in a direction in which the front surface of the electronic device 101 faces. For example, referring to FIG. 2B, the electronic device 101 may acquire an image in the direction in which the display 250 (e.g., the display of the display module 160 of FIG. 1) faces, through the camera 220 (e.g., the front camera).

Referring to FIG. 2A, according to an embodiment, the electronic device 101 may include a rear camera 222 (e.g., a camera of the camera module 180 of FIG. 1). For example, the rear camera 222 may be configured to acquire an image in a direction opposite to the direction in which the display 250 (e.g., the display of the display module 160 of FIG. 1) faces. For example, the rear camera 222 may be disposed in the direction opposite to the direction in which the display 250 (e.g., the display of the display module 160 of FIG. 1) faces. The rear camera 222 may be configured to acquire image data. For example, the rear camera 222 may be configured to acquire an image in a direction in which a back surface of the electronic device 101 faces. There is no limitation on the number of rear cameras 222. The electronic device 101 may acquire image data through the rear camera 222.

According to an embodiment, turning on (e.g., activation) and turning off (e.g., deactivation) of the rear camera 222 may be unrelated to a conversation mode described below. The conversation mode may be a mode in which a voice agent (e.g., an artificial intelligence model) executed by the electronic device 101 interacts with a voice input received through the microphone 210. The conversation mode will be described below. For example, turning on (e.g., activation) and turning off (e.g., deactivation) of the camera 220 (e.g., the front camera) may be determined based on an operation of the conversation mode, but turning on and turning off of the rear camera 222 may be unrelated to the conversation mode. For example, based on the activation of the conversation mode, the electronic device 101 may activate the camera 220 (e.g., the front camera). For example, the electronic device 101 may deactivate the camera 220, based on identifying a condition for deactivating the camera 220, while the conversation mode is performed. For example, the electronic device 101 may activate the camera 220, based on identifying a specific condition (e.g., identifying a standing state or a handheld state described below), while the conversation mode is performed in a state where the camera 220 is deactivated. For example, the electronic device 101 may deactivate the camera 220, based on the conversation mode being deactivated in a state where the camera 220 is activated.

Referring to FIG. 2A, according to an embodiment, the electronic device 101 may include a first sensor 231 (e.g., a sensor of the sensor module 176 of FIG. 1). The first sensor 231 may be configured to identify an orientation (e.g., a tilt direction and a degree of tilt) and/or a movement (e.g., a movement along the X-axis, Y-axis, and Z-axis) of the electronic device 101. For example, the first sensor 231 may include a gyro sensor, an acceleration sensor, and/or a six-axis sensor, but there is no limitation on the type and number of first sensors 231. The first sensor 231 may be configured to acquire sensing data for identifying the orientation and/or movement of the electronic device 101. The electronic device 101 may identify the orientation and/or movement of the electronic device 101 by using the sensing data (e.g., a sensing value) of the first sensor 231. There is no limitation on the number of first sensors 231, and the electronic device 101 may identify the orientation and/or movement of the electronic device 101, based on a combination of sensing data of multiple first sensors 231.

Referring to FIG. 2A, according to an embodiment, the electronic device 101 may include a second sensor 232 (e.g., a sensor of the sensor module 176 of FIG. 1). The second sensor 232 may be configured to measure a distance between the electronic device 101 and the user. A configuration for measuring the distance between the electronic device 101 and the user may be referred to as the second sensor 232. For example, the second sensor 232 may include a distance sensor (e.g., a time of flight (ToF) sensor), but there is no limitation on the type and number of second sensors 232. The second sensor 232 may be configured to acquire sensing data for measuring the distance between the electronic device 101 and the user. The electronic device 101 may measure the distance between the electronic device 101 and the user by using the sensing data (e.g., a sensing value) of the second sensor 232. There is no limitation on the number of second sensors 232, and the electronic device 101 may measure the distance between the electronic device 101 and the user, based on a combination of sensing data of multiple second sensors 232. As described above, according to an embodiment, the electronic device 101 may also measure the distance between the electronic device 101 and the user by using the microphone 210 (e.g., the multiple microphones 210). According to an embodiment, the electronic device 101 may measure the distance between the electronic device 101 and the user by using the sensing value of the second sensor 232 and voice data of the microphone 210.

Referring to FIG. 2A, according to an embodiment, the electronic device 101 may include a speaker 240 (e.g., a speaker of the sound output module 155 of FIG. 1). The speaker 240 may be configured to output sound. The electronic device 101 may output sound by using a speaker. For example, the electronic device 101 may output a response (e.g., sound) through the speaker 240 in response to an utterance of the user.

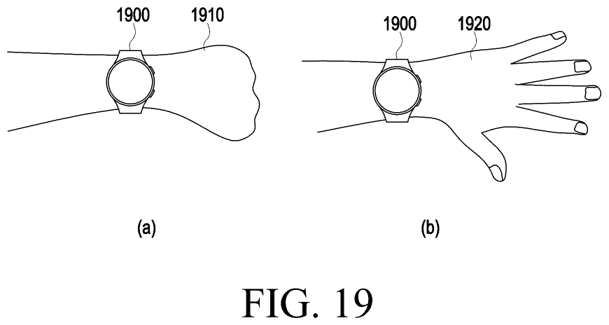

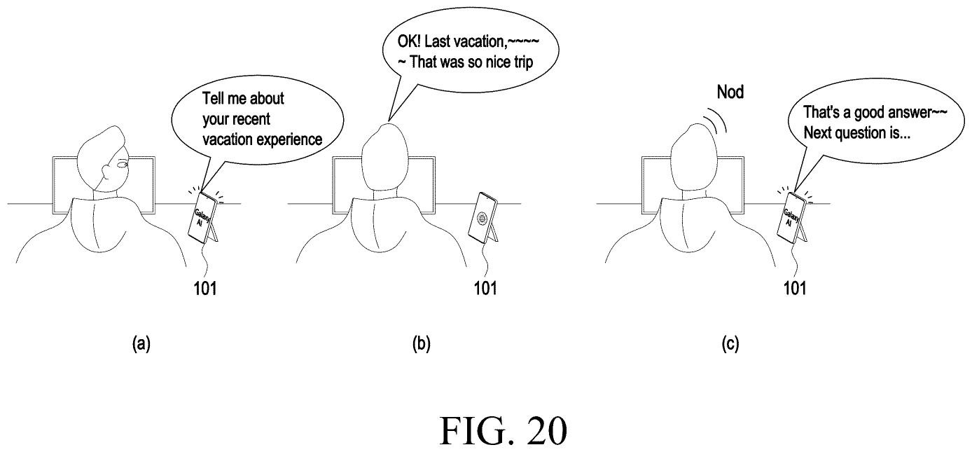

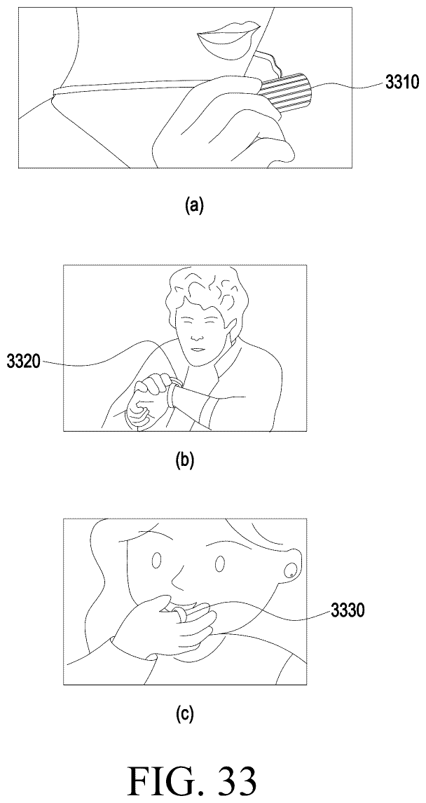

Referring to FIG. 2A, according to an embodiment, the electronic device 101 may include communication circuitry 260 (e.g., communication circuitry of the communication module 190 of FIG. 1). The communication circuitry 260 may be configured to perform communication with an external device (e.g., the electronic device 102, the electronic device 104, or the server 108 of FIG. 1, a wearable device 1900 of FIG. 19, or an external device 3310, 3320, or 3330 of FIG. 33). The electronic device 101 may perform communication with an external device (e.g., the electronic device 102, the electronic device 104, or the server 108 of FIG. 1, the wearable device 1900 of FIG. 19, or the external device 3310, 3320, or 3330 of FIG. 33) by using the communication circuitry 260.

Referring to FIG. 2C, according to an embodiment, a generative artificial intelligence system may be described. The generative artificial intelligence system may include a user query/response interface 271, an AI framework 280, a knowledge repository 272, an application/service component 273, and/or a generative AI model 274. Referring to FIG. 2C, the user query/response interface 271 may receive an input of a user. The input of the user may be in the form of a natural language, an image, and/or a video, but is not limited thereto. In addition, when the input of the user is transmitted, context information may be transmitted together. The context information may include various additional information at a time point of a user input. For example, the additional information may include information on an application currently being used by the user, information on a location of the user, or the like. In addition, the user input may also be in the form of a mixture of the above-described natural language, image, sound, and context information. In addition, the user input may also be in a non-natural language form such as selecting a menu. The user query/response interface 271 may output a result of the generative artificial intelligence system to the user. The output can be in a natural language form or a specific content form, and can also be provided in a form such as an action requested by the user. The user query/response interface 271 may output a result of the generative artificial intelligence system to the user. The output can be in a natural language form or a specific content form, and can also be provided in a form such as an action requested by the user.

The AI framework 280 may receive an input of the user, and may coordinate and control each component required to perform the intent of the user based on a query of the user.

A user input received by the user query/response interface 271 may be transmitted to a prompt design component 281. The prompt design component 281 may be used to generate a prompt suitable for inputting the user input into a large language model (LLM) or a large multimodal model (LMM). The prompt design component 281 may be an AI component which uses a machine learning algorithm or a neural network to develop better prompts over time. The prompt design component 281 may generate a prompt by accessing a knowledge component including user preference data, a prompt library, and a prompt example, based on the user input, and may transmit the generated prompt to the LLM or the LMM.

An application programming interface (API)/Plug-in management component 282 may perform the role of communicating with external information when there is a request for additional information at the time of transmitting a user input as an input of a generative model. The API/Plug-in management component 282 may establish a channel capable of communicating with the outside of an AI interface through an API, and may allow access to various data sources (e.g., the knowledge repository 272) through the established channel. In addition, when an action for performing the user's input finally, rather than as an intermediate result, is required to be performed in an application or a service, the API/Plug-in management component 282 may request the corresponding action from the application/service component 273 through the API. Information obtained from an external source may be used to generate a prompt in the prompt design component 281 together with a user input or may be transmitted as an input of the generative model.

An output modification component (or also referred to as a refiner component) 283 may finely tune a result output by the generative model. For example, the output modification component 283 may verify whether a content generated through an LLM and/or an LMM is not irrelevant, does not include biased content, or does not include harmful content. In addition, the output modification component 283 may determine the extent to which the generated content matches the user's desired result, and if an additional process is required, may also proceed with the corresponding process. The output adjustment component 283 may additionally configure a hint for avoiding an undesired output, and provide the hint to the user.

A generative AI model 274 may generally refer to an artificial intelligence neural network which generates a new type of data based on user input information. The generative AI model 274 may include a model which generates an image and/or a model which generates a language. Representative examples of models which generate images include a generative adversarial network (GAN) and a variational auto encoder (VAE), and examples of the models include a diffusion-based generative model which uses a transformer structure and a VAE. A model which generates a language is a model trained to output the most statistically appropriate output value based on an input value, and representative examples of the model include a model such as CHAT-GPT 3 or CHAT-GPT 4. In addition, there are large multimodal models (LMMs) which may recognize various forms of data input such as text, an image, and voice, and generate new data corresponding thereto.

Referring to FIG. 3, according to an embodiment, the electronic device 101 that responds to an utterance of a user may be described.

FIG. 3 illustrates a situation in which a first speaker 310 and a second speaker 320 are positioned around the electronic device 101. In case (a) of FIG. 3, the first speaker 310 may make an utterance requesting translation from the electronic device 101 (e.g., “Please translate it”). The electronic device 101 may perform the translation requested by the first speaker 310 in response to receiving voice data for the utterance requesting the translation (e.g., “Please translate it”). For example, in case (a) of FIG. 3, the electronic device 101 may output a response (e.g., “Yes”) indicating that a user's request (e.g., a translation request) has been recognized, and then output a response including a translated sentence. In case (b) of FIG. 3, the first speaker 310 may make an utterance containing a suggestion to the second speaker 320 (e.g., “Minsoo, do you want to go for a highball later?”). The electronic device 101 may receive voice data for the utterance suggested by the first speaker 310 (e.g., “Minsoo, do you want to go for a highball later?”). After the electronic device 101 receives the voice data for the utterance suggested by the first speaker 310 (e.g., “Minsoo, do you want to go for a highball later?”) in case (b) of FIG. 3, a situation illustrated in case (c-1) of FIG. 3 or a situation illustrated in case (c-2) of FIG. 3 may unfold. Case (c-1) of FIG. 3 may represent a situation where the electronic device 101 responds. In case (c-1) of FIG. 3, the electronic device 101 may output a response (e.g., “Yes, did you call me?” or “I'd like to go for a highball”) in response to receiving the voice data for the utterance suggested by the first speaker 310 (e.g., “Minsoo, do you want to go for a highball later?”). However, the response of the electronic device 101 in case (c-1) of FIG. 3 may not be a response intended by the first speaker 310. Case (c-1) of FIG. 3 may represent a situation where the first speaker 310 wanted a response from the second speaker 320, but the electronic device 101 responded instead. In such a case, the first speaker 310 and the second speaker 320 may be confused or may not trust the electronic device 101. Case (c-2) of FIG. 3 may represent a situation where the electronic device 101 does not respond. In case (c-2) of FIG. 3, even though the electronic device 101 has acquired the voice data for the utterance suggested by the first speaker 310 (e.g., “Minsoo, do you want to go for a highball later?”), the electronic device 101 may not output a response to the voice data.

The following embodiments may describe embodiments in which the electronic device 101 does not operate as shown in case (c-1) of FIG. 3, but operates as shown in cases (a) and (c-2) of FIG. 3.

The following drawings are divided into individual drawings for convenience of explanation, and those skilled in the art will understand that at least some of the embodiments in the following drawings may be applied in conjunction with each other.

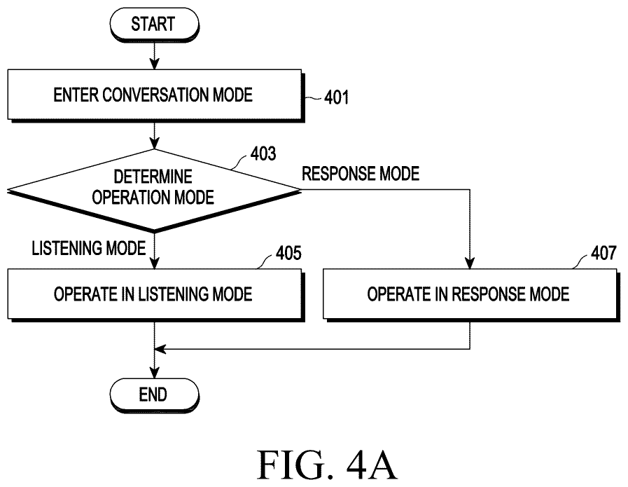

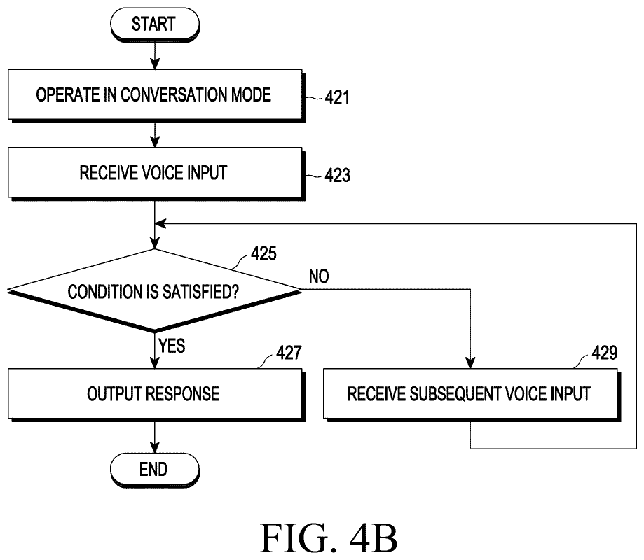

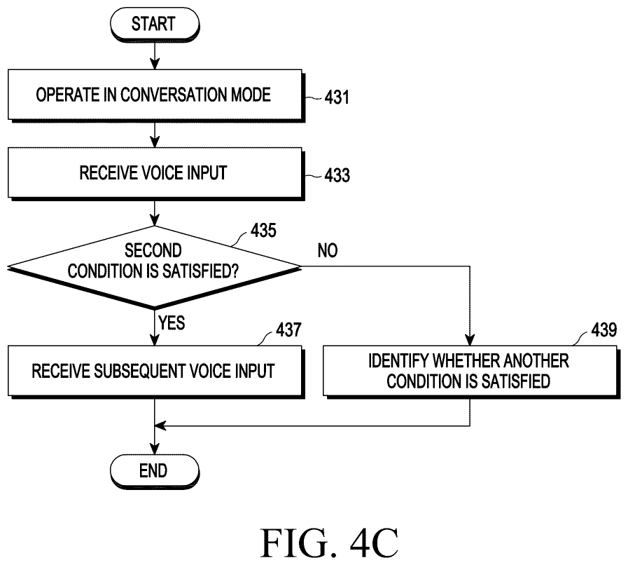

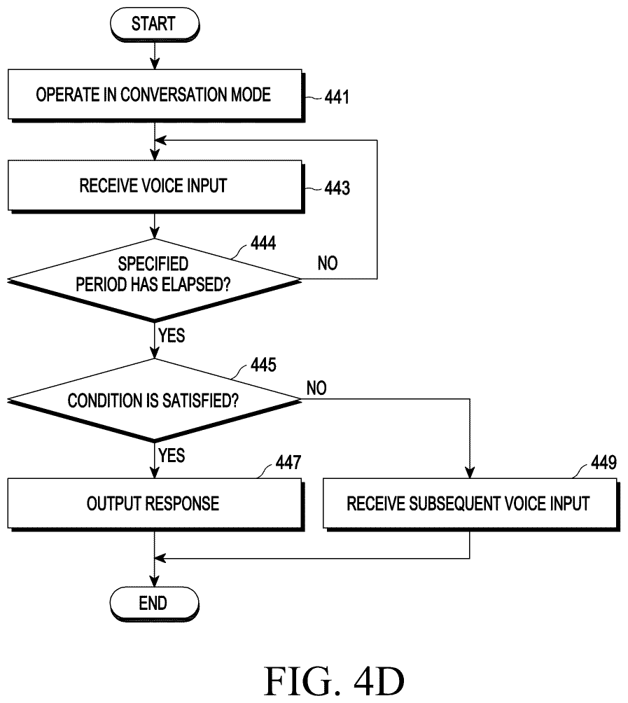

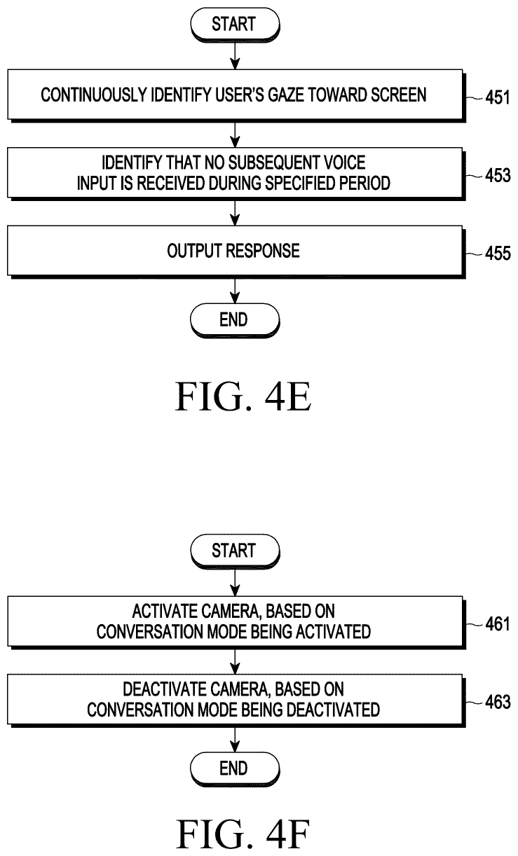

FIG. 4A is a flowchart of an operation method of an electronic device according to an embodiment of the disclosure.

FIG. 4A may be described based on the embodiments of FIGS. 1, 2A, 2B, 2C, and 3 and the embodiments described below.

Referring to FIG. 4A, according to an embodiment, the electronic device 101 may determine an operation mode (e.g., a listening mode or a response mode) of a conversation mode.

At least some of the operations of FIG. 4A may be omitted. The order of the operations of FIG. 4A may be changed. Operations other than the operations of FIG. 4A may be performed before, during, or after performing the operations of FIG. 4A.

Referring to FIG. 4A, in operation 401, according to an embodiment, the electronic device 101 may enter a conversation mode. The “conversation mode” may be a mode in which a user of the electronic device 101 and an artificial intelligence model (e.g., a voice agent) have a conversation. For example, the “conversation mode” may be a mode in which a voice agent executed by the electronic device 101 interacts with a voice input (e.g., voice data) received through the microphone 210. The voice input may be data acquired through the microphone 210 based on an utterance of the user. For example, an operation mode of the conversation mode may include a listening mode and a response mode, and the listening mode will be described in operation 405, and the response mode will be described in operation 407. The electronic device 101 may have a conversation with the user by using the artificial intelligence model (e.g., the voice agent) while operating in the conversation mode. The conversation between the electronic device 101 and the user may be performed by acquiring voice data (e.g., a voice input) for the utterance of the user, identifying response information generated based on an analysis of the voice data using the artificial intelligence model (e.g., the voice agent), and outputting a response based on the response information, by the electronic device 101, according to the utterance of the user. According to an embodiment, an on-device artificial intelligence model (e.g., a voice agent) of the electronic device 101 may be used to perform at least some operations in the process of having a conversation between the electronic device 101 and the user. According to an embodiment, an artificial intelligence model (e.g., a voice agent) of the server 108 may be used to perform at least some operations in the process of having a conversation between the electronic device 101 and the user. According to an embodiment, the on-device artificial intelligence model (e.g., the voice agent) of the electronic device 101 and the artificial intelligence model (e.g., the voice agent) of the server 108 may be used individually or collectively to perform at least some operations in the process of having a conversation between the electronic device 101 and the user. For example, an operation of generating response information based on an analysis of voice data may be performed by the on-device artificial intelligence model (e.g., the voice agent) of the electronic device 101, may be performed by the artificial intelligence model (e.g., the voice agent) of the server 108, or may be performed individually or collectively by the on-device artificial intelligence model (e.g., the voice agent) of the electronic device 101 and the artificial intelligence model (e.g., the voice agent) of the server 108. Although only the operation of generating the response information is given as an example, this is for convenience of explanation, and the on-device artificial intelligence model (e.g., the voice agent) of the electronic device 101 and/or the artificial intelligence model (e.g., the voice agent) of the server 108 may be individually or collectively used for other operations that require intervention of the artificial intelligence model (e.g., the voice agent).

According to an embodiment, in operation 401, based on identifying an event which causes entry into a conversation mode with an artificial intelligence model (e.g., a voice agent), the electronic device 101 may enter the conversation mode. An example of the event which causes entry into the conversation mode is as follows. According to an embodiment, the electronic device 101 may enter the conversation mode, based on a call to the electronic device 101. The call to the electronic device 101 may be a voice command which causes the electronic device 101 to enter the conversation mode. For example, the electronic device 101 may enter the conversation mode, based on receiving voice data corresponding to an utterance including a wake word (e.g., “Hi Bixby”). According to an embodiment, the electronic device 101 may enter the conversation mode, based on an input to a button (e.g., a hardware button of the electronic device 101 or a software button displayed on a screen of the display 250 of the electronic device 101). According to an embodiment, the electronic device 101 may enter the conversation mode, based on identifying that the electronic device 101 is placed on a stand. For example, the electronic device 101 may identify that the electronic device 101 is placed on the stand, based on sensing data (e.g., a sensing value) of at least one sensor (e.g., the first sensor 231 of FIG. 2A) configured to identify an orientation and/or a movement of the electronic device 101. Based on a configuration which causes the electronic device 101 to enter the conversation mode when placed on the stand, the electronic device 101 may enter the conversation mode, based on identifying that the electronic device 101 is placed on the stand. According to an embodiment, the electronic device 101 may enter the conversation mode, based on receiving a request from an external device (e.g., the electronic device 102, the electronic device 104, or the server 108 of FIG. 1, the wearable device 1900 of FIG. 19, or the external device 3310, 3320, or 3330 of FIG. 33) through the communication circuitry 260. For example, the user may input an input which causes the electronic device 101 to enter the conversation mode, through a wearable device (e.g., the external device 3310, 3320, or 3330 of FIG. 33) communicatively connected to the electronic device 101. Based on the input (e.g., a user input) through the wearable device (e.g., the external device 3310, 3320, or 3330 of FIG. 33) communicatively connected to the electronic device 101, the electronic device 101 may receive a request which causes entry into the conversation mode from the wearable device (e.g., the external device 3310, 3320, or 3330 of FIG. 33). The above-described events which cause entry into the conversation mode are exemplary, and there is no limitation on the types of events which cause entry into the conversation mode. The operation 401 may be understood as an operation of re-entering the conversation mode after the conversation mode is terminated or stopped.

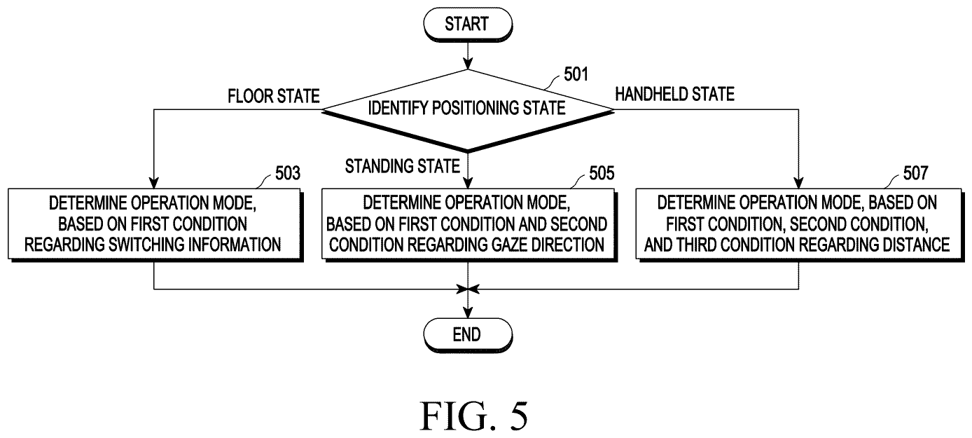

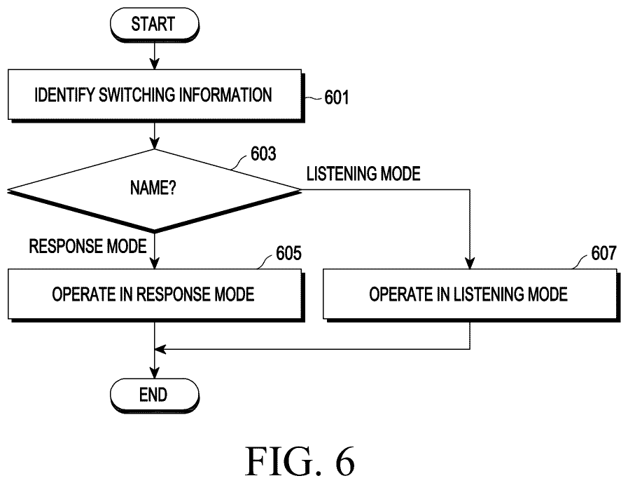

In the operation 403, according to an embodiment, the electronic device 101 may determine the operation mode of the conversation mode. The operation mode of the conversation mode may define an operation to be performed by the electronic device 101 during the conversation mode. As the operation mode of the conversation mode is determined, an operation performed by the electronic device 101 while the electronic device 101 is operating in the conversation mode may be determined. The operation mode of the conversation mode may include the listening mode and the response mode. As described below, a group mode and a default mode may also be one of operation modes of the conversation mode. For example, a combination of modes, such as the group mode and the response mode or the default mode and the response mode, may also be the operation modes of the conversation mode. According to an embodiment, the electronic device 101 may determine an operation mode of the conversation mode, based on a condition for determining the operation mode of the conversation mode. A specific condition for determining the operation mode of the conversation mode will be described with reference to the embodiment of FIG. 5 and the embodiments of FIGS. 6 to 33. In FIG. 4, an operation performed in the listening mode or the response mode among the operation modes of the conversation mode may be described. While the electronic device 101 is operating in the conversation mode, the electronic device 101 may switch the operation mode of the conversation mode depending on conditions. While the electronic device 101 is operating in the conversation mode, based on identifying a change in a condition, the electronic device 101 may switch to an operation mode (e.g., the listening mode or the response mode) corresponding to the changed condition. For example, while the electronic device 101 is operating in the conversation mode, the electronic device 101 may switch from the listening mode to the response mode while operating in the listening mode, or may switch from the response mode to the listening mode while operating in the response mode. According to an embodiment, when the electronic device 101 first enters the conversation mode, the electronic device 101 may determine the operation mode according to a condition. For example, when the electronic device 101 first enters the conversation mode, the electronic device 101 may identify a condition and determine the operation mode corresponding to the identified condition. According to an embodiment, when first entering the conversation mode, the electronic device 101 may determine the operation mode according to a configuration. For example, when the listening mode (or response mode) is configured as the default, the electronic device 101 may determine the listening mode (or response mode) as the operation mode according to the configuration when first entering the conversation mode. When first entering the conversation mode, the electronic device 101 may determine the listening mode (or response mode) as the operation mode according to the configuration, and then identify the condition and switch to the response mode (or listening mode) according to the identified condition.

In operation 405, according to an embodiment, the electronic device 101 may operate in the listening mode, based on determining the listening mode as the operation mode. An operation of the listening mode may include an operation of acquiring voice data. While operating in the listening mode, the electronic device 101 may acquire voice data corresponding to an utterance of the user by using the microphone 210. The operation of the listening mode may include an operation of storing the acquired voice data in the memory 130. While operating in the listening mode, the electronic device 101 may store, in the memory 130, the voice data acquired using the microphone 210. The listening mode may be a mode which does not output a response. The electronic device 101 may not output a response while operating in the listening mode. The voice data acquired (or stored) during the listening mode may be used in the response mode. The electronic device 101 may use, in the response mode, the voice data acquired (or stored) during the listening mode. According to an embodiment, the electronic device 101 may not use, in the response mode, the voice data acquired (or stored) during the listening mode.

In operation 407, according to an embodiment, the electronic device 101 may operate in the response mode, based on determining the response mode as the operation mode. An operation of the response mode may include an operation of acquiring voice data. While operating in the response mode, the electronic device 101 may acquire voice data corresponding to an utterance of the user by using the microphone 210. The operation of the response mode may include an operation of storing the acquired voice data in the memory 130. While operating in the response mode, the electronic device 101 may store, in the memory 130, the voice data acquired using the microphone 210. The response mode may be a mode of outputting a response. The electronic device 101 may output a response corresponding to the voice data while operating in the response mode. For example, the operation of the response mode may include an operation of identifying response information generated based on the voice data. The response information may be information generated based on an analysis of the artificial intelligence model (e.g., the voice agent) (e.g., the on-device artificial intelligence model of the electronic device 101 and/or the artificial intelligence model of the server 108) for the acquired voice data. For example, during the response mode, the electronic device 101 may analyze the voice data (e.g., voice data accumulated during the conversation mode or voice data acquired during the response mode) by using the on-device artificial intelligence model (e.g., the voice agent) of the electronic device 101, so as to generate response information corresponding to the voice data. For example, the electronic device 101 may transmit the voice data (e.g., voice data accumulated during the conversation mode or voice data acquired during the response mode) to the server 108, and may receive response information generated by the server 108 from the server 108. The voice data accumulated during the conversation mode may be voice data acquired (or stored) while the electronic device 101 is operating in the conversation mode, including the listening mode and the response mode. The electronic device 101 may use the voice data accumulated during the conversation mode, or may use the voice data acquired during the response mode. The operation of the response mode may include an operation of outputting a response based on identified voice information. While operating in the response mode, the electronic device 101 may output a response (e.g., sound) through the speaker 240, based on the response information generated based on the voice data.

With reference to the embodiments below, examples of operations of determining an operation mode of operation 403 in FIG. 4A will be described.

FIG. 4B is a flowchart of an operation method of an electronic device according to an embodiment of the disclosure.

FIG. 4B may be described based on the embodiments of FIGS. 1, 2A, 2B, 2C, and 3, the embodiments of FIG. 4A, and the embodiments described below.

At least some of the operations of FIG. 4B may be omitted. The order of the operations of FIG. 4B may be changed. Operations other than the operations of FIG. 4B may be performed before, during, or after performing the operations of FIG. 4B.

FIG. 4B may be a diagram illustrating the operations of FIG. 4A in chronological order. For example, the operations of FIG. 4B may correspond to an embodiment of the operations of FIG. 4A. A part of the description of the operations of FIG. 4B that overlaps with the description of the operations of FIG. 4A may be omitted.

Referring to FIG. 4B, in operation 421, according to an embodiment, the electronic device 101 may operate in a conversation mode. As described above, the “conversation mode” may be a mode in which a voice agent executed by the electronic device 101 interacts with a voice input received through the microphone 210. The voice input may be data acquired through the microphone 210 based on an utterance of a user. While operating in the conversation mode, the electronic device 101 may have a conversation with the user by using a voice agent (e.g., an artificial intelligence model). The conversation between the electronic device 101 and the user may be performed by acquiring voice data (e.g., a voice input) for the utterance of the user, identifying response information generated based on an analysis of the voice data (e.g., the voice input) using the artificial intelligence model (e.g., the voice agent), and outputting a response based on the response information, by the electronic device 101, according to the utterance of the user. Operation 421 may be understood with reference to the description of operation 401 of FIG. 4A.

In operation 423, according to an embodiment, the electronic device 101 may receive a voice input. For example, the electronic device 101 may receive a voice input (e.g., voice data for the utterance of the user) through the microphone 210. For example, the electronic device 101 may receive a first voice input at a first time point. For example, the electronic device 101 may receive the first voice input through the microphone 210, based on the utterance of the user.

In operation 425, according to an embodiment, the electronic device 101 may identify whether at least one condition for outputting a response is satisfied. The “at least one condition for outputting a response” may be referred to as a “response condition.” For example, the “at least one condition for outputting a response” (e.g., the “response condition”) may include an operation of identifying occurrence of an event which causes a response associated with the voice input to be output. For example, the electronic device 101 may output the response associated with the voice input, based on the at least one condition (e.g., the response condition) for outputting the response being satisfied. For example, the “at least one condition for outputting the response” (e.g., the “response condition”) may be a condition which causes the electronic device to operate in the response mode of FIG. 4A. There is no limitation on the number of at least one condition (e.g., the response condition) for outputting a response. According to an embodiment, the electronic device 101 may output the response associated with the voice input, based on at least one of the at least one condition (e.g., the response condition) for outputting the response being identified. For example, after receiving the first voice input (e.g., the first voice input in operation 423), the electronic device 101 may identify whether at least one condition for outputting a first response associated with the first voice input is satisfied.

In operation 427, according to an embodiment, the electronic device 101 may output the response associated with the voice input, based on at least one of the at least one condition (e.g., the response condition) for outputting the response being satisfied. For example, the electronic device 101 may perform operation 407 of FIG. 4A, based on at least one of the at least one condition (e.g., the response condition) for outputting the response being satisfied. For example, the electronic device 101 may output the first response associated with the first voice input, based on the at least one condition for outputting the first response being satisfied. For example, the electronic device 101 may identify response information generated based on an analysis of the voice input (e.g., the voice data) using the artificial intelligence model (e.g., the voice agent), based on the at least one condition for outputting the first response being satisfied, and may output the response, based on the response information. For example, the at least one condition for outputting the first response may include an operation of identifying that a gaze of the user of the electronic device 101, obtained using the camera 220, moves toward a screen of the display 250. For example, the electronic device 101 may identify the gaze of the user of the electronic device 101 by using the camera 220, and output the first response associated with the first voice input, based on identifying that the gaze of the user moves toward the screen of the display 250. There is no limitation on the type and number of at least one condition for outputting a response. In embodiments of drawings described below, at least one condition for outputting a response will be described.

In operation 429, according to an embodiment, the electronic device 101 may receive a subsequent voice input (e.g., a second voice input subsequent to the first voice input), instead of outputting the response (e.g., the first response associated with the first voice input), based on the at least one condition (e.g., the response condition) for outputting the response not being satisfied. For example, the electronic device 101 may perform operation 405 of FIG. 4A, based on the at least one condition (e.g., the response condition) for outputting the response not being satisfied. For example, the electronic device 101 may not output the response (e.g., the first response associated with the first voice input), based on the at least one condition (e.g., the response condition) for outputting the response not being satisfied. For example, the electronic device 101 may receive the subsequent voice input (e.g., the second voice input subsequent to the first voice input), based on the at least one condition (e.g., the response condition) for outputting the response not being satisfied. For example, the electronic device 101 may wait without outputting the response (e.g., the first response associated with the first voice input) in order to receive the subsequent voice input (e.g., the second voice input subsequent to the first voice input), based on the at least one condition (e.g., the response condition) for outputting the response not being satisfied.

According to an embodiment, after receiving the second voice input (e.g., the second voice input in operation 429 of FIG. 4B subsequent to the first voice input) without outputting the first response associated with the first voice input (e.g., the first voice input in operation 423 of FIG. 4B), the electronic device 101 may identify whether at least one condition for outputting a second response associated with the first voice input and the second voice input is satisfied. For example, the at least one condition for outputting the second response may be the at least one condition (e.g., the response condition) for outputting the response in operation 425 of FIG. 4B. For example, the second response may be a response generated based on the second voice input. For example, the second response may be a response generated based on the first voice input and the second voice input. According to an embodiment, the electronic device 101 may output the second response associated with the first voice input and the second voice input, based on the at least one condition (e.g., the response condition) for outputting the second response being satisfied. According to an embodiment, the electronic device 101 may output the second response associated with the second voice input, based on the at least one condition (e.g., the response condition) for outputting the second response being satisfied. According to an embodiment, the electronic device 101 may receive a third voice input subsequent to the second voice input, instead of outputting the second response, based on the at least one condition (e.g., the response condition) for outputting the second response not being satisfied. For example, the electronic device 101 may wait to receive a voice input subsequent to the second voice input, instead of outputting the second response, based on the at least one condition (e.g., the response condition) for outputting the second response not being satisfied.

FIG. 4C is a flowchart of an operation method of an electronic device according to an embodiment of the disclosure.

FIG. 4C may be described based on the embodiments of FIGS. 1, 2A to 2C, and 3, the embodiments of FIGS. 4A and 4B, and the embodiments described below.

At least some of the operations of FIG. 4C may be omitted. The order of the operations of FIG. 4C may be changed. Operations other than the operations of FIG. 4C may be performed before, during, or after performing the operations of FIG. 4C.

FIG. 4C may be a diagram illustrating the operations of FIG. 4A in chronological order. For example, the operations of FIG. 4C may correspond to an embodiment of the operations of FIG. 4A. A part of the description of the operations of FIG. 4C that overlaps with the description of the operations of FIG. 4A may be omitted.

Referring to FIG. 4C, in operation 431, according to an embodiment, the electronic device 101 may operate in a conversation mode. The operation 431 may be understood with reference to the description of operation 421 of FIG. 4B and the description of operation 401 of FIG. 4A.

In operation 433, according to an embodiment, the electronic device 101 may receive a voice input. The operation 433 may be understood with reference to the description of operation 423 of FIG. 4B. For example, the electronic device 101 may receive a first voice input at a first time point. For example, the electronic device 101 may receive the first voice input through the microphone 210, based on an utterance of a user.

In operation 435, according to an embodiment, the electronic device 101 may identify whether a second condition (e.g., a listening condition) is satisfied. The second condition (e.g., the listening condition) may be at least one condition for receiving a subsequent voice input instead of outputting a response. The second condition (e.g., the listening condition) may include an operation of identifying occurrence of an event which causes a response associated with the voice input not to be output. For example, the electronic device 101 may not output the response associated with the voice input, based on the second condition (e.g., the listening condition) being satisfied. For example, the electronic device 101 may receive a subsequent voice input, based on the second condition (e.g., the listening condition) being satisfied. For example, the second condition (e.g., the listening condition) may be a condition which causes the electronic device to operate in the listening mode of FIG. 4A. There is no limitation on the number of second conditions (e.g., the listening condition). According to an embodiment, the electronic device 101 may receive the subsequent voice input, instead of outputting the response, based on at least one of second conditions (e.g., the listening condition) being identified. For example, after receiving the first voice input (e.g., the first voice input in operation 433), the electronic device 101 may identify whether the second condition (e.g., the listening condition) is satisfied.

In operation 437, according to an embodiment, the electronic device 101 may receive the subsequent voice input, instead of outputting the response, based on at least one of the second conditions (e.g., the listening condition) being satisfied. For example, the electronic device 101 may perform operation 405 of FIG. 4A, based on at least one of the second conditions (e.g., the listening condition) being satisfied. For example, the electronic device 101 may not output the response, based on the second condition (e.g., the listening condition) being satisfied. For example, the electronic device 101 may receive the subsequent voice input, based on the second condition (e.g., the listening condition) being satisfied. For example, the second condition (e.g., the listening condition) may include an operation of identifying that a gaze of the user, obtained using the camera 220, moves to a location outside a screen of the display 250. For example, the electronic device 101 may identify the gaze of the user of the electronic device 101 by using the camera 220, and receive the subsequent voice input, instead of outputting the response, based on identifying that the gaze of the user moves to a location outside the screen of the display 250. There is no limitation on the type and number of second conditions (e.g., the listening condition). In embodiments of drawings described below, the second condition (e.g., the listening condition) will be described.

In operation 439, according to an embodiment, the electronic device 101 may identify whether another condition (e.g., at least one condition (e.g., a response condition) for outputting a response in FIG. 4B) is satisfied, based on the second condition (e.g., the listening condition) not being satisfied.

FIG. 4D is a flowchart of an operation method of an electronic device according to an embodiment of the disclosure.

FIG. 4D may be described based on the embodiments of FIGS. 1, 2A, 2B, 2C, and 3, the embodiments of FIGS. 4A, 4B, and 4C, and the embodiments described below.

At least some of the operations of FIG. 4D may be omitted. The order of the operations of FIG. 4D may be changed. Operations other than the operations of FIG. 4D may be performed before, during, or after performing the operations of FIG. 4D.

FIG. 4D may be a diagram illustrating the operations of FIG. 4A in chronological order. For example, the operations of FIG. 4D may correspond to an embodiment of the operations of FIG. 4A. A part of the description of the operations of FIG. 4D that overlaps with the description of the operations of FIG. 4A may be omitted.

Referring to FIG. 4D, in operation 441, according to an embodiment, the electronic device 101 may operate in a conversation mode. The operation 441 may be understood with reference to the description of operation 421 of FIG. 4B and the description of operation 401 of FIG. 4A.

In operation 443, according to an embodiment, the electronic device 101 may receive a voice input. Operation 443 may be understood with reference to the description of operation 423 of FIG. 4B. For example, the electronic device 101 may receive a first voice input at a first time point. For example, the electronic device 101 may receive the first voice input through the microphone 210, based on an utterance of a user.

In operation 444, according to an embodiment, the electronic device 101 may identify whether a specified period has elapsed. For example, the electronic device 101 may identify whether a subsequent voice input is received during a specified period (e.g., a first period) from a time point (e.g., the first time point in operation 443) at which the voice input (e.g., the first voice input in operation 443) is received. For example, the electronic device 101 may identify the length of time during which no voice input is received. According to an embodiment, the electronic device 101 may receive a subsequent voice input (e.g., a third voice input subsequent to a second voice input), based on identifying that a subsequent voice input (e.g., the second voice input) is received within the specified period (e.g., the first period) from the time point (e.g., the first time point in operation 443) at which the voice input (e.g., the first voice input in operation 443) is received.

In operation 445, according to an embodiment, the electronic device 101 may identify whether at least one condition (e.g., a response condition) for outputting a response is satisfied, based on identifying that no subsequent voice input is received during the specified period (e.g., the first period) from the time point (e.g., the first time point in operation 443) at which the voice input (e.g., the first voice input in operation 443) is received. The at least one condition (e.g., the response condition) for outputting the response may be understood with reference to the description of operation 425 of FIG. 4B.

In operation 447, according to an embodiment, the electronic device 101 may output a response associated with the voice input, based on at least one of the at least one condition (e.g., the response condition) for outputting the response being satisfied. For example, the electronic device 101 may output a response (e.g., a first response associated with the first voice input) associated with the voice input (e.g., the first voice input in operation 443), based on no subsequent voice input being received during the specified period (e.g., the first period) from the time point (e.g., the first time point in operation 443) at which the voice input (e.g., the first voice input in operation 443) is received, and at least one of the at least one condition (e.g., the response condition) for outputting the response being satisfied. The output of the response (e.g., the first response associated with the first voice input) may be understood with reference to the description of operation 427 of FIG. 4B.

In operation 449, according to an embodiment, the electronic device 101 may receive the subsequent voice input (e.g., the second voice input subsequent to the first voice input), instead of outputting the response (e.g., the first response associated with the first voice input), based on the at least one condition (e.g., the response condition) for outputting the response not being satisfied. For example, the electronic device 101 may wait to receive the subsequent voice input (e.g., the second voice input subsequent to the first voice input), instead of outputting the response (e.g., the first response associated with the first voice input), based on no subsequent voice input being received during the specified period (e.g., the first period) from the time point (e.g., the first time point in operation 443) at which the voice input (e.g., the first voice input in operation 443) is received, and the at least one condition (e.g., the response condition) for outputting the response not being satisfied.

FIG. 4E is a flowchart of an operation method of an electronic device according to an embodiment of the disclosure.

FIG. 4E may be described based on the embodiments of FIGS. 1, 2A, 2B, 2C, and 3, the embodiments of FIGS. 4A, 4B, 4C, and 4D, and the embodiments described below.

At least some of the operations of FIG. 4E may be omitted. The order of the operations of FIG. 4E may be changed. Operations other than the operations of FIG. 4E may be performed before, during, or after performing the operations of FIG. 4E.

FIG. 4E may be a diagram illustrating the operations of FIG. 4A in chronological order. For example, the operations of FIG. 4E may correspond to an embodiment of the operations of FIG. 4A. A part of the description of the operations of FIG. 4E that overlaps with the description of the operations of FIG. 4A may be omitted.

Referring to FIG. 4E, in operation 451, according to an embodiment, the electronic device 101 may continuously identify a gaze of a user toward a screen of the display 250. For example, the user may continuously look at a screen of the electronic device 101. For example, the electronic device 101 may identify a continuous gaze of the user toward the screen of the display 250. For example, the electronic device 101 may identify the continuous gaze of the user toward the screen of the display 250 from before receiving a first voice input to after receiving the first voice input.

In operation 453, according to an embodiment, the electronic device 101 may identify that no subsequent voice input is received during a specified period. For example, while identifying the continuous gaze of the user toward the screen of the display 250, the electronic device 101 may identify that no subsequent voice input is received during the specified period after the first voice input. For example, the user may not make an utterance during the specified period after inputting the first voice input while looking at the screen of the display 250.

In operation 455, according to an embodiment, the electronic device 101 may output a first response associated with the first voice input, based on identifying that no subsequent voice input is received during the specified period from a time point at which the first voice input is received, while identifying the continuous gaze of the user toward the screen of the display 250.

FIG. 4F is a flowchart of an operation method of an electronic device according to an embodiment of the disclosure.

FIG. 4F may be described based on the embodiments of FIGS. 1, 2A, 2B, 2C, and 3, the embodiments of FIGS. 4A, 4B, 4C, 4D, and 4E, and the embodiments described below.

At least some of the operations of FIG. 4F may be omitted. The order of the operations of FIG. 4F may be changed. Operations other than the operations of FIG. 4F may be performed before, during, or after performing the operations of FIG. 4F.

Referring to FIG. 4F, in operation 461, according to an embodiment, the electronic device 101 may activate the camera 220, based on a conversation mode being activated. According to an embodiment, the electronic device 101 may activate the camera 220, based on the conversation mode being activated, according to a configuration (e.g., a first configuration). According to an embodiment, the electronic device 101 may identify whether an event which causes the camera 220 to be activated occurs, based on the conversation mode being activated, according to a configuration (e.g., a second configuration). According to an embodiment, even when the conversation mode is activated, the electronic device 101 may not activate the camera 220, based on another condition not being satisfied. Another condition for activating the camera 220 will be described later.

In operation 463, according to an embodiment, the electronic device 101 may deactivate the camera 220, based on the conversation mode being deactivated. For example, the electronic device 101 may deactivate the camera 220, based on the conversation mode being terminated.

FIG. 5 is a flowchart of an operation method of an electronic device according to an embodiment of the disclosure.

FIG. 5 may be described based on the embodiments of FIGS. 1, 2A, 2B, 2C, and 3, the embodiments of FIGS. 4A, 4B, 4C, 4D, 4E, and 4F, and the embodiments described below.

Referring to FIG. 5, according to an embodiment, the electronic device 101 may identify a positioning state of the electronic device 101, and determine an operation mode, based on another condition depending on the positioning state.

At least some of the operations of FIG. 5 may be omitted. The order of the operations of FIG. 5 may be changed. Operations other than the operations of FIG. 5 may be performed before, during, or after performing the operations of FIG. 5.

Referring to FIG. 5, in operation 501, according to an embodiment, the electronic device 101 may identify a positioning state of the electronic device 101. For example, the electronic device 101 may identify the positioning state of the electronic device 101 by using sensing data (e.g., a sensing value) of at least one sensor (e.g., the first sensor 231 of FIG. 2A) configured to identify an orientation and/or a movement of the electronic device. The positioning state of the electronic device 101 may include a floor state in which a back surface of the electronic device 101 is placed substantially parallel to a floor surface (e.g., a bottom surface of a desk), a standing state in which the back surface of the electronic device 101 is placed at a predetermined angle (e.g., a non-parallel angle) with respect to the floor surface (e.g., the bottom surface of the desk), and a handheld state in which the electronic device 101 is held by a user. For example, the electronic device 101 may identify the floor state, based on identifying a state in which the back surface of the electronic device 101 is substantially parallel to a ground surface and there is no or little movement of the electronic device 101. For example, in the floor state of the electronic device 101, as the display 250 of the electronic device 101 faces upward (e.g., toward the sky), the user may visually recognize the display 250 of the electronic device 101. For example, the electronic device 101 may identify the standing state, based on identifying a state in which the back surface of the electronic device 101 forms a predetermined angle (e.g., a non-parallel angle) with the ground surface and there is no or little movement of the electronic device 101. For example, the electronic device 101 may identify the handheld state, based on detecting a movement of the electronic device 101. According to an embodiment, the electronic device 101 may determine an operation mode, based on another condition depending on the positioning state of the electronic device 101. Some of the conditions depending on the positioning state may overlap with each other.

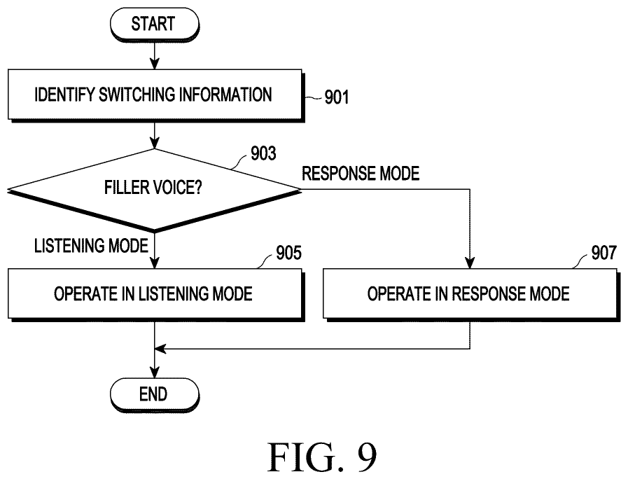

In operation 503, according to an embodiment, in the floor state, the electronic device 101 may determine the operation mode, based on a first condition regarding switching information. The switching information may be information causing an operation mode of a conversation mode to be switched. A condition based on other information identified based on voice data, in addition to the switching information, may be referred to as the first condition. For example, at least one condition (e.g., a response condition) for outputting a response (e.g., a first response) may include an operation of identifying whether the first condition regarding whether a voice input (e.g., voice data) includes the switching information causing the operation mode to be switched is satisfied. In the floor state, the electronic device 101 may determine the operation mode, based on other conditions (e.g., a movement of a mouth, an input through a button, and biometric information) as well as the first condition, and this will be described in the drawings described below. In operation 503, in the floor state, the electronic device 101 may identify the first condition regarding whether the voice data includes the switching information causing the operation mode of the conversation mode to be switched. According to an embodiment, the switching information may include information on a name. For example, based on identifying the name in the voice data, the electronic device 101 may select the operation mode, based on the identified name. An embodiment regarding a name will be described in detail in FIGS. 6 to 8. According to an embodiment, the switching information may include information on a filler voice. For example, based on identifying the filler voice in the voice data, the electronic device 101 may select the operation mode, based on the identified filler voice. An embodiment regarding a filler voice will be described in detail in FIG. 9.

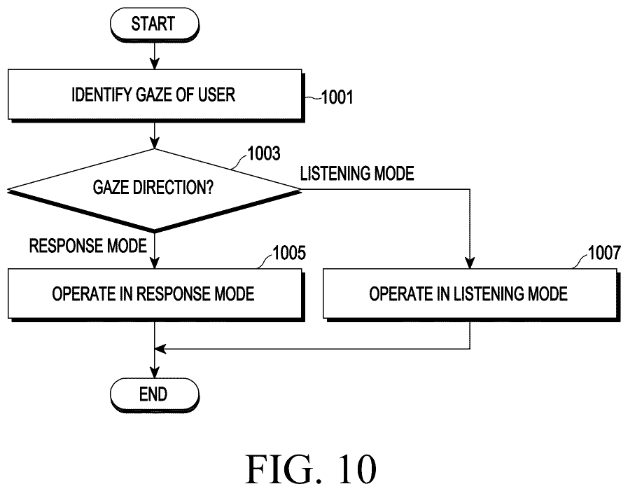

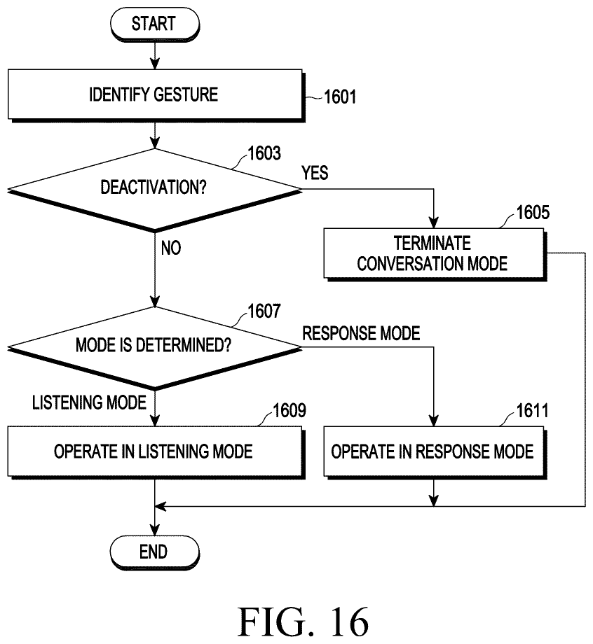

In operation 505, according to an embodiment, in the standing state, the electronic device 101 may determine the operation mode, based on the first condition (e.g., the first condition regarding the switching information in operation 503) and a second condition regarding a gaze direction. For example, in the standing state, the electronic device 101 may determine the operation mode, based on the first condition and/or the second condition. For example, the at least one condition (e.g., the response condition) for outputting the response (e.g., the first response) may include an operation of identifying whether the first condition and/or the second condition regarding the gaze direction of the user is satisfied. In the standing state, the electronic device 101 may determine the operation mode, based on other conditions (e.g., a movement of a mouth, an input through a button, and biometric information) as well as the first condition and/or the second condition, and this will be described in the drawings described below. In operation 505, in the standing state, the electronic device 101 may identify the first condition regarding whether the voice data includes the switching information causing the operation mode of the conversation mode to be switched. In the standing state, the electronic device 101 may determine the operation mode, based on the first condition regarding the switching information. As described above in operation 503, the switching information may include the information on the name or the information on the filler voice, and this will be described in detail in FIGS. 6 to 9. In the standing state, the electronic device 101 may identify the second condition regarding the gaze direction. For example, the electronic device 101 may identify the gaze direction of the user by using the camera 220 of the electronic device 101. In the standing state, the electronic device 101 may determine the operation mode, based on the second condition regarding the gaze direction. An embodiment regarding a gaze direction will be described in detail in FIGS. 10 to 15. A condition based on other information identified based on image data of the camera 220, in addition to the gaze direction, may be referred to as the second condition. For example, the electronic device 101 may identify a gesture and/or a facial expression of the user by using the camera 220 of the electronic device 101. For example, in the standing state, the electronic device 101 may determine the operation mode, based on a condition (e.g., the second condition) regarding a gesture and/or a facial expression. An embodiment regarding a gesture and/or a facial expression will be described in detail in FIGS. 16 to 20.

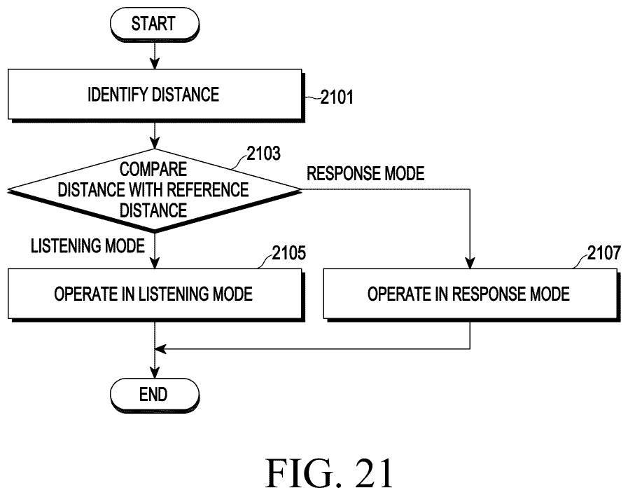

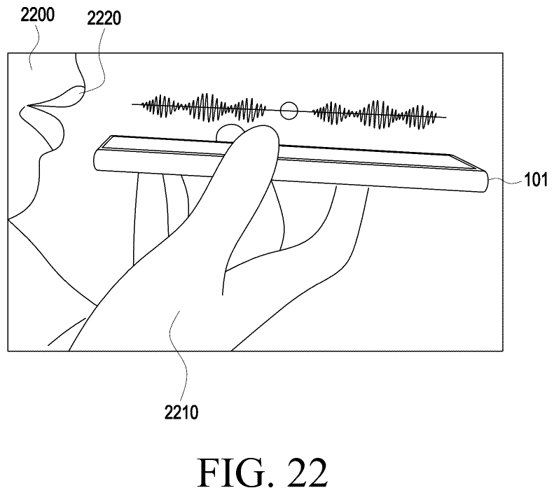

In operation 507, according to an embodiment, in the handheld state, the electronic device 101 may determine the operation mode, based on the first condition (e.g., the first condition regarding the switching information in operation 503), the second condition (e.g., the second condition regarding the gaze direction, gesture, and/or facial expression in operation 505), and a third condition regarding a distance. For example, in the handheld state, the electronic device 101 may determine the operation mode, based on the first condition, the second condition, and/or the third condition. For example, the at least one condition (e.g., the response condition) for outputting the response (e.g., the first response) may include an operation of identifying whether the first condition, the second condition, and/or the third condition regarding a first distance between the electronic device 101 and the user is satisfied. In the handheld state, the electronic device 101 may determine the operation mode, based on other conditions (e.g., a movement of a mouth, an input through a button, and biometric information) as well as the first condition, the second condition, and/or the third condition, and this will be described in the drawings described below. In operation 507, in the handheld state, the electronic device 101 may identify the first condition regarding whether the voice data includes the switching information causing the operation mode of the conversation mode to be switched. In the handheld state, the electronic device 101 may determine the operation mode, based on the first condition regarding the switching information. As described above in operation 503, the switching information may include the information on the name or the information on the filler voice, and this will be described in detail in FIGS. 6 to 9. In the handheld state, the electronic device 101 may identify the second condition (e.g., a condition regarding the gaze direction, gesture, and/or facial expression). In the handheld state, the electronic device 101 may determine the operation mode, based on the second condition (e.g., the condition regarding the gaze direction, gesture, and/or facial expression). As described above in operation 505, the second condition may include a condition regarding a gaze direction, gesture, and/or facial expression, and this will be described in detail in FIGS. 10 to 20. In the handheld state, the electronic device 101 may identify the third condition regarding the distance. For example, the electronic device 101 may identify a distance between the electronic device 101 and the user. For example, the electronic device 101 may identify the distance between the electronic device 101 and the user by using sensing data (e.g., a sensing value) of at least one sensor (e.g., the second sensor 232 of FIG. 2A). For example, the electronic device 101 may identify the distance between the electronic device 101 and the user by using the microphone 210 (e.g., multiple microphones). In the handheld state, the electronic device 101 may determine the operation mode, based on the third condition regarding the distance between the electronic device 101 and the user. An embodiment regarding a distance will be described in detail in FIGS. 21 and 22. A condition based on a distance between an external device (e.g., the external device 3310, 3320, or 3330 of FIG. 33) (e.g., a wearable device) and the user, in addition to the distance between the electronic device 101 and the user, may be referred to as the third condition. For example, the electronic device 101 may identify the distance between the external device (e.g., 3310, 3320, or 3330 of FIG. 33) (e.g., a wearable device) and the user. For example, in the handheld state, the electronic device 101 may determine the operation mode, based on the condition (e.g., the third condition) regarding the distance between the external device (e.g., 3310, 3320, or 3330 of FIG. 33) (e.g., a wearable device) and the user. An embodiment regarding a distance between an external device (e.g., 3310, 3320, 3330 of FIG. 33) (e.g., a wearable device) and a user will be described in detail in FIG. 33.

FIG. 6 is a flowchart of an operation method of an electronic device according to an embodiment of the disclosure.

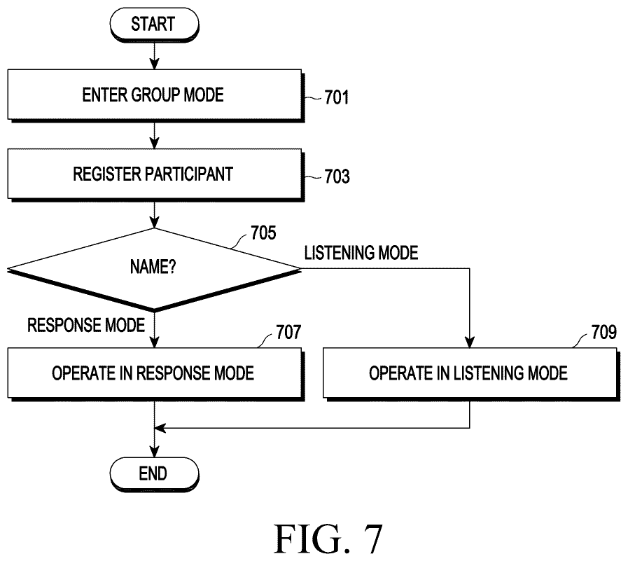

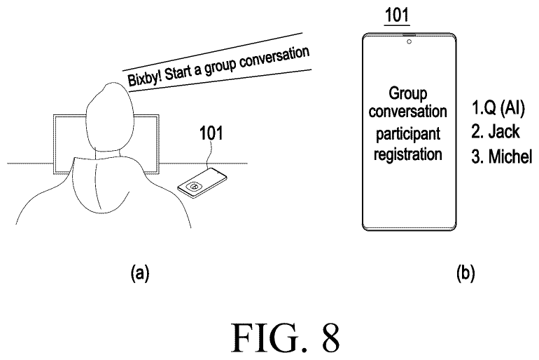

FIG. 6 may be described based on the embodiments of FIGS. 1, 2A, 2B, 2C, 3, 4A, 4B, 4C, 4D, 4E, 4F, and 5, the embodiments of FIGS. 7 and 8, and the embodiments described below.

Referring to FIG. 6, according to an embodiment, based on identifying a name in voice data, the electronic device 101 may select an operation mode, based on the identified name.

At least some of the operations of FIG. 6 may be omitted. The order of the operations of FIG. 6 may be changed. Operations other than the operations of FIG. 6 may be performed before, during, or after performing the operations of FIG. 6.

Referring to FIG. 6, in operation 601, according to an embodiment, the electronic device 101 may identify whether voice data includes switching information causing an operation mode of a conversation mode to be switched. The switching information may be information causing the operation mode of the conversation mode to be switched. For example, the switching information may include information on a name. The electronic device 101 may identify whether the voice data includes the name.

In the operation 603, according to an embodiment, the electronic device 101 may identify the name in the voice data. The name may include a name assigned to an artificial intelligence model (e.g., a voice agent) and/or a name assigned to a user. The electronic device 101 may identify whether the name included in the voice data is the name assigned to the artificial intelligence model (e.g., the voice agent). The electronic device 101 may identify whether the name included in the voice data is the name assigned to the user. The name assigned to the artificial intelligence model (e.g., the voice agent) may include a default name assigned to the artificial intelligence model (e.g., the voice agent) and/or a name assigned to the artificial intelligence model (e.g., the voice agent) by the user. The name assigned to the user may include the default name assigned to the user and/or the name assigned to the user by the user. For example, the user may input information on a name to be assigned to the artificial intelligence model (e.g., the voice agent) and/or information on a name to be assigned to the user. For example, based on the input, the electronic device 101 may identify the information on the name to be assigned to the artificial intelligence model (e.g., the voice agent) and/or the information on the name to be assigned to the user. When the information on the name to be assigned to the artificial intelligence model (e.g., the voice agent) is not input, the electronic device 101 may assign a default name corresponding to the artificial intelligence model (e.g., the voice agent) to the artificial intelligence model (e.g., the voice agent). When the information on the name to be assigned to the user is not input, the electronic device 101 may assign a default name corresponding to the user to the user. There is no limitation on a default name (e.g., the default name corresponding to the artificial intelligence model (e.g., the voice agent) or the default name corresponding to the user). The user may input information on names of others as well as his/her own name, and this will be described below. According to an embodiment, the electronic device 101 may perform an operation for receiving an input of information on a name, before entering the conversation mode. According to an embodiment, the electronic device 101 may perform an operation for receiving an input of information on a name, after entering the conversation mode. According to an embodiment, the information on the name may be changed while the conversation mode is performed.

In operation 605, according to an embodiment, the electronic device 101 may operate in a response mode, based on identifying a name which causes the response mode in the voice data. For example, at least one condition (e.g., a response condition) for outputting a response (e.g., a first response) may include an operation of identifying the name assigned to the artificial intelligence model (e.g., the voice agent) in a voice input (e.g., a first voice input). For example, the electronic device 101 may select the response mode as the operation mode, based on identifying the name assigned to the artificial intelligence model (e.g., the voice agent) in the voice data. According to an embodiment, even when the electronic device 101 fails to identify the name assigned to the artificial intelligence model (e.g., the voice agent) in the voice data, the electronic device 101 may select the response mode as the operation mode, based on identifying an utterance of the user requesting an operation of the artificial intelligence model (e.g., the voice agent) in the voice data according to an analysis of the voice data.

In operation 607, according to an embodiment, the electronic device 101 may operate in a listening mode, based on identifying a name which causes the listening mode in the voice data. For example, the electronic device 101 may select the listening mode as the operation mode, based on identifying the name assigned to the user in the voice data. According to an embodiment, even when the electronic device 101 fails to identify the name assigned to the user in the voice data, the electronic device 101 may select the listening mode as the operation mode, based on identifying the absence of an utterance of the user requesting an operation of the artificial intelligence model (e.g., the voice agent) in the voice data according to an analysis of the voice data.

FIG. 7 is a flowchart of an operation method of an electronic device according to an embodiment of the disclosure.

FIG. 7 may be described based on the embodiments of FIGS. 1, 2A, 2B, 2C, 3, 4A to 4F, 5, and 6, the embodiments of FIG. 8, and the embodiments described below.

FIG. 8 is a diagram illustrating an operation of an electronic device according to an embodiment of the disclosure.

Referring to FIG. 7, according to an embodiment, in a group mode, the electronic device 101 may select an operation mode, based on a name.

At least some of the operations of FIG. 7 may be omitted. The order of the operations of FIG. 7 may be changed. Operations other than the operations of FIG. 7 may be performed before, during, or after performing the operations of FIG. 7.

Referring to FIG. 7, in operation 701, according to an embodiment, the electronic device 101 may enter a group mode. The group mode may be one of operation modes of a conversation mode. The group mode may be a mode in which multiple users participate in a conversation. The opposite concept of the group mode may be referred to as a default mode. The default mode may be a mode in which one user participates in a conversation. The electronic device 101 may enter the group mode, based on identifying an event which causes entry into the group mode in which multiple users participate in a conversation. For example, referring to case (a) of FIG. 8, the electronic device 101 may enter the group mode, based on a call to the group mode. The call to the group mode may be a voice command which causes the electronic device 101 to enter the group mode. For example, the electronic device 101 may enter the group mode, based on receiving voice data corresponding to an utterance including a voice (e.g., “Bixby! Start a group conversation.”) which causes the group mode. According to an embodiment, the electronic device 101 may enter the group mode when a primary user wants to have a conversation with multiple users. According to an embodiment, the primary user may be a user registered as the primary user of the electronic device 101. According to an embodiment, the primary user may be a user having the largest face region in an image acquired through the camera 220. For example, the electronic device 101 may identify the primary user and enter the group mode, based on identifying a voice (e.g., “Bixby! Start a group conversation.”) which causes the group mode in the voice data corresponding to the utterance of the primary user. For example, the electronic device 101 may identify a user registered as the primary user, based on a voice analysis of the voice data. For example, the electronic device 101 may identify a user registered as the primary user, based on a face analysis of image data. For example, the electronic device 101 may compare the sizes of face regions in the image data, so as to determine the user who is the primary user. According to an embodiment, the electronic device 101 may enter the group mode, based on receiving the voice data corresponding to the utterance including the voice (e.g., “Bixby! Start a group conversation.”) which causes the group mode, without distinguishing between the primary user and another user. According to an embodiment, the electronic device 101 may enter the group mode, based on identifying voices of the multiple users in the voice data. For example, the electronic device 101 may enter the group mode, based on identifying the voices of the multiple users in the voice data without a call to the group mode.

In operation 703, according to an embodiment, the electronic device 101 may perform a procedure for registering a participant in the group mode. For example, the electronic device 101 may identify an input for names respectively corresponding to the multiple users, so as to assign the names corresponding to the multiple users in the group mode. For example, in case (b) of FIG. 8, the electronic device 101 may display a screen for registering participants to participate in a group conversation. For example, while the screen for registering the participants to participate in the group conversation is displayed so as to assign the names respectively corresponding to the multiple users, the primary user may input information on the names corresponding to the multiple users into the electronic device 101. The electronic device 101 may assign the names respectively corresponding to the multiple users, based on receiving an input of the information on the names corresponding to the multiple users. According to an embodiment, the electronic device 101 may assign the names respectively corresponding to the multiple users, based on identifying a voice for registering the names corresponding to the multiple users in the voice data, without displaying the screen for registering the participants to participate in the group conversation. For example, a user may utter, “Register Jack and Michel,” and the electronic device 101 may assign the names respectively corresponding to the multiple users, based on the voice data. In case (b) of FIG. 8, in the group mode, the electronic device 101 may receive an input of information on a name corresponding to an artificial intelligence model (e.g., a voice agent). When information on a name to be assigned to the artificial intelligence model (e.g., the voice agent) is not input, the electronic device 101 may assign a default name corresponding to the artificial intelligence model (e.g., the voice agent) to the artificial intelligence model (e.g., the voice agent). In the default mode, the electronic device 101 may also receive an input of the information on the name corresponding to the artificial intelligence model (e.g., the voice agent).

In the operation 705, according to an embodiment, the electronic device 101 may identify a name in the voice data while operating in the group mode. The name may include a name assigned to the artificial intelligence model (e.g., the voice agent) and/or names assigned to the multiple users.

In operation 707, according to an embodiment, in the group mode, the electronic device 101 may operate in a response mode, based on identifying a name which causes the response mode in the voice data. For example, at least one condition (e.g., a response condition) for outputting a response (e.g., a first response) may include an operation of identifying the name assigned to the artificial intelligence model (e.g., the voice agent) in a voice input (e.g., a first voice input). For example, in the group mode, the electronic device 101 may select the response mode as an operation mode, based on identifying the name assigned to the artificial intelligence model (e.g., the voice agent) in the voice data. According to an embodiment, even when the electronic device 101 fails to identify the name assigned to the artificial intelligence model (e.g., the voice agent) in the voice data, the electronic device 101 may select the response mode as the operation mode, based on identifying an utterance of the user requesting an operation of the artificial intelligence model (e.g., the voice agent) in the voice data according to an analysis of the voice data.

In operation 709, according to an embodiment, in the group mode, the electronic device 101 may operate in a listening mode, based on identifying a name which causes the listening mode in the voice data. For example, in the group mode, the electronic device 101 may select the listening mode as the operation mode, based on identifying at least one of the names assigned to the multiple users in the voice data. For example, in the group mode, the electronic device 101 may receive a subsequent voice input, instead of outputting a response, based on identifying at least one of the names corresponding to the multiple users in the voice input.

According to an embodiment, even when the electronic device 101 fails to identify the name assigned to the user in the voice data, the electronic device 101 may select the listening mode as the operation mode, based on identifying the absence of an utterance of the user requesting an operation of the artificial intelligence model (e.g., the voice agent) in the voice data according to an analysis of the voice data.

FIG. 9 is a flowchart of an operation method of an electronic device according to an embodiment of the disclosure.

FIG. 9 may be described based on the embodiments of FIGS. 1, 2A to 2C, 3, 4A to 4F, 5, 6, 7, and 8 and the embodiments described below.

Referring to FIG. 9, according to an embodiment, based on identifying a filler voice (e.g., “Um . . . ,” “Let me think.”) in voice data, the electronic device 101 may select an operation mode, based on the identified filler voice.

At least some of the operations of FIG. 9 may be omitted. The order of the operations of FIG. 9 may be changed. Operations other than the operations of FIG. 9 may be performed before, during, or after performing the operations of FIG. 9.

Referring to FIG. 9, in operation 901, according to an embodiment, the electronic device 101 may identify whether voice data includes switching information causing an operation mode of a conversation mode to be switched. The switching information may be information causing the operation mode of the conversation mode to be switched. For example, the switching information may include information on a filler voice.

In the operation 903, according to an embodiment, the electronic device 101 may identify whether the filler voice is included in the voice data. The filler voice (e.g., “Um . . . ,” “Let me think.”) may be a voice for a word or sentence which serves to buy time for thinking or to connect words. There is no limitation on the types of filler voices.

In operation 905, according to an embodiment, the electronic device 101 may select the listening mode as the operation mode, based on identifying the filler voice (e.g., “Um . . . ,” “Let me think.”) which causes the listening mode in the voice data.

In operation 907, according to an embodiment, the electronic device 101 may select the response mode as the operation mode according to another condition, based on identifying the absence of the filler voice which causes the listening mode in the voice data.

FIG. 10 is a flowchart of an operation method of an electronic device according to an embodiment of the disclosure.

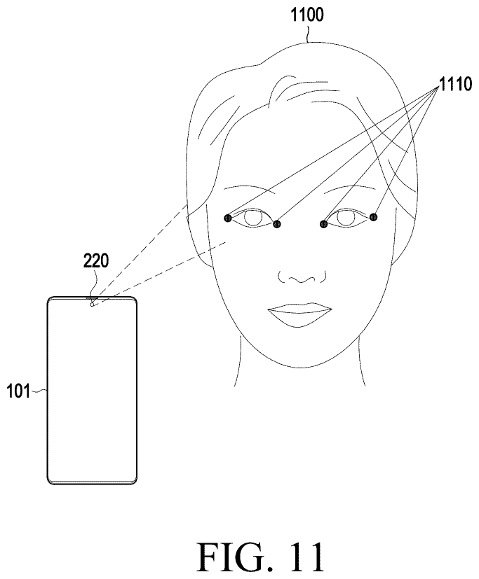

FIG. 10 may be described based on the embodiments of FIGS. 1, 2A to 2C, 3, 4A to 4F, 5, 6, 7, 8, and 9, the embodiments of FIGS. 11 to 15, and the embodiments described below.

FIG. 11 is a diagram illustrating an operation of an electronic device according to an embodiment of the disclosure.

Referring to FIG. 10, according to an embodiment, the electronic device 101 may select an operation mode depending on a gaze direction of a user.

At least some of the operations of FIG. 10 may be omitted. The order of the operations of FIG. 10 may be changed. Operations other than the operations of FIG. 10 may be performed before, during, or after performing the operations of FIG. 10.

Referring to FIG. 10, in operation 1001, according to an embodiment, the electronic device 101 may identify a gaze of a user. For example, the electronic device 101 may identify a gaze direction of the user by using the camera 220 of the electronic device 101. For example, in FIG. 11, the electronic device 101 may configure a specific point (e.g., an end point) of an eye of a user 1100 as a tracking point (e.g., 1110) in an image acquired using the camera 220. The electronic device 101 may identify a gaze of the user 1100 by tracking the position of the tracking point (e.g., 1110) corresponding to the eye of the user 1100.

In operation 1003, according to an embodiment, the electronic device 101 may identify the gaze direction of the user, and determine an operation mode of a conversation mode, based on the gaze direction. For example, the electronic device 101 may identify only a gaze of a primary user or may identify gazes of multiple users participating in a conversation. An operation of identifying the primary user may be understood with reference to the description of operation 701 of FIG. 7.

In operation 1005, according to an embodiment, the electronic device 101 may select a response mode as the operation mode, based on identifying a gaze in a first direction toward the electronic device 101 (e.g., a screen of the display 250). For example, at least one condition (e.g., a response condition) for outputting a response (e.g., a first response) may include an operation of identifying the gaze in the first direction toward the electronic device 101 (e.g., the screen of the display 250). For example, the electronic device 101 may select the response mode as the operation mode, based on a gaze direction of the gaze of the primary user being in the first direction toward the electronic device 101 (e.g., the screen of the display 250). For example, the electronic device 101 may select the response mode as the operation mode, based on gaze directions of gazes of the other users participating in the conversation as well as the gaze of the primary user being in the first direction toward the electronic device 101 (e.g., the screen of the display 250). According to an embodiment, the electronic device 101 may ignore the gazes of the other users, based on the gaze directions of the gazes of the other users other than the primary user being in the first direction toward the electronic device 101 (e.g., the screen of the display 250). According to an embodiment, based on identifying another gaze of a person other than the users participating in the conversation, the electronic device 101 may ignore said another gaze.

In operation 1007, according to an embodiment, the electronic device 101 may select a listening mode as the operation mode, based on a failure to identify the gaze in the first direction (e.g., a direction toward the electronic device 101 (e.g., the screen of the display 250)). The electronic device 101 may select the listening mode as the operation mode, based on identifying a gaze directed toward a direction other than the first direction (e.g., the direction toward the electronic device 101 (e.g., the screen of the display 250)). According to an embodiment, the electronic device 101 may also select the response mode as the operation mode, based on another condition, even when the electronic device 101 identifies the gaze directed toward the direction other than the first direction (e.g., the direction toward the electronic device 101 (e.g., the screen of the display 250)).

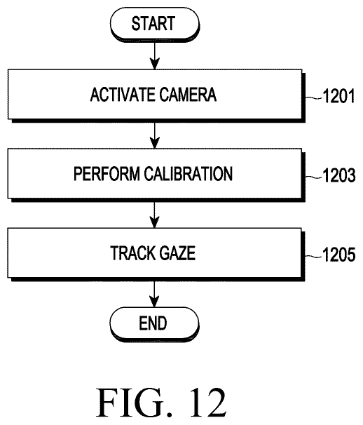

FIG. 12 is a flowchart of an operation method of an electronic device according to an embodiment of the disclosure.

Referring to FIG. 12, in operation 1201, according to an embodiment, the electronic device 101 may activate the camera 220. The electronic device 101 may activate the camera 220 so as to acquire image data. For example, the electronic device 101 may activate the camera 220 of the electronic device 101, based on identifying a standing state or a handheld state. The electronic device 101 may activate the camera 220 so as to acquire image data in the standing state or the handheld state. For example, the electronic device 101 may not activate the camera 220 in a floor state.

In operation 1203, according to an embodiment, the electronic device 101 may perform calibration of the camera 220. For example, the electronic device 101 may perform the calibration of the camera 220 in the standing state or the handheld state. The calibration may be an operation of detecting a position of a user's eye and testing to enable tracking of a tracking point corresponding to the eye in image data in order to track a gaze through the camera 220. For example, the electronic device 101 may perform the calibration by detecting the user's eye, configuring the tracking point corresponding to the eye, displaying an object (e.g., a dot displayed on a screen) at a reference point on the screen, and identifying the movement of the tracking point when the user looks at the object. The electronic device 101 may also correct a calibration result by displaying an object (e.g., a dot displayed on the screen) at an additional reference point in order to test the accuracy after the calibration is performed, and identifying the movement of the tracking point when the user looks at the object. For example, in a positioning state, the calibration may be easily performed since there is no or little movement of the camera 220, but in the handheld state, the calibration of the camera 220 may not be completed due to the movement of the electronic device 101. When the calibration is not possible (e.g., when tracking of a gaze direction fails), the electronic device 101 may notify the user that the user's eye is not recognized, deactivate the camera 220, and determine an operation mode, based on the remaining conditions except for a condition related to a gaze.

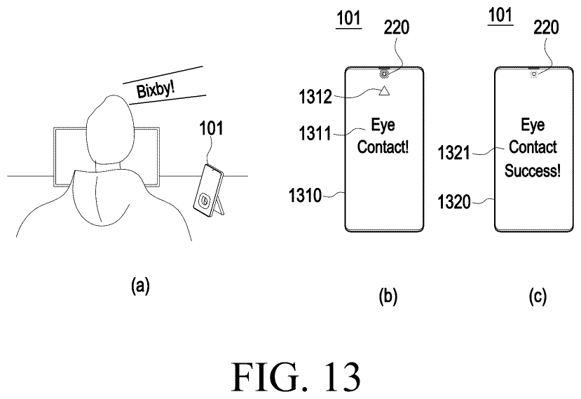

FIG. 13 is a diagram illustrating an operation of an electronic device according to an embodiment of the disclosure.

For example, in case (a) of FIG. 13, the electronic device 101 may enter a conversation mode, based on identifying a call (e.g., “Bixby!”) of the user in the standing state. The electronic device 101 may perform calibration of the camera 220 as the electronic device 101 enters the conversation mode in the standing state. For example, in case (b) of FIG. 13, the electronic device 101 may display a screen 1310 including a guidance text (e.g., 1311) telling the user to look at the camera 220. For example, the electronic device 101 may display an object (e.g., 1312) which guides the position of the camera 220. For example, the electronic device 101 may apply an effect (e.g., an effect applied to a region surrounding the camera 220 on the screen) which guides the position of the camera 220. Accordingly, in case (b) of FIG. 13, the user may look at the camera 220. Thereafter, the electronic device 101 may perform the calibration and display a screen 1320 including a text (e.g., 1321) indicating completion of the calibration in case (c) of FIG. 13. For example, the electronic device 101 may apply an effect indicating the completion of the calibration. For example, the effect indicating the completion of the calibration may be an effect applied to the region surrounding the camera 220 on the screen 1320, and may be a different effect from the effect in case (b) of FIG. 13. For example, the color of the effect in case (b) of FIG. 13 and the color of the effect in case (c) of FIG. 13 may be different. The description of the effect is exemplary, and those skilled in the art will understand that various effects may be applied.

In operation 1205, according to an embodiment, the electronic device 101 may track the user's gaze, based on the completion of the calibration, and determine the operation mode, based on a gaze direction. The determination of the operation mode based on the gaze direction may be understood with reference to the embodiments described above.

According to an embodiment, the electronic device 101 may deactivate the camera 220, based on a transition to the floor state, a failure in tracking the gaze direction, or a termination of the conversation mode.

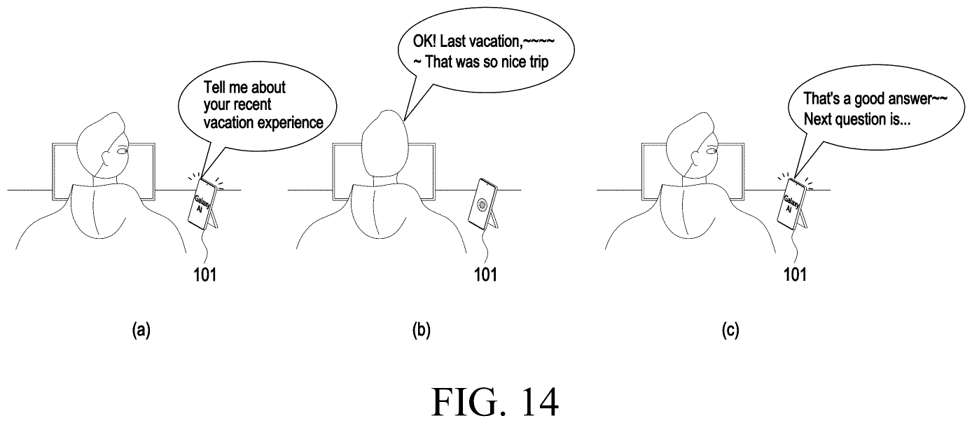

FIG. 14 is a diagram illustrating an operation of an electronic device according to an embodiment of the disclosure.

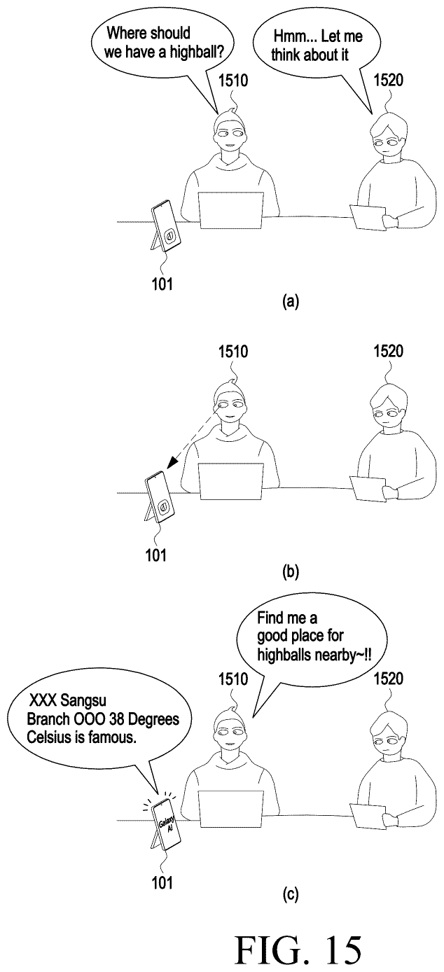

FIG. 15 is a diagram illustrating an operation of an electronic device according to an embodiment of the disclosure.

Referring to FIGS. 14 and 15, a condition regarding a gaze will be described.

For example, referring to FIG. 14, a user may or may not look at the electronic device 101 while performing English conversation practice. For example, in case (a) of FIG. 14, the user may practice English conversation by using the electronic device 101. According to an embodiment, while the user performs English conversation practice, the electronic device 101 may select a listening mode as an operation mode, based on identifying a gaze of the user who does not look at the electronic device 101, for example, as in case (b) of FIG. 14. According to an embodiment, while the user performs English conversation practice, the electronic device 101 may select a response mode as the operation mode, based on identifying a gaze of the user who looks at the electronic device 101, for example, as in case (c) of FIG. 14. Accordingly, the user may control an operation mode of a conversation mode of the electronic device 101 through an action of looking at or not looking at the electronic device 101.

For example, referring to FIG. 15, a first user 1510 and a second user 1520 may have a conversation around the electronic device 101. In case (a) of FIG. 15, the electronic device 101 may select a listening mode as an operation mode, based on a failure to identify gazes of the first user 1510 and the second user 1520 looking at the electronic device 101. The electronic device 101 may select the listening mode as the operation mode, based on identifying the gaze of the first user 1510 directed toward a different direction from a direction toward the electronic device 101 and the gaze of the second user 1520 directed toward a different direction from a direction toward the electronic device 101. In case (a) of FIG. 15, the electronic device 101 may store, in the memory 130, voice data acquired during the listening mode. Thereafter, in case (b) of FIG. 15, the first user 1510 may look at the electronic device 101. The electronic device 101 may select a response mode as the operation mode, based on identifying the gaze of the first user 1510 directed toward the electronic device 101. In case (c) of FIG. 15, the electronic device 101 may identify response information generated based on voice data (e.g., “Find me a good place for highballs nearby”), and output a response (e.g., “XXX Sangsu branch OOO 38 Degrees Celsius is famous.”), based on the identified response information. According to an embodiment, even when separate voice data is not acquired after switching to the response mode, the electronic device 101 may identify response information generated based on voice data (e.g., voice data stored during the listening mode in case (a) of FIG. 15) accumulated while operating in a conversation mode, and output the response (e.g., “XXX Sangsu branch OOO 38 Degrees Celsius is famous.”), based on the identified response information.

FIG. 16 is a flowchart of an operation method of an electronic device according to an embodiment of the disclosure.

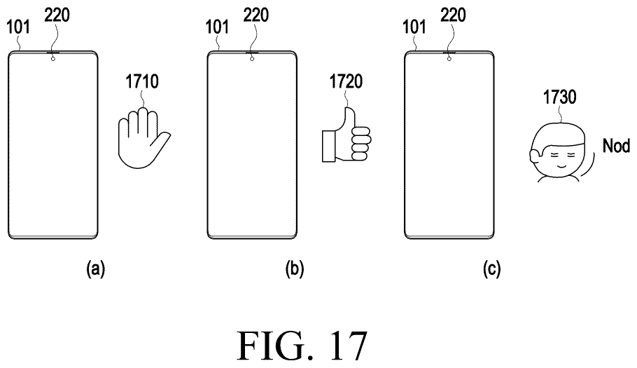

FIG. 16 may be described based on the embodiments of FIGS. 1, 2A to 2C, 3, 4A to 4F, and 5 to 15, the embodiments of FIGS. 17 to 20, and the embodiments described below.

FIG. 17 is a diagram illustrating an operation of an electronic device according to an embodiment of the disclosure.

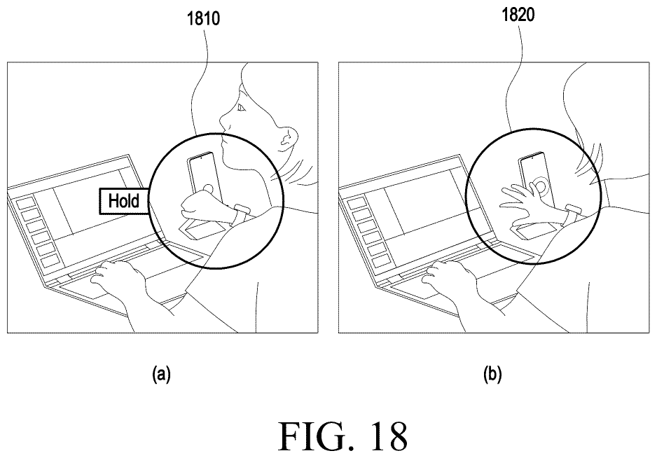

FIG. 18 is a diagram illustrating an operation of an electronic device according to an embodiment of the disclosure.

FIG. 19 is a diagram illustrating an operation of an electronic device according to an embodiment of the disclosure.

FIG. 20 is a diagram illustrating an operation of an electronic device according to an embodiment of the disclosure.

Referring to FIG. 16, according to an embodiment, the electronic device 101 may select an operation mode depending on a gesture of a user.

At least some of the operations of FIG. 16 may be omitted. The order of the operations of FIG. 16 may be changed. Operations other than the operations of FIG. 16 may be performed before, during, or after performing the operations of FIG. 16.

Referring to FIG. 16, in operation 1601, according to an embodiment, the electronic device 101 may identify a gesture of a user. For example, the electronic device 101 may identify the gesture of the user by using the camera 220 of the electronic device 101. For example, the electronic device 101 may identify feature points corresponding to the body of the user in an image acquired using the camera 220, and identify the gesture of the user, based on a combination of the feature points corresponding to the body and the movement of the feature points. According to an embodiment, the electronic device 101 may also identify a facial expression of the user. For example, the electronic device 101 may identify feature points corresponding to the face of the user in the image acquired using the camera 220, and identify the facial expression of the user, based on a combination of the feature points corresponding to the face and the movement of the feature points.

In operation 1603, according to an embodiment, the electronic device 101 may identify whether there is a gesture (or facial expression) which causes deactivation.

In operation 1605, according to an embodiment, the electronic device 101 may terminate or temporarily pause a conversation mode, based on identifying the gesture (or facial expression) which causes deactivation in the image acquired using the camera 220. The electronic device 101 may deactivate the camera 220, based on identifying the gesture (or facial expression) which causes deactivation. For example, in case (a) of FIG. 17, the electronic device 101 may register a first gesture 1710 (e.g., a gesture of opening a hand and showing a palm) as a gesture which causes deactivation. The electronic device 101 may terminate the conversation mode or temporarily pause the conversation mode, based on identifying the gesture (e.g., a gesture of opening a hand and showing a palm) which causes deactivation. According to an embodiment, the electronic device 101 may terminate the conversation mode or temporarily pause the conversation mode, based on the identified gesture being the first gesture (e.g., a gesture of opening a hand and showing a palm), while a gaze in a first direction toward the electronic device 101 (e.g., a screen of the display 250) is not identified.

In operation 1607, according to an embodiment, the electronic device 101 may identify whether there is a gesture (or facial expression) which causes switching of an operation mode. According to an embodiment, the electronic device 101 may switch the operation mode, based on identifying the gesture which causes switching of the operation mode. According to an embodiment, a gesture which causes switching from a listening mode to a response mode, and a gesture which causes switching from the response mode to the listening mode may be different.

In operation 1609, according to an embodiment, the electronic device 101 may select the listening mode as the operation mode, based on identifying a gesture which causes the listening mode in the image acquired using the camera 220. According to an embodiment, the electronic device 101 may select the listening mode as the operation mode, based on the identified gesture being the gesture which causes the listening mode, while the gaze in the first direction toward the electronic device 101 (e.g., the screen of the display 250) is not identified. For example, the electronic device 101 may receive a subsequent voice input, instead of outputting a response, based on identifying the gesture which causes the listening mode. For example, while the user's gaze is not identified, the electronic device 101 may receive a subsequent voice input, instead of outputting a response, based on identifying the gesture which causes the listening mode. For example, in case (b) of FIG. 17, the electronic device 101 may select the listening mode as the operation mode, based on identifying a second gesture 1720 (e.g., a thumbs up) which causes the listening mode.

In operation 1611, according to an embodiment, the electronic device 101 may select the response mode as the operation mode, based on identifying a gesture which causes the response mode in the image acquired using the camera 220. For example, at least one condition (e.g., a response condition) for outputting a response (e.g., a first response) may include an operation of identifying a gesture which causes the response. According to an embodiment, the electronic device 101 may select the response mode as the operation mode, based on the identified gesture being the gesture which causes the response mode, while the gaze in the first direction toward the electronic device 101 (e.g., the screen of the display 250) is not identified. For example, the electronic device 101 may output the response associated with the voice input, based on identifying the gesture which causes the response. For example, the electronic device 101 may output the response associated with the voice input, based on identifying the gesture which causes the response, while the user's gaze is not identified. For example, in case (c) of FIG. 17, the electronic device 101 may select the response mode as the operation mode, based on identifying a third gesture 1730 (e.g., nodding) which causes the response mode.

According to an embodiment, a gesture which causes switching from the listening mode to the response mode and a gesture which causes switching from the response mode to the listening mode may be the same. For example, the electronic device 101 may switch from the listening mode to the response mode, based on identifying the gesture which causes switching of the operation mode. Thereafter, the electronic device 101 may switch from the response mode to the listening mode, based on identifying the same gesture which causes switching of the operation mode. As the gesture which causes switching of the operation mode is repeated, the electronic device 101 may continuously switch from the listening mode to the response mode or from the response mode to the listening mode.

According to an embodiment, the electronic device 101 may learn the user's gesture, facial expression, and gaze. For example, the electronic device 101 may perform learning by using an artificial intelligence model (e.g., a voice agent), based on data about the user's gesture, facial expression, and gaze and data about the user's intent. The electronic device 101 may identify the user's intent corresponding to at least one combination of the user's gesture, facial expression, or gaze. The electronic device 101 may infer the user's intent by using the artificial intelligence model (e.g., the voice agent) by using information on the user's gesture, facial expression, and gaze as input data. The electronic device 101 may identify the information on the user's gesture, facial expression, and gaze in image data, infer the user's intent, based on the identified information on the gesture, facial expression, and gaze, and determine the listening mode or the response mode as the operation mode, based on the user's intent.

Referring to FIGS. 18 and 19, a gesture which causes pausing of a conversation mode or causes a listening mode and a gesture which causes reactivation of the conversation mode or causes a response mode may be described.

In case (a) of FIG. 18, according to an embodiment, the electronic device 101 may temporarily pause a conversation mode or operate in a listening mode, based on identifying a first gesture 1810 (e.g., a clenched fist) which causes pausing of the conversation mode or causes the listening mode. For example, the electronic device 101 may identify the first gesture 1810 (e.g., a clenched fist), based on image data, and temporarily pause the conversation mode or operate in the listening mode.

In case (b) of FIG. 18, according to an embodiment, the electronic device 101 may reactivate the conversation mode or operate in a response mode, based on identifying a second gesture 1820 (e.g., an open hand) which causes reactivation of the conversation mode or causes the response mode. For example, the electronic device 101 may identify the second gesture 1820 (e.g., an open hand), based on the image data, and reactivate the conversation mode or operate in the response mode.

In case (a) of FIG. 19, according to an embodiment, the electronic device 101 may temporarily pause a conversation mode or operate in a listening mode, based on identifying a first gesture 1910 (e.g., a clenched fist) which causes pausing of the conversation mode or causes the listening mode. For example, the electronic device 101 may receive a signal indicating that the first gesture 1910 (e.g., a clenched fist) is identified from a wearable device 1900 worn on a user's wrist, and may temporarily pause the conversation mode or operate in the listening mode. For example, the wearable device 1900 may identify the user's first gesture 1910 (e.g., a clenched fist), based on a bio signal, and transmit a signal indicating that the first gesture 1910 (e.g., a clenched fist) is identified to the electronic device 101.

In case (b) of FIG. 19, according to an embodiment, the electronic device 101 may temporarily reactivate a conversation mode or operate in the response mode, based on identifying a second gesture 1920 (e.g., an open hand) which causes reactivation of the conversation mode or causes a response mode. For example, the electronic device 101 may receive a signal indicating that the second gesture 1920 (e.g., an open hand) is identified from the wearable device 1900 worn on the user's wrist, and may reactivate the conversation mode or operate in the response mode. For example, the wearable device 1900 may identify the user's second gesture 1920 (e.g., an open hand), based on a bio signal, and transmit a signal indicating that the second gesture 1920 (e.g., an open hand) is identified to the electronic device 101.

Referring to FIG. 20, a condition regarding a gesture will be described.

For example, referring to FIG. 20, a user may control the electronic device 101 through a gesture without looking at the electronic device 101 while performing English conversation practice. For example, in case (a) of FIG. 20, the user may practice English conversation by using the electronic device 101. According to an embodiment, in case (b) of FIG. 20, the electronic device 101 may select a listening mode as an operation mode, based on identifying the user's gaze not directed toward the electronic device 101, while the user performs English conversation practice. According to an embodiment, in case (c) of FIG. 20, the electronic device 101 may select a response mode as the operation mode, based on identifying a gesture (e.g., a nod) which causes the response mode, despite identifying the user's gaze not directed toward the electronic device 101, while the user performs English conversation practice.

FIG. 21 is a flowchart of an operation method of an electronic device according to an embodiment of the disclosure.

FIG. 21 may be described based on the embodiments of FIGS. 1, 2A to 2C, 3, 4A to 4F, and 5 to 20, the embodiments of FIG. 22, and the embodiments described below.

FIG. 22 is a diagram illustrating an operation of an electronic device according to an embodiment of the disclosure.

Referring to FIG. 21, according to an embodiment, the electronic device 101 may select an operation mode depending on a distance between the electronic device 101 and a user. According to an embodiment, the electronic device 101 may also select the operation mode depending on a distance between an external device (e.g., the external device 3310, 3320, or 3330 of FIG. 33) and the user.

At least some of the operations of FIG. 21 may be omitted. The order of the operations of FIG. 21 may be changed. Operations other than the operations of FIG. 21 may be performed before, during, or after performing the operations of FIG. 21.

Referring to FIG. 21, in operation 2101, according to an embodiment, the electronic device 101 may identify a distance between the electronic device 101 and the user. For example, the electronic device 101 may identify the distance between the electronic device 101 and the user, based on at least one sensor (e.g., the second sensor 232 of FIG. 2A). For example, the electronic device 101 may identify the distance between the electronic device 101 and the user by using the microphone 210 (e.g., multiple microphones). The operation of identifying the distance has been described above. According to an embodiment, the electronic device 101 may perform an operation of measuring the distance between the electronic device 101 and the user, based on identifying a handheld state.

In operation 2103, according to an embodiment, the electronic device 101 may identify whether the electronic device 101 and the user are in close proximity by comparing the distance between the electronic device 101 and the user with a reference distance.

In operation 2105, according to an embodiment, the electronic device 101 may select a listening mode as an operation mode, based on the distance between the electronic device 101 and the user being less than the reference distance. For example, in FIG. 22, a user 2200 may control the electronic device 101 to operate in the listening mode by bringing the electronic device 101 close to a mouth 2220 while holding the electronic device 101 with a hand 2210.

In operation 2107, according to an embodiment, the electronic device 101 may select a response mode as the operation mode, based on the distance between the electronic device 101 and the user being greater than or equal to the reference distance. For example, at least one condition (e.g., a response condition) for outputting a response (e.g., a first response) may include an operation of identifying that the distance between the electronic device 101 and the user is greater than or equal to the reference distance. For example, the user may control the electronic device 101 to operate in the response mode by positioning the electronic device 101 away from the user while holding the electronic device 101 with the hand.

According to an embodiment, the electronic device 101 may stop measuring the distance between the electronic device 101 and the user, based on a transition to a floor state or a standing state, or a termination of a conversation mode.

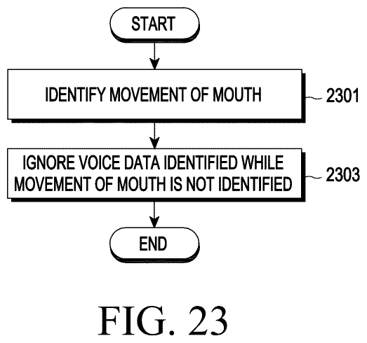

FIG. 23 is a flowchart of an operation method of an electronic device according to an embodiment of the disclosure.

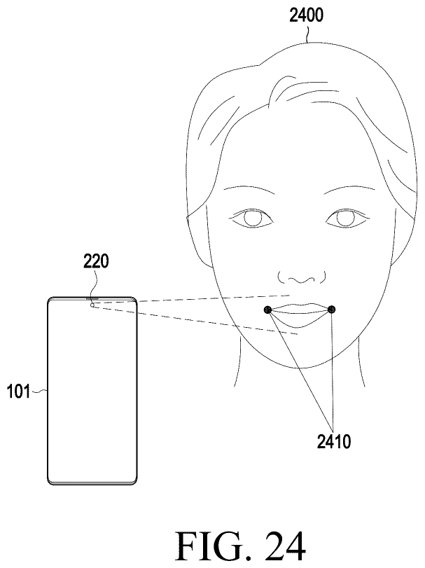

FIG. 23 may be described based on the embodiments of FIGS. 1, 2A to 2C, 3, 4A to 4F, and 5 to 22, the embodiments of FIG. 24, and the embodiments described below.

FIG. 24 is a diagram illustrating an operation of an electronic device according to an embodiment of the disclosure.

Referring to FIG. 23, according to an embodiment, the electronic device 101 may select an operation mode depending on the shape of the mouth of a user.

At least some of the operations of FIG. 23 may be omitted. The order of the operations of FIG. 23 may be changed. Operations other than the operations of FIG. 23 may be performed before, during, or after performing the operations of FIG. 23.

Referring to FIG. 23, in operation 2301, according to an embodiment, the electronic device 101 may identify the movement of the mouth of the user. For example, in FIG. 24, the electronic device 101 may configure a point corresponding to the mouth of a user 2400 in an image acquired using the camera 220 of the electronic device 101 as a tracking point 2410. The electronic device 101 may identify the movement of the mouth of the user 2400 by tracking the position of the tracking point 2410 corresponding to the mouth of the user 2400.

In operation 2303, according to an embodiment, the electronic device 101 may ignore voice data identified while there is no movement of the mouth of the user. The electronic device 101 may ignore voice data identified while the movement of the mouth of the user is not identified. For example, the electronic device 101 may not store, in the memory 130, the voice data identified while the movement of the mouth of the user is not identified. For example, the electronic device 101 may ignore switching information even when the switching information is identified in the voice data identified while the movement of the mouth of the user is not identified.

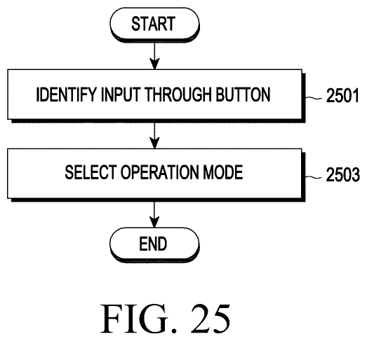

FIG. 25 is a flowchart of an operation method of an electronic device according to an embodiment of the disclosure.

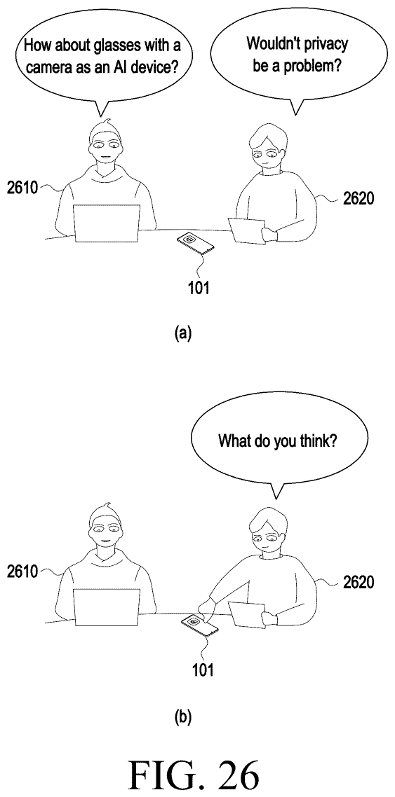

FIG. 25 may be described based on the embodiments of FIGS. 1, 2A to 2C, 3, 4A to 4F, and 5 to 24, the embodiments of FIG. 26, and the embodiments described below.

FIG. 26 is a diagram illustrating an operation of an electronic device according to an embodiment of the disclosure.

Referring to FIG. 25, according to an embodiment, the electronic device 101 may select an operation mode according to an input through a button.

At least some of the operations of FIG. 25 may be omitted. The order of the operations of FIG. 25 may be changed. Operations other than the operations of FIG. 25 may be performed before, during, or after performing the operations of FIG. 25.

Referring to FIG. 25, in operation 2501, according to an embodiment, the electronic device 101 may identify an input through a button. The button may be a hardware button of the electronic device 101 or a software button displayed on a screen of the display 250 of the electronic device 101. For example, a user may press a hardware button or touch a software button.

In operation 2503, according to an embodiment, the electronic device 101 may determine an operation mode, based on the input through the button. According to an embodiment, based on the input through the button not being identified, the electronic device 101 may determine the operation mode, based on another condition. According to an embodiment, the electronic device 101 may select a response mode as the operation mode, based on the input through the button being identified. For example, at least one condition (e.g., a response condition) for outputting a response may include an operation of identifying the input through the button. For example, the electronic device 101 may output a response associated with a voice input, based on identifying the input through the button. For example, the electronic device 101 may operate in the response mode when the user makes an utterance while pressing (or touching) the button, or when the user makes an utterance after pressing (or touching) the button. For example, in FIG. 26, a first user 2610 and a second user 2620 may be located around the electronic device 101. In case (a) of FIG. 26, based on an input through a button not being identified, the electronic device 101 may determine the operation mode, based on another condition. For example, in case (a) of FIG. 26, the electronic device 101 may operate in a listening mode, based on another condition. In case (a) of FIG. 26, the electronic device 101 may store, in the memory 130, voice data acquired while operating in the listening mode. Thereafter, in case (b) of FIG. 26, the electronic device 101 may operate in a response mode, based on an input through a button being identified. For example, in case (b) of FIG. 26, the user may utter “What do you think?” while pressing the button. The electronic device 101 may operate in the response mode, based on the input through the button being identified, and may output a response (e.g., sound) by using voice data accumulated during a conversation mode, based on identifying an utterance requesting an operation of the electronic device 101 in the voice data.

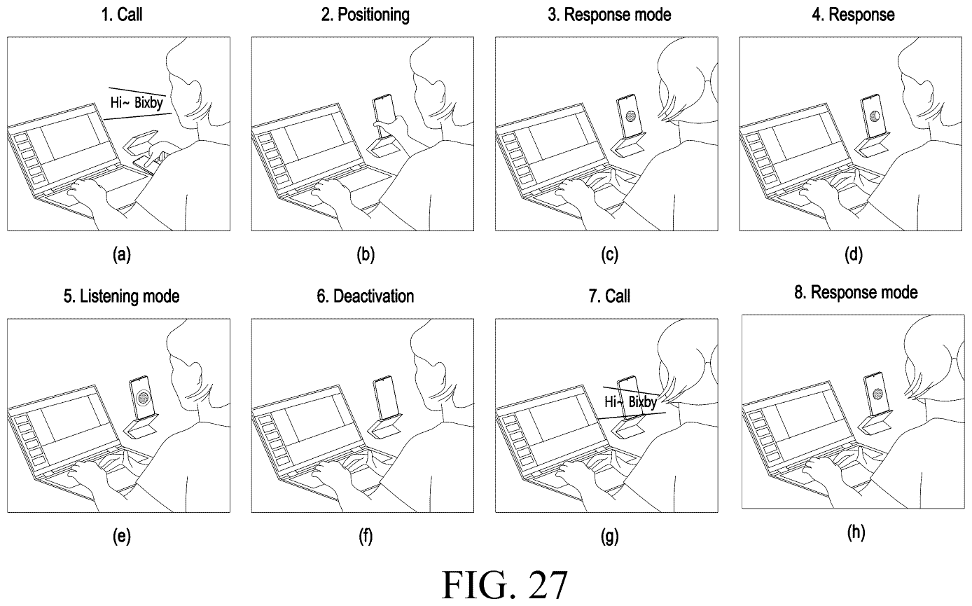

FIG. 27 is a diagram illustrating an operation of an electronic device according to an embodiment of the disclosure.

FIG. 27 may be described based on the embodiments of FIGS. 1, 2A to 2C, 3, 4A to 4F, and 5 to 26 and the embodiments described below.

In case (a) of FIG. 27, according to an embodiment, the electronic device 101 may enter a conversation mode, based on identifying a call (e.g., “Hi, Bixby”) to the electronic device 101. In case (b) of FIG. 27, according to an embodiment, the electronic device 101 may identify a standing state in which the electronic device 101 is placed on a stand. In case (c) of FIG. 27, according to an embodiment, in the standing state, the electronic device 101 may operate in a response mode, based on a gaze direction of a user toward the electronic device 101. In case (d) of FIG. 27, while the electronic device 101 responds, the user may look in a different direction. According to an embodiment, the electronic device 101 may switch to a listening mode after outputting a response in the response mode, based on identifying the user's gaze directed toward a different direction. According to an embodiment, the electronic device 101 may stop outputting the response in the response mode and switch to the listening mode, based on identifying the user's gaze directed toward a different direction. In case (e) of FIG. 27, according to an embodiment, the electronic device 101 may maintain the listening mode, based on identifying that the user is not looking at the electronic device 101. In case (f) of FIG. 27, according to an embodiment, the electronic device 101 may deactivate the camera 220 and stop the conversation mode, based on voice data not being acquired for a specified time. In case (g) of FIG. 27, according to an embodiment, the electronic device 101 may reactivate the conversation mode, based on identifying a call (e.g., “Hi, Bixby”) to the electronic device 101. In case (h) of FIG. 27, according to an embodiment, when the conversation mode is reactivated, the electronic device 101 may use voice data stored before the conversation mode is stopped, while performing the conversation mode. For example, the electronic device 101 may identify response information generated using the voice data stored before the conversation mode is stopped, and output a response (e.g., sound), based on the identified response information.

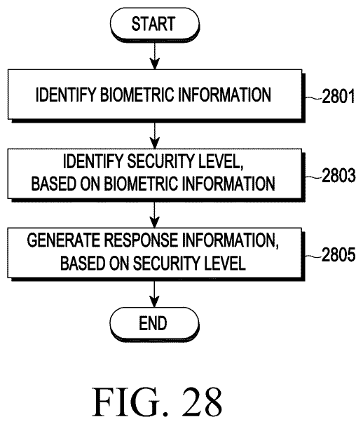

FIG. 28 is a flowchart of an operation method of an electronic device according to an embodiment of the disclosure.

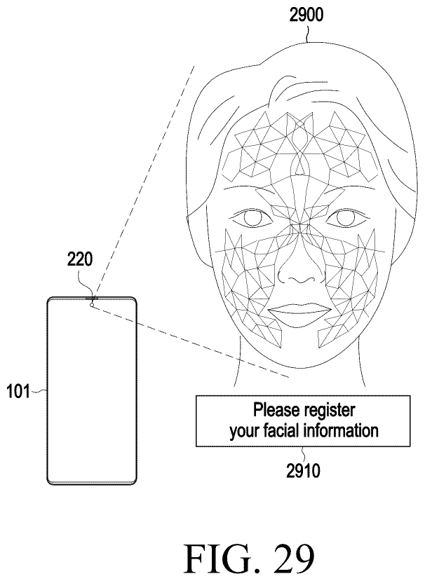

FIG. 28 may be described based on the embodiments of FIGS. 1, 2A to 2C, 3, 4A to 4F, and 5 to 27, the embodiments of FIG. 29, and the embodiments described below.

FIG. 29 is a diagram illustrating an operation of an electronic device according to an embodiment of the disclosure.

Referring to FIG. 28, according to an embodiment, the electronic device 101 may identify a security level for each user and determine the level of response, based on the security level.

At least some of the operations of FIG. 28 may be omitted. The order of the operations of FIG. 28 may be changed. Operations other than the operations of FIG. 28 may be performed before, during, or after performing the operations of FIG. 28.

Referring to FIG. 28, in operation 2801, according to an embodiment, the electronic device 101 may identify biometric information of a user. The biometric information may be information on the body of the user identified in image data. For example, the biometric information may include information on the face of the user. For example, the electronic device 101 may identify a face region in image data acquired through the camera 220, and acquire biometric information from the face region. For example, in FIG. 29, the electronic device 101 may identify facial feature points in the image data acquired through the camera 220, and acquire biometric information on the face of the user, based on the identified feature points.

In operation 2803, according to an embodiment, the electronic device 101 may identify a security level of the user, based on the biometric information. For example, the electronic device 101 may store information on a security level for each user in the memory 130. The electronic device 101 may store, in the memory 130, matching information on the correspondence between the security level and the biometric information of the user. For example, the electronic device 101 may identify a security level corresponding to the user by identifying a security level matching the biometric information identified in the image data acquired through the camera 220, in the matching information.

In operation 2805, according to an embodiment, the electronic device 101 may generate response information, based on the security level. The security level may be a criterion for determining the level of response. For example, the electronic device 101 may generate response information at a level corresponding to the security level of the user in a response mode. The higher the security level, the greater the amount of information included in the response information or the greater the amount of security information included in the response information. The security information may be information configured to be disclosed only to a registered user. The lower the security level, the smaller the amount of information included in the response information or the smaller the amount of security information included in the response information. When the security level is the lowest level, the response information may not include security information. According to the embodiment of FIG. 28, the electronic device 101 may recognize the face of the user, generate response information at different levels according to a security level for each user, and output a response (e.g., sound), based on the generated response information. According to an embodiment, in FIG. 29, the electronic device 101 may output a message 2910 (e.g., a screen or sound) requesting registration, based on that the face of a user 2900 is not a registered face.

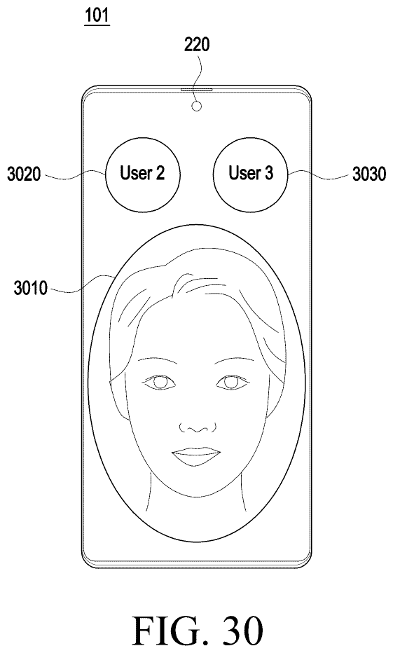

FIG. 30 is a diagram illustrating an operation of an electronic device according to an embodiment of the disclosure. FIG. 30 may be described based on the embodiments of FIGS. 1, 2A to 2C, 3, 4A to 4F, and 5 to 29 and the embodiments described below.

Referring to FIG. 30, according to an embodiment, the electronic device 101 may identify a primary user, based on a face region, in image data acquired through the camera 220. For example, the electronic device 101 may identify face regions (e.g., 3010, 3020, and 3030) corresponding to multiple users in the image data. The electronic device 101 may identify locations and areas of the face regions. The electronic device 101 may configure the primary user, based on the locations and areas of the face regions. For example, the electronic device 101 may identify a face region (e.g., 3010) located in the middle of the image data and/or having the largest area, and configure a user corresponding to the identified face region (e.g., 3010) as the primary user. The above-described embodiments may be applied to the primary user.

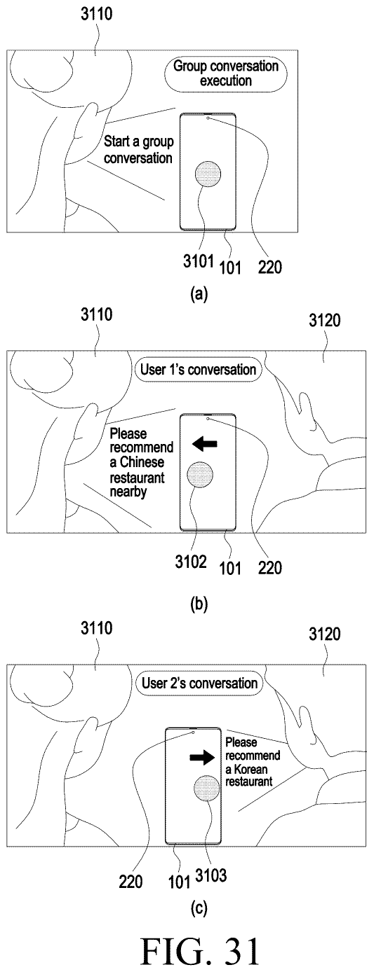

FIG. 31 is a diagram illustrating an operation of an electronic device according to an embodiment of the disclosure.

FIG. 31 may be described based on the embodiments of FIGS. 1, 2A to 2C, 3, 4A to 4F, and 5 to 30 and the embodiments described below.

According to an embodiment, the electronic device 101 may identify a direction in which an utterance of a user occurs, based on voice data. In FIG. 31, a first user 3110 may be located on the left side of the electronic device 101, and a second user 3120 may be located on the right side of the electronic device 101. The electronic device 101 may identify a first utterance of the first user 3110 and a second utterance of the second user 3120 in the voice data, and identify a direction of the first utterance and a direction of the second utterance. According to an embodiment, the electronic device 101 may change the display of a screen, based on a direction of an utterance. For example, in FIG. 31, the electronic device 101 may display an icon in the direction of the utterance. In case (a) of FIG. 31, the electronic device 101 may display a screen including an object 3101 indicating execution of a group mode, based on entry into the group mode. In case (b) of FIG. 31, the electronic device 101 may identify a first direction of the first utterance, based on identifying the first utterance of the first user 3110. The electronic device 101 may display an object 3102 in the first direction of the first utterance. In case (c) of FIG. 31, the electronic device 101 may identify a second direction of the second utterance, based on identifying the second utterance of the second user 3120. The electronic device 101 may display an object 3103 in the second direction of the second utterance.

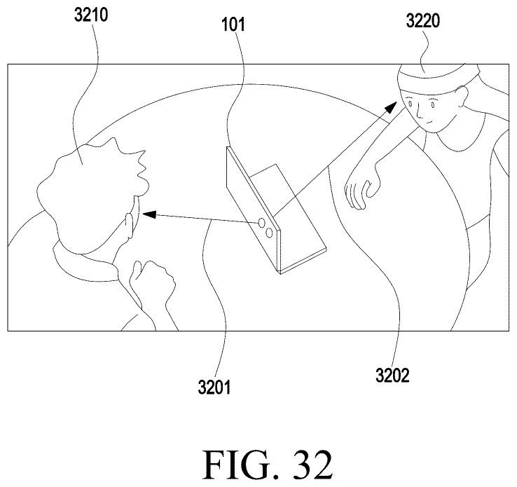

FIG. 32 is a diagram illustrating an operation of an electronic device according to an embodiment of the disclosure. FIG. 32 may be described based on the embodiments of FIGS. 1, 2A to 2C, 3, 4A to 4F, and 5 to 31 and the embodiments described below.

The electronic device 101 of FIG. 32 may be a foldable device. For example, the electronic device 101 may include a first camera 3201 facing a first direction and a second camera 3202 facing a second direction opposite to the first direction. According to an embodiment, in a group mode in which multiple users participate in a conversation, the electronic device 101 may use the first camera 3201 to identify a first gaze direction of a first user 3210, and may use the second camera 3202 to identify a second gaze direction of a second user 3220. According to an embodiment, the electronic device 101 may identify a first utterance of the first user 3210 in voice data. The electronic device 101 may select a response mode as an operation mode, based on the first gaze direction of the first user 3210 being a first direction toward the electronic device 101 (e.g., a screen of the display 250), while the first utterance of the first user 3210 is identified. For example, the electronic device 101 may select a listening mode as the operation mode, based on the first gaze direction of the first user 3210 not being the first direction toward the electronic device 101 (e.g., the screen of the display 250), while the first utterance of the first user 3210 is identified. For example, the electronic device 101 may ignore information on the second gaze direction of the second user 3220 while the first utterance of the first user 3210 is identified.

FIG. 33 is a diagram illustrating an operation of an electronic device according to an embodiment of the disclosure.

FIG. 33 may be described based on the embodiments of FIGS. 1, 2A to 2C, 3, 4A to 4F, and 5 to 32 and the embodiments described below.

In FIG. 33, according to an embodiment, the electronic device 101 may establish a communication connection with an external device (e.g., 3310, 3320, or 3330) (e.g., a wearable device) through the communication circuitry 260. For example, the external device (e.g., 3310, 3320, or 3330) may include a smart necklace 3310 in case (a) of FIG. 33, a smart watch 3320 in case (b) of FIG. 33, or a smart ring 3330 in case (c) of FIG. 33, and there is no limitation on the types of external devices (e.g., 3310, 3320, or 3330). The external device (e.g., 3310, 3320, or 3330) may measure a distance between the external device (e.g., 3310, 3320, or 3330) and a user, and transmit information on the measured distance to the electronic device 101. For example, the electronic device 101 may identify the distance between the external device (e.g., 3310, 3320, or 3330) and the user. According to an embodiment, the electronic device 101 may select a listening mode as an operation mode, based on the distance between the external device (e.g., 3310, 3320, or 3330) and the user being less than a reference distance. For example, the electronic device 101 may receive an additional voice input, instead of outputting a response associated with voice data received from the external device (e.g., 3310, 3320, or 3330), based on the distance between the external device (e.g., 3310, 3320, or 3330) and the user being less than the reference distance. According to an embodiment, the electronic device 101 may select the listening mode as the operation mode, based on a first distance between the electronic device 101 and the user being greater than or equal to the reference distance and a second distance between the external device (e.g., 3310, 3320, or 3330) and the user being less than the reference distance. For example, the electronic device 101 may receive the additional voice input, instead of outputting the response associated with the voice data received from the external device (e.g., 3310, 3320, or 3330), based on the first distance between the electronic device 101 and the user being greater than or equal to the reference distance and the second distance between the external device (e.g., 3310, 3320, or 3330) and the user being less than the reference distance. According to an embodiment, the electronic device 101 may select a response mode as the operation mode, based on a distance (e.g., the second distance) between the external device (e.g., 3310, 3320, or 3330) and the user being greater than or equal to the reference distance. For example, the electronic device 101 may output the response associated with the voice data received from the external device (e.g., 3310, 3320, or 3330), based on a distance (e.g., the second distance) between the external device (e.g., 3310, 3320, or 3330) and the user being greater than or equal to the reference distance. According to an embodiment, the electronic device 101 may select the response mode as the operation mode, based on the first distance between the electronic device 101 and the user being greater than or equal to the reference distance and the second distance between the external device (e.g., 3310, 3320, or 3330) and the user being greater than or equal to the reference distance. For example, the electronic device 101 may output the response associated with the voice data received from the external device (e.g., 3310, 3320, or 3330), based on the first distance between the electronic device 101 and the user being greater than or equal to the reference distance and the second distance between the external device (e.g., 3310, 3320, or 3330) and the user being greater than or equal to the reference distance.

In the above-described embodiments, a response has been described as being output as sound, but this is exemplary, and a response of the electronic device 101 may also be output in the form of text or an image through a screen of the display 250.

Those skilled in the art may understand that the embodiments described herein may be interchangeably applied within an applicable range. For example, those skilled in the art may understand that at least some operations of an embodiment described herein may be omitted in application, and at least some operations of embodiments may be interchangeably applied.

The technical tasks to be achieved in the disclosure may not be limited to the above-mentioned technical tasks, and other technical tasks not mentioned may be clearly understood by those skilled in the art to which the disclosure belongs.

The disclosure is not limited to the foregoing description, and other modifications not mentioned will be apparent to those skilled in the art from the disclosure.

The effects obtainable from the disclosure are not limited to the above-mentioned effects, and other effects not mentioned may be clearly understood through the following description by those skilled in the art to which the disclosure belongs.

According to an embodiment, an electronic device 101 may include a housing 200 configured to form an outer surface of the electronic device 101, a display 250 disposed on a first surface of the housing 200, a camera 220 disposed in a direction in which the display 250 faces, a microphone 210, at least one processor 120 including processing circuitry, and memory 130 configured to store instructions. The instructions, when executed by the at least one processor 120 individually or collectively, may cause the electronic device 101 to operate in a conversation mode in which a voice agent executed by the electronic device 101 interacts with voice inputs received through the microphone 210. The instructions, when executed by the at least one processor 120 individually or collectively, may cause the electronic device 101 to, after receiving a first voice input, identify whether at least one condition for outputting a first response associated with the first voice input is satisfied. The instructions, when executed by the at least one processor 120 individually or collectively, may cause the electronic device 101 to, based on the at least one condition for outputting the first response being satisfied, output the first response associated with the first voice input. The instructions, when executed by the at least one processor 120 individually or collectively, may cause the electronic device 101 to, based on the at least one condition for outputting the first response not being satisfied, receive a second voice input subsequent to the first voice input, instead of outputting the first response. The at least one condition for outputting the first response may include an operation of identifying that a gaze of a user of the electronic device 101, obtained using the camera 220, moves toward a screen of the display 250.

According to an embodiment, the instructions, when executed by the at least one processor 120 individually or collectively, may cause the electronic device 101 to, based on a second condition being satisfied, receive the second voice input subsequent to the first voice input, instead of outputting the first response. The second condition may include an operation of identifying that the gaze of the user, obtained using the camera 220, moves to a location outside the screen of the display 250.

According to an embodiment, the instructions, when executed by the at least one processor 120 individually or collectively, may cause the electronic device 101 to, after receiving the second voice input without outputting the first response, identify whether at least one condition for outputting a second response associated with the first voice input and the second voice input is satisfied. The instructions, when executed by the at least one processor 120 individually or collectively, may cause the electronic device 101 to, based on the at least one condition for outputting the second response being satisfied, output the second response associated with the first voice input and the second voice input. The instructions, when executed by the at least one processor 120 individually or collectively, may cause the electronic device 101 to, based on the at least one condition for outputting the second response not being satisfied, receive a third voice input subsequent to the second voice input, instead of outputting the second response.

According to an embodiment, the instructions, when executed by the at least one processor 120 individually or collectively, may cause the electronic device 101 to, based on identifying that no subsequent voice input is received during a specified period from a time point when the first voice input is received, identify whether the at least one condition for outputting the first response is satisfied. The instructions, when executed by the at least one processor 120 individually or collectively, may cause the electronic device 101 to, based on the at least one condition for outputting the first response being satisfied, output the first response associated with the first voice input.

According to an embodiment, the instructions, when executed by the at least one processor 120 individually or collectively, may cause the electronic device 101 to, from before receiving the first voice input to after receiving the first voice input, identify a continuous gaze of the user toward the screen of the display 250. The instructions, when executed by the at least one processor 120 individually or collectively, may cause the electronic device 101 to, while identifying the continuous gaze of the user toward the screen of the display 250, based on identifying that no subsequent voice input is received during a specified period from a time point when the first voice input is received, output the first response associated with the first voice input.

According to an embodiment, the instructions, when executed by the at least one processor 120 individually or collectively, may cause the electronic device 101 to, based at least on the conversation mode being activated, activate the camera 220. The instructions, when executed by the at least one processor 120 individually or collectively, may cause the electronic device 101 to, based on the conversation mode being deactivated, deactivate the camera 220.

According to an embodiment, the at least one condition for outputting the first response may include an operation of identifying a name assigned to the voice agent in the first voice input.

According to an embodiment, the instructions, when executed by the at least one processor 120 individually or collectively, may cause the electronic device 101 to, in an image acquired using the camera 220, configure a point corresponding to an eye of the user as a tracking point. The instructions, when executed by the at least one processor 120 individually or collectively, may cause the electronic device 101 to identify the gaze of the user by tracking a position of the tracking point corresponding to the eye of the user. The instructions, when executed by the at least one processor 120 individually or collectively, may cause the electronic device 101 to, based on identifying another gaze of a person other than the user, ignore said another gaze.

According to an embodiment, the at least one condition for outputting the first response may include an operation of identifying a first distance between the electronic device 101 and the user being greater than or equal to a reference distance.

According to an embodiment, the electronic device 101 may include at least one sensor 231 configured to identify an orientation and/or a movement of the electronic device 101. The instructions, when executed by the at least one processor 120 individually or collectively, may cause the electronic device 101 to identify a positioning state of the electronic device 101 by using a sensing value of the at least one sensor 231. The positioning state may include a floor state in which a back surface of the electronic device 101 is placed substantially parallel to a floor surface, a standing state in which the back surface is placed at a predetermined angle with respect to the floor surface, and a handheld state in which the electronic device 101 is held by the user. The at least one condition for outputting the first response may include an operation of, in the floor state, identifying whether a first condition, regarding whether the first voice input includes switching information causing an operation mode of the conversation mode to be switched, is satisfied. The at least one condition for outputting the first response may include an operation of, in the standing state, identifying whether the first condition or a second condition regarding a gaze direction of the user is satisfied. The at least one condition for outputting the first response may include an operation of, in the handheld state, identifying whether the first condition, the second condition, or a third condition regarding a first distance between the electronic device 101 and the user is satisfied.

According to an embodiment, the instructions, when executed by the at least one processor 120 individually or collectively, may cause the electronic device 101 to, based on identifying the standing state or the handheld state, activate the camera 220 of the electronic device 101, and thus obtain image data necessary for determining the second condition. The instructions, when executed by the at least one processor 120 individually or collectively, may cause the electronic device 101 to, based on a transition to the floor state, a failure in tracking the gaze direction, or a termination of the conversation mode, deactivate the camera 220.

According to an embodiment, the instructions, when executed by the at least one processor 120 individually or collectively, may cause the electronic device 101 to, based on identifying the handheld state, perform an operation of measuring the first distance between the electronic device 101 and the user. The instructions, when executed by the at least one processor 120 individually or collectively, may cause the electronic device 101 to, based on a transition to the floor state or the standing state or a termination of the conversation mode, stop measuring the first distance.

According to an embodiment, the instructions, when executed by the at least one processor 120 individually or collectively, may cause the electronic device 101 to, based on identifying a second event causing entry into a group mode in which multiple users participate in a conversation, enter the group mode. The instructions, when executed by the at least one processor 120 individually or collectively, may cause the electronic device 101 to identify an input for names respectively corresponding to the multiple users, so as to assign the names corresponding to the multiple users in the group mode. The instructions, when executed by the at least one processor 120 individually or collectively, may cause the electronic device 101 to, in the group mode, based on identifying at least one of the names corresponding to the multiple users in the first voice input, receive the second voice input subsequent to the first voice input, instead of outputting the first response.

According to an embodiment, the instructions, when executed by the at least one processor 120 individually or collectively, may cause the electronic device 101 to identify a gesture of the user by using the camera 220. The instructions, when executed by the at least one processor 120 individually or collectively, may cause the electronic device 101 to, while the gaze toward the screen of the display 250 is not identified, based on the gesture being a first gesture, output the first response associated with the first voice input. The instructions, when executed by the at least one processor 120 individually or collectively, may cause the electronic device 101 to, while the gaze toward the screen of the display 250 is not identified, based on the gesture being a second gesture, receive the second voice input subsequent to the first voice input, instead of outputting the first response. The instructions, when executed by the at least one processor 120 individually or collectively, may cause the electronic device 101 to, while the gaze toward the screen of the display 250 is not identified, based on the gesture being a third gesture, terminate the conversation mode.

According to an embodiment, the electronic device 101 may include a foldable device. The instructions, when executed by the at least one processor 120 individually or collectively, may cause the electronic device 101 to, in a group mode in which multiple users participate in a conversation, identify a first gaze direction of a first user by using a first camera 3201 of the electronic device 101. The instructions, when executed by the at least one processor 120 individually or collectively, may cause the electronic device 101 to, in the group mode, identify a second gaze direction of a second user by using a second camera 3202 of the electronic device 101. The instructions, when executed by the at least one processor 120 individually or collectively, may cause the electronic device 101 to identify a first utterance of the first user in the voice inputs. The instructions, when executed by the at least one processor 120 individually or collectively, may cause the electronic device 101 to, while the first utterance is identified, based on the first gaze direction being directed toward the screen of the display 250, output a response associated with the first utterance. The instructions, when executed by the at least one processor 120 individually or collectively, may cause the electronic device 101 to, while the first utterance is identified, ignore information on the second gaze direction of the second user.

According to an embodiment, the instructions, when executed by the at least one processor 120 individually or collectively, may cause the electronic device 101 to establish a communication connection between the electronic device 101 and a wearable device through communication circuitry 260 of the electronic device 101. The instructions, when executed by the at least one processor 120 individually or collectively, may cause the electronic device 101 to acquire voice data for an utterance of the user from the wearable device. The instructions, when executed by the at least one processor 120 individually or collectively, may cause the electronic device 101 to identify a second distance between the wearable device and the user. The instructions, when executed by the at least one processor 120 individually or collectively, may cause the electronic device 101 to, based on the first distance being greater than or equal to the reference distance and the second distance being greater than or equal to the reference distance, output a response associated with the voice data received from the wearable device. The instructions, when executed by the at least one processor 120 individually or collectively, may cause the electronic device 101 to, based on the first distance being greater than or equal to the reference distance and the second distance being less than the reference distance, receive an additional voice input, instead of outputting the response associated with the voice data received from the wearable device.

According to an embodiment, the instructions, when executed by the at least one processor 120 individually or collectively, may cause the electronic device 101 to, in an image acquired using the camera 220 of the electronic device 101, configure a point corresponding to the mouth of the user as a tracking point. The instructions, when executed by the at least one processor 120 individually or collectively, may cause the electronic device 101 to identify a movement of the mouth of the user by tracking a position of the tracking point corresponding to the mouth of the user. The instructions, when executed by the at least one processor 120 individually or collectively, may cause the electronic device 101 to ignore voice inputs identified while the movement of the mouth of the user is not identified.

According to an embodiment, the instructions, when executed by the at least one processor 120 individually or collectively, may cause the electronic device 101 to control the display 250 of the electronic device 101 to display a button for obtaining an input. The at least one condition for outputting the first response may include an operation of identifying the input through the button.

According to an embodiment, an operation method of an electronic device 101 may include an operation of operating in a conversation mode in which a voice agent executed by the electronic device 101 interacts with voice inputs received through a microphone 210. The method may include an operation of, after receiving a first voice input, identifying whether at least one condition for outputting a first response associated with the first voice input is satisfied. The method may include an operation of, based on the at least one condition for outputting the first response being satisfied, outputting the first response associated with the first voice input. The method may include an operation of, based on the at least one condition for outputting the first response not being satisfied, receiving a second voice input subsequent to the first voice input, instead of outputting the first response. The at least one condition for outputting the first response may include an operation of identifying that a gaze of a user of the electronic device 101, obtained using a camera 220, moves toward a screen of a display 250.

According to an embodiment, the method may include an operation of, based on a second condition being satisfied, receiving the second voice input subsequent to the first voice input, instead of outputting the first response. The second condition may include an operation of identifying that the gaze of the user, obtained using the camera 220, moves to a location outside the screen of the display 250.

According to an embodiment, the method may include an operation of, after receiving the second voice input without outputting the first response, identifying whether at least one condition for outputting a second response associated with the first voice input and the second voice input is satisfied. The method may include an operation of, based on the at least one condition for outputting the second response being satisfied, outputting the second response associated with the first voice input and the second voice input. The method may include an operation of, based on the at least one condition for outputting the second response not being satisfied, receiving a third voice input subsequent to the second voice input, instead of outputting the second response.

According to an embodiment, the method may include an operation of, based on identifying that no subsequent voice input is received during a specified period from a time point when the first voice input is received, identifying whether the at least one condition for outputting the first response is satisfied. The method may include an operation of, based on the at least one condition for outputting the first response being satisfied, outputting the first response associated with the first voice input.

According to an embodiment, the method may include an operation of, from before receiving the first voice input to after receiving the first voice input, identifying a continuous gaze of the user toward the screen of the display 250. The method may include an operation of, while identifying the continuous gaze of the user toward the screen of the display 250, based on identifying that no subsequent voice input is received during a specified period from a time point when the first voice input is received, outputting the first response associated with the first voice input.

According to an embodiment, the method may include an operation of, based at least on the conversation mode being activated, activating the camera 220. The method may include an operation of, based on the conversation mode being deactivated, deactivating the camera 220.

According to an embodiment, in the method, the at least one condition for outputting the first response may include an operation of identifying a name assigned to the voice agent in the first voice input.

According to an embodiment, the method may include an operation of, in an image acquired using the camera 220, configuring a point corresponding to an eye of the user as a tracking point. The method may include an operation of identifying the gaze of the user by tracking a position of the tracking point corresponding to the eye of the user. The method may include an operation of, based on identifying another gaze of a person other than the user, ignoring said another gaze.

According to an embodiment, in the method, the at least one condition for outputting the first response may include an operation of identifying a first distance between the electronic device 101 and the user being greater than or equal to a reference distance.

According to an embodiment, the method may include an operation of identifying a positioning state of the electronic device 101 by using a sensing value of at least one sensor 231 configured to identify an orientation and/or a movement of the electronic device 101. The positioning state may include a floor state in which a back surface of the electronic device 101 is placed substantially parallel to a floor surface, a standing state in which the back surface is placed at a predetermined angle with respect to the floor surface, and a handheld state in which the electronic device 101 is held by the user. The at least one condition for outputting the first response may include an operation of, in the floor state, identifying whether a first condition, regarding whether the first voice input includes switching information causing an operation mode of the conversation mode to be switched, is satisfied. The at least one condition for outputting the first response may include an operation of, in the standing state, identifying whether the first condition or a second condition regarding a gaze direction of the user is satisfied. The at least one condition for outputting the first response may include an operation of, in the handheld state, identifying whether the first condition, the second condition, or a third condition regarding a first distance between the electronic device 101 and the user is satisfied.

According to an embodiment, the method may include an operation of, based on identifying the standing state or the handheld state, activating the camera 220 of the electronic device 101, and thus obtaining image data necessary for determining the second condition. The method may include an operation of, based on a transition to the floor state, a failure in tracking the gaze direction, or a termination of the conversation mode, deactivating the camera 220.

According to an embodiment, the method may include an operation of, based on identifying the handheld state, performing measuring the first distance between the electronic device 101 and the user. The method may include an operation of, based on a transition to the floor state or the standing state or a termination of the conversation mode, stopping measuring the first distance.

According to an embodiment, the method may include an operation of, based on identifying a second event causing entry into a group mode in which multiple users participate in a conversation, entering the group mode. The method may include an operation of identifying an input for names respectively corresponding to the multiple users, so as to assign the names corresponding to the multiple users in the group mode. The method may include an operation of, in the group mode, based on identifying at least one of the names corresponding to the multiple users in the first voice input, receiving the second voice input subsequent to the first voice input, instead of outputting the first response.

According to an embodiment, the method may include an operation of identifying a gesture of the user by using the camera 220. The method may include an operation of, while the gaze toward the screen of the display 250 is not identified, based on the gesture being a first gesture, outputting the first response associated with the first voice input. The method may include an operation of, while the gaze toward the screen of the display 250 is not identified, based on the gesture being a second gesture, receiving the second voice input subsequent to the first voice input, instead of outputting the first response. The method may include an operation of, while the gaze toward the screen of the display 250 is not identified, based on the gesture being a third gesture, terminating the conversation mode.

According to an embodiment, in the method, the electronic device 101 may include a foldable device. The method may include an operation of, in a group mode in which multiple users participate in a conversation, identifying a first gaze direction of a first user by using a first camera 3201 of the electronic device 101. The method may include an operation of, in the group mode, identifying a second gaze direction of a second user by using a second camera 3202 of the electronic device 101. The method may include an operation of identifying a first utterance of the first user in the voice inputs. The method may include an operation of, while the first utterance is identified, based on the first gaze direction being directed toward the screen of the display 250, outputting a response associated with the first utterance. The method may include an operation of, while the first utterance is identified, ignoring information on the second gaze direction of the second user.

According to an embodiment, the method may include an operation of establishing a communication connection between the electronic device 101 and a wearable device through communication circuitry 260 of the electronic device 101. The method may include an operation of acquiring voice data for an utterance of the user from the wearable device. The method may include an operation of identifying a second distance between the wearable device and the user. The method may include an operation of, based on the first distance being greater than or equal to the reference distance and the second distance being greater than or equal to the reference distance, outputting a response associated with the voice data received from the wearable device. The method may include an operation of, based on the first distance being greater than or equal to the reference distance and the second distance being less than the reference distance, receiving an additional voice input, instead of outputting the response associated with the voice data received from the wearable device.

According to an embodiment, the method may include an operation of, in an image acquired using the camera 220 of the electronic device 101, configuring a point corresponding to the mouth of the user as a tracking point. The method may include an operation of identifying a movement of the mouth of the user by tracking a position of the tracking point corresponding to the mouth of the user. The method may include an operation of ignoring voice inputs identified while the movement of the mouth of the user is not identified.

According to an embodiment, the method may include an operation of controlling the display 250 of the electronic device 101 to display a button for obtaining an input. The at least one condition for outputting the first response may include an operation of identifying the input through the button.

According to an embodiment, in a non-transitory computer-readable recording medium storing instructions, the instructions, when executed by at least one processor of an electronic device 101 individually or collectively, may cause the electronic device 101 to perform at least one operation. The at least one operation may include an operation of operating in a conversation mode in which a voice agent executed by the electronic device 101 interacts with voice inputs received through a microphone 210. The at least one operation may include an operation of, after receiving a first voice input, identifying whether at least one condition for outputting a first response associated with the first voice input is satisfied. The at least one operation may include an operation of, based on the at least one condition for outputting the first response being satisfied, outputting the first response associated with the first voice input. The at least one operation may include an operation of, based on the at least one condition for outputting the first response not being satisfied, receiving a second voice input subsequent to the first voice input, instead of outputting the first response. The at least one condition for outputting the first response may include an operation of identifying that a gaze of a user of the electronic device 101, obtained using a camera 220, moves toward a screen of a display 250.

According to an embodiment, in the recording medium, the at least one operation may include an operation of, based on a second condition being satisfied, receiving the second voice input subsequent to the first voice input, instead of outputting the first response. The second condition may include an operation of identifying that the gaze of the user, obtained using the camera 220, moves to a location outside the screen of the display 250.

According to an embodiment, in the recording medium, the at least one operation may include an operation of, after receiving the second voice input without outputting the first response, identifying whether at least one condition for outputting a second response associated with the first voice input and the second voice input is satisfied. The at least one operation may include an operation of, based on the at least one condition for outputting the second response being satisfied, outputting the second response associated with the first voice input and the second voice input. The at least one operation may include an operation of, based on the at least one condition for outputting the second response not being satisfied, receiving a third voice input subsequent to the second voice input, instead of outputting the second response.

According to an embodiment, in the recording medium, the at least one operation may include an operation of, based on identifying that no subsequent voice input is received during a specified period from a time point when the first voice input is received, identifying whether the at least one condition for outputting the first response is satisfied. The at least one operation may include an operation of, based on the at least one condition for outputting the first response being satisfied, outputting the first response associated with the first voice input.

According to an embodiment, in the recording medium, the at least one operation may include an operation of, from before receiving the first voice input to after receiving the first voice input, identifying a continuous gaze of the user toward the screen of the display 250. The at least one operation may include an operation of, while identifying the continuous gaze of the user toward the screen of the display 250, based on identifying that no subsequent voice input is received during a specified period from a time point when the first voice input is received, outputting the first response associated with the first voice input.

According to an embodiment, in the recording medium, the at least one operation may include an operation of, based at least on the conversation mode being activated, activating the camera 220. The at least one operation may include an operation of, based on the conversation mode being deactivated, deactivating the camera 220.

According to an embodiment, in the recording medium, the at least one condition for outputting the first response may include an operation of identifying a name assigned to the voice agent in the first voice input.

According to an embodiment, in the recording medium, the at least one operation may include an operation of, in an image acquired using the camera 220, configuring a point corresponding to an eye of the user as a tracking point. The at least one operation may include an operation of identifying the gaze of the user by tracking a position of the tracking point corresponding to the eye of the user. The at least one operation may include an operation of, based on identifying another gaze of a person other than the user, ignoring said another gaze.

According to an embodiment, in the recording medium, the at least one condition for outputting the first response may include an operation of identifying a first distance between the electronic device 101 and the user being greater than or equal to a reference distance.

According to an embodiment, in the recording medium, the at least one operation may include an operation of identifying a positioning state of the electronic device 101 by using a sensing value of at least one sensor 231 configured to identify an orientation and/or a movement of the electronic device 101. The positioning state may include a floor state in which a back surface of the electronic device 101 is placed substantially parallel to a floor surface, a standing state in which the back surface is placed at a predetermined angle with respect to the floor surface, and a handheld state in which the electronic device 101 is held by the user. The at least one condition for outputting the first response may include an operation of, in the floor state, identifying whether a first condition, regarding whether the first voice input includes switching information causing an operation mode of the conversation mode to be switched, is satisfied. The at least one condition for outputting the first response may include an operation of, in the standing state, identifying whether the first condition or a second condition regarding a gaze direction of the user is satisfied. The at least one condition for outputting the first response may include an operation of, in the handheld state, identifying whether the first condition, the second condition, or a third condition regarding a first distance between the electronic device 101 and the user is satisfied.

According to an embodiment, in the recording medium, the at least one operation may include an operation of, based on identifying the standing state or the handheld state, activating the camera 220 of the electronic device 101, and thus obtaining image data necessary for determining the second condition. The at least one operation may include an operation of, based on a transition to the floor state, a failure in tracking the gaze direction, or a termination of the conversation mode, deactivating the camera 220.

According to an embodiment, in the recording medium, the at least one operation may include an operation of, based on identifying the handheld state, performing measuring the first distance between the electronic device 101 and the user. The at least one operation may include an operation of, based on a transition to the floor state or the standing state or a termination of the conversation mode, stopping measuring the first distance.

According to an embodiment, in the recording medium, the at least one operation may include an operation of, based on identifying a second event causing entry into a group mode in which multiple users participate in a conversation, entering the group mode. The at least one operation may include an operation of identifying an input for names respectively corresponding to the multiple users, so as to assign the names corresponding to the multiple users in the group mode. The at least one operation may include an operation of, in the group mode, based on identifying at least one of the names corresponding to the multiple users in the first voice input, receiving the second voice input subsequent to the first voice input, instead of outputting the first response.

According to an embodiment, in the recording medium, the at least one operation may include an operation of identifying a gesture of the user by using the camera 220. The at least one operation may include an operation of, while the gaze toward the screen of the display 250 is not identified, based on the gesture being a first gesture, outputting the first response associated with the first voice input. The at least one operation may include an operation of, while the gaze toward the screen of the display 250 is not identified, based on the gesture being a second gesture, receiving the second voice input subsequent to the first voice input, instead of outputting the first response. The at least one operation may include an operation of, while the gaze toward the screen of the display 250 is not identified, based on the gesture being a third gesture, terminating the conversation mode.

According to an embodiment, in the recording medium, the electronic device 101 may include a foldable device. The at least one operation may include an operation of, in a group mode in which multiple users participate in a conversation, identifying a first gaze direction of a first user by using a first camera 3201 of the electronic device 101. The at least one operation may include an operation of, in the group mode, identifying a second gaze direction of a second user by using a second camera 3202 of the electronic device 101. The at least one operation may include an operation of identifying a first utterance of the first user in the voice inputs. The at least one operation may include an operation of, while the first utterance is identified, based on the first gaze direction being directed toward the screen of the display 250, outputting a response associated with the first utterance. The at least one operation may include an operation of, while the first utterance is identified, ignoring information on the second gaze direction of the second user.

According to an embodiment, in the recording medium, the at least one operation may include an operation of establishing a communication connection between the electronic device 101 and a wearable device through communication circuitry 260 of the electronic device 101. The at least one operation may include an operation of acquiring voice data for an utterance of the user from the wearable device. The at least one operation may include an operation of identifying a second distance between the wearable device and the user. The at least one operation may include an operation of, based on the first distance being greater than or equal to the reference distance and the second distance being greater than or equal to the reference distance, outputting a response associated with the voice data received from the wearable device. The at least one operation may include an operation of, based on the first distance being greater than or equal to the reference distance and the second distance being less than the reference distance, receiving an additional voice input, instead of outputting the response associated with the voice data received from the wearable device.

According to an embodiment, in the recording medium, the at least one operation may include an operation of, in an image acquired using the camera 220 of the electronic device 101, configuring a point corresponding to the mouth of the user as a tracking point. The at least one operation may include an operation of identifying a movement of the mouth of the user by tracking a position of the tracking point corresponding to the mouth of the user. The at least one operation may include an operation of ignoring voice inputs identified while the movement of the mouth of the user is not identified.

According to an embodiment, in the recording medium, the at least one operation may include an operation of controlling the display 250 of the electronic device 101 to display a button for obtaining an input. The at least one condition for outputting the first response may include an operation of identifying the input through the button. According to an embodiment, the electronic device 101 may include the microphone 210 configured to acquire voice data, at least one processor 120 including processing circuitry, and memory 130 storing instructions. The instructions, when executed by the at least one processor 120 individually or collectively, may cause the electronic device 101 to, based on identifying a first event causing entry into a conversation mode with an artificial intelligence model (e.g., a voice agent), enter the conversation mode. The instructions, when executed by the at least one processor 120 individually or collectively, may cause the electronic device 101 to, based on a condition for determining an operation mode of the conversation mode, determine the operation mode among a listening mode or a response mode. The instructions, when executed by the at least one processor 120 individually or collectively, may cause the electronic device 101 to, based on determining the listening mode or the response mode as the operation mode, perform an operation of the listening mode or an operation of the response mode. The operation of the listening mode may include an operation of acquiring the voice data. The operation of the response mode may include the operation of acquiring the voice data, an operation of identifying response information generated based on the voice data accumulated during the conversation mode, and an operation of outputting a response based on the response information.

According to an embodiment, the instructions, when executed by the at least one processor 120 individually or collectively, may cause the electronic device 101 to identify whether the voice data includes switching information causing the operation mode of the conversation mode to be switched. The instructions, when executed by the at least one processor 120 individually or collectively, may cause the electronic device 101 to, based on identifying a name assigned to the artificial intelligence model (e.g., the voice agent) in the voice data, select the response mode as the operation mode. The instructions, when executed by the at least one processor 120 individually or collectively, may cause the electronic device 101 to, based on identifying a name assigned to the user in the voice data, select the listening mode as the operation mode.

According to an embodiment, the instructions, when executed by the at least one processor 120 individually or collectively, may cause the electronic device 101 to identify a gaze direction of the user by using the camera 220 of the electronic device 101. The instructions, when executed by the at least one processor 120 individually or collectively, may cause the electronic device 101 to, based on identifying a gaze of the user in a first direction toward the electronic device 101 (e.g., a screen of the display 250), select the response mode as the operation mode. The instructions, when executed by the at least one processor 120 individually or collectively, may cause the electronic device 101 to, based on a failure to identify the gaze in the first direction, select the listening mode as the operation mode.

According to an embodiment, the instructions, when executed by the at least one processor 120 individually or collectively, may cause the electronic device 101 to, in an image acquired using the camera 220, configure a point corresponding to an eye of the user as a tracking point. The instructions, when executed by the at least one processor 120 individually or collectively, may cause the electronic device 101 to identify the gaze of the user by tracking a position of the tracking point corresponding to the eye of the user. The instructions, when executed by the at least one processor 120 individually or collectively, may cause the electronic device 101 to, based on identifying another gaze of a person other than the user, ignore said another gaze.

According to an embodiment, the instructions, when executed by the at least one processor 120 individually or collectively, may cause the electronic device 101 to identify a first distance between the electronic device 101 and the user. The instructions, when executed by the at least one processor 120 individually or collectively, may cause the electronic device 101 to, based on the first distance being less than a reference distance, select the listening mode as the operation mode. The instructions, when executed by the at least one processor 120 individually or collectively, may cause the electronic device 101 to, based on the first distance being greater than or equal to the reference distance, select the response mode as the operation mode.

According to an embodiment, the electronic device 101 may include at least one sensor 231 configured to identify an orientation and/or a movement of the electronic device 101. The instructions, when executed by the at least one processor 120 individually or collectively, may cause the electronic device 101 to identify a positioning state of the electronic device 101 by using a sensing value of the at least one sensor 231. The positioning state may include a floor state in which a back surface of the electronic device 101 is placed substantially parallel to a floor surface. The positioning state may include a standing state in which the back surface is placed at a predetermined angle with the floor surface. The positioning state may include a handheld state in which the electronic device 101 is held by the user. The instructions, when executed by the at least one processor 120 individually or collectively, may cause the electronic device 101 to, in the floor state, based on a first condition regarding whether the voice data includes switching information causing the operation mode of the conversation mode to be switched, determine the listening mode or the response mode as the operation mode. The instructions, when executed by the at least one processor 120 individually or collectively, may cause the electronic device 101 to, in the standing state, based on the first condition and a second condition regarding a gaze direction of the user, determine the listening mode or the response mode as the operation mode. The instructions, when executed by the at least one processor 120 individually or collectively, may cause the electronic device 101 to, in the handheld state, based on the first condition, the second condition, and a third condition regarding a first distance between the electronic device 101 and the user, determine the listening mode or the response mode as the operation mode.

According to an embodiment, the instructions, when executed by the at least one processor 120 individually or collectively, may cause the electronic device 101 to, based on identifying the standing state or the handheld state, activate the camera 220 of the electronic device 101, and thus obtain image data necessary for determining the second condition. The instructions, when executed by the at least one processor 120 individually or collectively, may cause the electronic device 101 to, based on a transition to the floor state, a failure in tracking the gaze direction, or a termination of the conversation mode, deactivate the camera 220.

According to an embodiment, the instructions, when executed by the at least one processor 120 individually or collectively, may cause the electronic device 101 to, based on identifying the handheld state, perform an operation of measuring the first distance between the electronic device 101 and the user. The instructions, when executed by the at least one processor 120 individually or collectively, may cause the electronic device 101 to, based on a transition to the floor state or the standing state or a termination of the conversation mode, stop measuring the first distance.

According to an embodiment, the instructions, when executed by the at least one processor 120 individually or collectively, may cause the electronic device 101 to, based on identifying a second event causing entry into a group mode in which multiple users participate in a conversation, enter the group mode. The instructions, when executed by the at least one processor 120 individually or collectively, may cause the electronic device 101 to identify an input for names respectively corresponding to the multiple users, so as to assign the names corresponding to the multiple users in the group mode. The instructions, when executed by the at least one processor 120 individually or collectively, may cause the electronic device 101 to, in the group mode, based on identifying the name assigned to the artificial intelligence model (e.g., the voice agent) in the voice data, select the response mode as the operation mode. The instructions, when executed by the at least one processor 120 individually or collectively, may cause the electronic device 101 to, in the group mode, based on identifying at least one of the names corresponding to the multiple users in the voice data, select the listening mode as the operation mode.

According to an embodiment, the instructions, when executed by the at least one processor 120 individually or collectively, may cause the electronic device 101 to identify a gesture of the user by using the camera 220. The instructions, when executed by the at least one processor 120 individually or collectively, may cause the electronic device 101 to, while the gaze in the first direction toward the electronic device 101 (e.g., the screen of the display 250) is not identified, based on the gesture being a first gesture, select the response mode as the operation mode. The instructions, when executed by the at least one processor 120 individually or collectively, may cause the electronic device 101 to, while the gaze in the first direction toward the electronic device 101 (e.g., the screen of the display 250) is not identified, based on the gesture being a second gesture, select the listening mode as the operation mode. The instructions, when executed by the at least one processor 120 individually or collectively, may cause the electronic device 101 to, while the gaze in the first direction toward the electronic device 101 (e.g., the screen of the display 250) is not identified, based on the gesture being a third gesture, terminate the conversation mode.

According to an embodiment, the electronic device 101 may include a foldable device. The instructions, when executed by the at least one processor 120 individually or collectively, may cause the electronic device 101 to, in a group mode in which multiple users participate in a conversation, identify a first gaze direction of a first user by using a first camera 3201 of the electronic device 101. The instructions, when executed by the at least one processor 120 individually or collectively, may cause the electronic device 101 to, in the group mode, identify a second gaze direction of a second user by using a second camera 3202 of the electronic device 101. The instructions, when executed by the at least one processor 120 individually or collectively, may cause the electronic device 101 to identify a first utterance of the first user in the voice data. The instructions, when executed by the at least one processor 120 individually or collectively, may cause the electronic device 101 to, while the first utterance is identified, based on the first gaze direction being the first direction toward the electronic device 101 (e.g., the screen of the display 250), select the response mode as the operation mode. The instructions, when executed by the at least one processor 120 individually or collectively, may cause the electronic device 101 to, while the first utterance is identified, based on the first gaze direction not being the first direction, select the listening mode as the operation mode. The instructions, when executed by the at least one processor 120 individually or collectively, may cause the electronic device 101 to, while the first utterance is identified, ignore information on the second gaze direction of the second user.

According to an embodiment, the instructions, when executed by the at least one processor 120 individually or collectively, may cause the electronic device 101 to establish a communication connection between the electronic device 101 and a wearable device through communication circuitry 260 of the electronic device 101. The instructions, when executed by the at least one processor 120 individually or collectively, may cause the electronic device 101 to acquire voice data for an utterance of the user from the wearable device. The instructions, when executed by the at least one processor 120 individually or collectively, may cause the electronic device 101 to identify a second distance between the wearable device and the user. The instructions, when executed by the at least one processor 120 individually or collectively, may cause the electronic device 101 to, based on the first distance being greater than or equal to the reference distance and the second distance being less than the reference distance, select the listening mode as the operation mode. The instructions, when executed by the at least one processor 120 individually or collectively, may cause the electronic device 101 to, based on the first distance being greater than or equal to the reference distance and the second distance being less than the reference distance, select the response mode as the operation mode.

According to an embodiment, the instructions, when executed by the at least one processor 120 individually or collectively, may cause the electronic device 101 to, based on identifying, in the voice data, a filler voice which causes the listening mode, select the listening mode as the operation mode.

According to an embodiment, the instructions, when executed by the at least one processor 120 individually or collectively, may cause the electronic device 101 to, in an image acquired using the camera 220 of the electronic device 101, configure a point corresponding to the mouth of the user as a tracking point. The instructions, when executed by the at least one processor 120 individually or collectively, may cause the electronic device 101 to identify a movement of the mouth of the user by tracking a position of the tracking point corresponding to the mouth of the user. The instructions, when executed by the at least one processor 120 individually or collectively, may cause the electronic device 101 to ignore voice data identified while the movement of the mouth of the user is not identified.

According to an embodiment, the instructions, when executed by the at least one processor 120 individually or collectively, may cause the electronic device 101 to control the display 250 of the electronic device 101 to display a button for obtaining an input. The instructions, when executed by the at least one processor 120 individually or collectively, may cause the electronic device 101 to, based on identifying the input through the button, select the response mode as the operation mode. The instructions, when executed by the at least one processor 120 individually or collectively, may cause the electronic device 101 to, based on the input through the button not being identified, select the operation mode, based on another condition.

According to an embodiment, the instructions, when executed by the at least one processor 120 individually or collectively, may cause the electronic device 101 to, in the image acquired using the camera 220, identify biometric information on a face of the user. The instructions, when executed by the at least one processor 120 individually or collectively, may cause the electronic device 101 to identify a security level corresponding to the user by identifying a security level matching the biometric information in matching information stored in the memory 130. The instructions, when executed by the at least one processor 120 individually or collectively, may cause the electronic device 101 to, based on identifying the gaze in the first direction toward the electronic device 101 (e.g., the screen of the display 250), select the response mode as the operation mode. The instructions, when executed by the at least one processor 120 individually or collectively, may cause the electronic device 101 to, in the response mode, generate the response information at a level corresponding to the security level of the user. The instructions, when executed by the at least one processor 120 individually or collectively, may cause the electronic device 101 to, based on the response information, output the response.

According to an embodiment, an operation method of an electronic device 101 may include an operation of, based on identifying a first event causing entry into a conversation mode with an artificial intelligence model (e.g., a voice agent), entering the conversation mode. The method may include an operation of, based on a condition for determining an operation mode of the conversation mode, determining the operation mode among a listening mode or a response mode. The method may include an operation of, based on determining the listening mode or the response mode as the operation mode, performing an operation of the listening mode or an operation of the response mode. The operation of the listening mode may include an operation of acquiring voice data. The operation of the response mode may include the operation of acquiring the voice data, an operation of identifying response information generated based on the voice data accumulated during the conversation mode, and an operation of outputting a response based on the response information.

According to an embodiment, the method may include an operation of identifying whether the voice data includes switching information causing the operation mode of the conversation mode to be switched. The method may include an operation of, based on identifying a name assigned to the artificial intelligence model (e.g., the voice agent) in the voice data, selecting the response mode as the operation mode. The method may include an operation of, based on identifying a name assigned to a user in the voice data, selecting the listening mode as the operation mode.

According to an embodiment, the method may include an operation of identifying a gaze direction of the user by using a camera 220 of the electronic device 101. The method may include an operation of, based on identifying a gaze of the user in a first direction toward the electronic device 101 (e.g., a screen of the display 250), selecting the response mode as the operation mode. The method may include an operation of, based on a failure to identify the gaze in the first direction, selecting the listening mode as the operation mode.

According to an embodiment, the method may include an operation of, in an image acquired using the camera 220, configuring a point corresponding to an eye of the user as a tracking point. The method may include an operation of identifying the gaze of the user by tracking a position of the tracking point corresponding to the eye of the user. The method may include an operation of, based on identifying another gaze of a person other than the user, ignoring said another gaze.

According to an embodiment, the method may include an operation of identifying a first distance between the electronic device 101 and the user. The method may include an operation of, based on the first distance being less than a reference distance, selecting the listening mode as the operation mode. The method may include an operation of, based on the first distance being greater than or equal to the reference distance, selecting the response mode as the operation mode.

According to an embodiment, in the method, the electronic device 101 may include at least one sensor 231 configured to identify an orientation and/or a movement of the electronic device 101. The method may include an operation of identifying a positioning state of the electronic device 101 by using a sensing value of the at least one sensor 231. The positioning state may include a floor state in which a back surface of the electronic device 101 is placed substantially parallel to a floor surface. The positioning state may include a standing state in which the back surface is placed at a predetermined angle with the floor surface. The positioning state may include a handheld state in which the electronic device 101 is held by the user. The method may include an operation of, in the floor state, based on a first condition regarding whether the voice data includes switching information causing the operation mode of the conversation mode to be switched, determining the listening mode or the response mode as the operation mode. The method may include an operation of, in the standing state, based on the first condition and a second condition regarding a gaze direction of the user, determining the listening mode or the response mode as the operation mode. The method may include an operation of, in the handheld state, based on the first condition, the second condition, and a third condition regarding a first distance between the electronic device 101 and the user, determining the listening mode or the response mode as the operation mode.

According to an embodiment, the method may include an operation of, based on identifying the standing state or the handheld state, activating the camera 220 of the electronic device 101, and thus obtaining image data necessary for determining the second condition. The method may include an operation of, based on a transition to the floor state, a failure in tracking the gaze direction, or a termination of the conversation mode, deactivating the camera 220.

According to an embodiment, the method may include an operation of, based on identifying the handheld state, performing measuring the first distance between the electronic device 101 and the user. The method may include an operation of, based on a transition to the floor state or the standing state or a termination of the conversation mode, stopping measuring the first distance.

According to an embodiment, the method may include an operation of, based on identifying a second event causing entry into a group mode in which multiple users participate in a conversation, entering the group mode. The method may include an operation of identifying an input for names respectively corresponding to the multiple users, so as to assign the names corresponding to the multiple users in the group mode. The method may include an operation of, in the group mode, based on identifying the name assigned to the artificial intelligence model (e.g., the voice agent) in the voice data, selecting the response mode as the operation mode. The method may include an operation of, in the group mode, based on identifying at least one of the names corresponding to the multiple users in the voice data, selecting the listening mode as the operation mode.

According to an embodiment, the method may include an operation of identifying a gesture of the user by using the camera 220. The method may include an operation of, while the gaze in the first direction toward the electronic device 101 (e.g., the screen of the display 250) is not identified, based on the gesture being a first gesture, selecting the response mode as the operation mode. The method may include an operation of, while the gaze in the first direction toward the electronic device 101 (e.g., the screen of the display 250) is not identified, based on the gesture being a second gesture, selecting the listening mode as the operation mode. The method may include an operation of, while the gaze in the first direction toward the electronic device 101 (e.g., the screen of the display 250) is not identified, based on the gesture being a third gesture, terminating the conversation mode.

According to an embodiment, the electronic device 101 may include a foldable device. The method may include an operation of, in a group mode in which multiple users participate in a conversation, identifying a first gaze direction of a first user by using a first camera 3201 of the electronic device 101. The method may include an operation of, in the group mode, identifying a second gaze direction of a second user by using a second camera 3202 of the electronic device 101. The method may include an operation of identifying a first utterance of the first user in the voice data. The method may include an operation of, while the first utterance is identified, based on the first gaze direction being the first direction toward the electronic device 101 (e.g., the screen of the display 250), selecting the response mode as the operation mode. The method may include an operation of, while the first utterance is identified, based on the first gaze direction not being the first direction, selecting the listening mode as the operation mode. The method may include an operation of, while the first utterance is identified, ignoring information on the second gaze direction of the second user.

According to an embodiment, the method may include an operation of establishing a communication connection between the electronic device 101 and a wearable device through communication circuitry 260 of the electronic device 101. The method may include an operation of acquiring voice data for an utterance of the user from the wearable device. The method may include an operation of identifying a second distance between the wearable device and the user. The method may include an operation of, based on the first distance being greater than or equal to the reference distance and the second distance being less than the reference distance, selecting the listening mode as the operation mode. The method may include an operation of, based on the first distance being greater than or equal to the reference distance and the second distance being greater than or equal to the reference distance, selecting the response mode as the operation mode.

According to an embodiment, the method may include an operation of, based on identifying, in the voice data, a filler voice which causes the listening mode, selecting the listening mode as the operation mode.

According to an embodiment, the method may include an operation of, in an image acquired using the camera 220 of the electronic device 101, configuring a point corresponding to the mouth of the user as a tracking point. The method may include an operation of identifying a movement of the mouth of the user by tracking a position of the tracking point corresponding to the mouth of the user. The method may include an operation of ignoring voice data identified while the movement of the mouth of the user is not identified.

According to an embodiment, the method may include an operation of controlling a display 250 of the electronic device 101 to display a button for obtaining an input. The method may include an operation of, based on identifying the input through the button, selecting the response mode as the operation mode. The method may include an operation of, based on the input through the button not being identified, selecting the operation mode based on another condition.

According to an embodiment, the method may include an operation of, in an image acquired using the camera 220, identifying biometric information on a face of the user. The method may include an operation of identifying a security level corresponding to the user by identifying a security level matching the biometric information in matching information stored in the memory 130. The method may include an operation of, based on identifying the gaze in the first direction toward the electronic device 101 (e.g., the screen of the display 250), selecting the response mode as the operation mode. The method may include an operation of, in the response mode, generating the response information at a level corresponding to the security level of the user. The method may include an operation of outputting the response based on the response information.

According to an embodiment, in a non-transitory computer-readable recording medium storing instructions, the instructions, when executed by at least one processor of an electronic device 101 individually or collectively, may cause the electronic device 101 to perform at least one operation. The at least one operation may include an operation of, based on identifying a first event causing entry into a conversation mode with an artificial intelligence model (e.g., a voice agent), entering the conversation mode. The at least one operation may include an operation of, based on a condition for determining an operation mode of the conversation mode, determining the operation mode among a listening mode or a response mode. The at least one operation may include an operation of, based on determining the listening mode or the response mode as the operation mode, performing an operation of the listening mode or an operation of the response mode. The operation of the listening mode may include an operation of acquiring voice data. The operation of the response mode may include the operation of acquiring the voice data, an operation of identifying response information generated based on the voice data accumulated during the conversation mode, and an operation of outputting a response based on the response information.

According to an embodiment, in the recording medium, the at least one operation may include an operation of identifying whether the voice data includes switching information causing the operation mode of the conversation mode to be switched. The at least one operation may include an operation of, based on identifying a name assigned to the artificial intelligence model (e.g., the voice agent) in the voice data, selecting the response mode as the operation mode. The at least one operation may include an operation of, based on identifying a name assigned to a user in the voice data, selecting the listening mode as the operation mode.

According to an embodiment, in the recording medium, the at least one operation may include an operation of identifying a gaze direction of the user by using a camera 220 of the electronic device 101. The at least one operation may include an operation of, based on identifying a gaze of the user in a first direction toward the electronic device 101 (e.g., a screen of the display 250), selecting the response mode as the operation mode. The at least one operation may include an operation of, based on a failure to identify the gaze in the first direction, selecting the listening mode as the operation mode.

According to an embodiment, in the recording medium, the at least one operation may include an operation of, in an image acquired using the camera 220, configuring a point corresponding to an eye of the user as a tracking point. The at least one operation may include an operation of identifying the gaze of the user by tracking a position of the tracking point corresponding to the eye of the user. The at least one operation may include an operation of, based on identifying another gaze of a person other than the user, ignoring said another gaze.

According to an embodiment, in the recording medium, the at least one operation may include an operation of identifying a first distance between the electronic device 101 and the user. The at least one operation may include an operation of, based on the first distance being less than a reference distance, selecting the listening mode as the operation mode. The at least one operation may include an operation of, based on the first distance being greater than or equal to the reference distance, selecting the response mode as the operation mode.

According to an embodiment, in the recording medium, the electronic device 101 may include at least one sensor 231 configured to identify an orientation and/or a movement of the electronic device 101. The at least one operation may include an operation of identifying a positioning state of the electronic device 101 by using a sensing value of the at least one sensor 231. The positioning state may include a floor state in which a back surface of the electronic device 101 is placed substantially parallel to a floor surface. The positioning state may include a standing state in which the back surface is placed at a predetermined angle with the floor surface. The positioning state may include a handheld state in which the electronic device 101 is held by the user. The at least one operation may include an operation of, in the floor state, based on a first condition regarding whether the voice data includes switching information causing the operation mode of the conversation mode to be switched, determining the listening mode or the response mode as the operation mode. The at least one operation may include an operation of, in the standing state, based on the first condition and a second condition regarding a gaze direction of the user, determining the listening mode or the response mode as the operation mode. The at least one operation may include an operation of, in the handheld state, based on the first condition, the second condition, and a third condition regarding a first distance between the electronic device 101 and the user, determining the listening mode or the response mode as the operation mode.

According to an embodiment, in the recording medium, the at least one operation may include an operation of, based on identifying the standing state or the handheld state, activating the camera 220 of the electronic device 101, and thus obtaining image data necessary for determining the second condition. The at least one operation may include an operation of, based on a transition to the floor state, a failure in tracking the gaze direction, or a termination of the conversation mode, deactivating the camera 220.

According to an embodiment, in the recording medium, the at least one operation may include an operation of, based on identifying the handheld state, performing measuring the first distance between the electronic device 101 and the user. The at least one operation may include an operation of, based on a transition to the floor state or the standing state or a termination of the conversation mode, stopping measuring the first distance.

According to an embodiment, in the recording medium, the at least one operation may include an operation of, based on identifying a second event causing entry into a group mode in which multiple users participate in a conversation, entering the group mode. The at least one operation may include an operation of identifying an input for names respectively corresponding to the multiple users, so as to assign the names corresponding to the multiple users in the group mode. The at least one operation may include an operation of, in the group mode, based on identifying the name assigned to the artificial intelligence model (e.g., the voice agent) in the voice data, selecting the response mode as the operation mode. The at least one operation may include an operation of, in the group mode, based on identifying at least one of the names corresponding to the multiple users in the voice data, selecting the listening mode as the operation mode.

According to an embodiment, in the recording medium, the at least one operation may include an operation of identifying a gesture of the user by using the camera 220. The at least one operation may include an operation of, while the gaze in the first direction toward the electronic device 101 (e.g., the screen of the display 250) is not identified, based on the gesture being a first gesture, selecting the response mode as the operation mode. The at least one operation may include an operation of, while the gaze in the first direction toward the electronic device 101 (e.g., the screen of the display 250) is not identified, based on the gesture being a second gesture, selecting the listening mode as the operation mode. The at least one operation may include an operation of, while the gaze in the first direction toward the electronic device 101 (e.g., the screen of the display 250) is not identified, based on the gesture being a third gesture, terminating the conversation mode.

According to an embodiment, in the recording medium, the electronic device 101 may include a foldable device. The at least one operation may include an operation of, in a group mode in which multiple users participate in a conversation, identifying a first gaze direction of a first user by using a first camera 3201 of the electronic device 101. The at least one operation may include an operation of, in the group mode, identifying a second gaze direction of a second user by using a second camera 3202 of the electronic device 101. The at least one operation may include an operation of identifying a first utterance of the first user in the voice data. The at least one operation may include an operation of, while the first utterance is identified, based on the first gaze direction being the first direction toward the electronic device 101 (e.g., the screen of the display 250), selecting the response mode as the operation mode. The at least one operation may include an operation of, while the first utterance is identified, based on the first gaze direction not being the first direction, selecting the listening mode as the operation mode. The at least one operation may include an operation of, while the first utterance is identified, ignoring information on the second gaze direction of the second user.

According to an embodiment, in the recording medium, the at least one operation may include an operation of establishing a communication connection between the electronic device 101 and a wearable device through communication circuitry 260 of the electronic device 101. The at least one operation may include an operation of acquiring voice data for an utterance of the user from the wearable device. The at least one operation may include an operation of identifying a second distance between the wearable device and the user. The at least one operation may include an operation of, based on the first distance being greater than or equal to the reference distance and the second distance being less than the reference distance, selecting the listening mode as the operation mode. The at least one operation may include an operation of, based on the first distance being greater than or equal to the reference distance and the second distance being greater than or equal to the reference distance, selecting the response mode as the operation mode.

According to an embodiment, in the recording medium, the at least one operation may include an operation of, based on identifying, in the voice data, a filler voice which causes the listening mode, selecting the listening mode as the operation mode.

According to an embodiment, in the recording medium, the at least one operation may include an operation of, in an image acquired using the camera 220 of the electronic device 101, configuring a point corresponding to the mouth of the user as a tracking point. The at least one operation may include an operation of identifying a movement of the mouth of the user by tracking a position of the tracking point corresponding to the mouth of the user. The at least one operation may include an operation of ignoring voice data identified while the movement of the mouth of the user is not identified.

According to an embodiment, in the recording medium, the at least one operation may include an operation of controlling a display 250 of the electronic device 101 to display a button for obtaining an input. The at least one operation may include an operation of, based on identifying the input through the button, selecting the response mode as the operation mode. The at least one operation may include an operation of, based on the input through the button not being identified, selecting the operation mode based on another condition.

According to an embodiment, in the recording medium, the at least one operation may include an operation of, in an image acquired using the camera 220, identifying biometric information on a face of the user. The at least one operation may include an operation of identifying a security level corresponding to the user by identifying a security level matching the biometric information in matching information stored in the memory 130. The at least one operation may include an operation of, based on identifying the gaze in the first direction toward the electronic device 101 (e.g., the screen of the display 250), selecting the response mode as the operation mode. The at least one operation may include an operation of, in the response mode, generating the response information at a level corresponding to the security level of the user. The at least one operation may include an operation of outputting the response based on the response information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device). For example, a processor (e.g., the controller) of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing configured to form an outer surface of the electronic device;
a display disposed at a first side of the housing;
a camera disposed in a direction in which the display faces;
a microphone;
at least one processor including processing circuitry; and
memory, comprising one or more storage media, storing instructions,
wherein the instructions, when executed by the at least one processor individually or collectively, cause the electronic device to:
operate in a conversation mode in which a voice agent executed by the electronic device interacts with voice inputs received through the microphone,
after receiving a first voice input, identify whether at least one condition for outputting a first response associated with the first voice input is satisfied,
based on the at least one condition for outputting the first response being satisfied, output the first response associated with the first voice input, and
based on the at least one condition for outputting the first response being unsatisfied, receive a second voice input subsequent to the first voice input, rather than outputting the first response, and
wherein the at least one condition for outputting the first response includes identifying that a gaze of a user, obtained using the camera, moves toward a screen of the display.

2. The electronic device of claim 1,
wherein the instructions, when executed by the at least one processor individually or collectively, further cause the electronic device to:
based on a second condition being satisfied, receive a second voice input subsequent to the first voice input, rather than outputting the first response, and
wherein the second condition includes identifying that the gaze of the user, obtained using the camera, moves out of the screen of the display.

3. The electronic device of claim 1, wherein the instructions, when executed by the at least one processor individually or collectively, further cause the electronic device to:
after receiving the second voice input without outputting the first response, identify whether at least one condition for outputting a second response associated with the first voice input and the second voice input is satisfied,
based on the at least one condition for outputting the second response being satisfied, output the second response associated with the first voice input and the second voice input, and
based on the at least one condition for outputting the second response being unsatisfied, receive a third voice input subsequent to the second voice input, rather than outputting the second response.

4. The electronic device of claim 1, wherein the instructions, when executed by the at least one processor individually or collectively, further cause the electronic device to:
based on identifying that no subsequent voice input is received for a specified period from a time when the first voice input is received, determine whether the at least one condition for outputting the first response is satisfied, and
based on the at least one condition for outputting the first response being satisfied, output the first response associated with the first voice input.

5. The electronic device of claim 1, wherein the instructions, when executed by the at least one processor individually or collectively, further cause the electronic device to:
from before receiving the first voice input to after receiving the first voice input, identify a continuous gaze of the user toward the screen of the display, and
while identifying the continuous gaze of the user toward the screen of the display, based on identifying that no subsequent voice input is received for a specified period from a time when the first voice input is received, output the first response associated with the first voice input.

6. The electronic device of claim 1, wherein the instructions, when executed by the at least one processor individually or collectively, further cause the electronic device to:
based at least on the conversation mode being activated, activate the camera, and
based on the conversation mode being deactivated, deactivate the camera.

7. The electronic device of claim 1, wherein the at least one condition for outputting the first response includes identifying a name assigned to the voice agent in the first voice input.

8. The electronic device of claim 1, wherein the instructions, when executed by the at least one processor individually or collectively, further cause the electronic device to:
in an image acquired using the camera, set a point corresponding to eye(s) of the user as a tracking point,
by tracking a position of the tracking point corresponding to the eye of the user, identify the gaze of the user, and
based on identifying another gaze of a person other than the user, ignore the other gaze.

9. The electronic device of claim 1, wherein the at least one condition for outputting the first response includes identifying a first distance between the electronic device and the user being greater than or equal to a reference distance.

10. The electronic device of claim 1, further comprising:
at least one sensor configured to identify an orientation and/or a movement of the electronic device,
wherein the instructions, when executed by the at least one processor individually or collectively, further cause the electronic device to:
using a sensing value of the at least one sensor, identify a positioning state of the electronic device,
wherein the positioning state includes a floor state in which a back surface of the electronic device is placed substantially parallel to a floor surface, a standing state in which the back surface is placed at a certain angle with respect to the floor surface, and a handheld state in which the electronic device is held by a user,
wherein the at least one condition for outputting the first response includes, in the floor state, identifying whether a first condition of whether the first voice input includes switching information causing an operation mode of the conversation mode to be switched is satisfied,
wherein the at least one condition for outputting the first response includes, in the standing state, identifying whether the first condition or a second condition regarding a gaze direction of a user is satisfied, and
wherein the at least one condition for outputting the first response includes, in the handheld state, identifying whether the first condition, the second condition, or a third condition regarding a first distance between the electronic device and the user is satisfied.

11. The electronic device of claim 10, wherein the instructions, when executed by the at least one processor individually or collectively, further cause the electronic device to:
based on identifying the standing state or the handheld state, obtain, by activating the camera of the electronic device, image data necessary for determining the second condition, and
based on a transition to the floor state, failure of tracking the gaze direction, or a termination of the conversation mode, deactivate the camera.

12. The electronic device of claim 10, wherein the instructions, when executed by the at least one processor individually or collectively, further cause the electronic device to:
based on identifying the handheld state, perform measuring the first distance between the electronic device and the user, and
based on a transition to the floor state or the standing state, or a termination of the conversation mode, stop measuring the first distance.

13. The electronic device of claim 7, wherein the instructions, when executed by the at least one processor individually or collectively, further cause the electronic device to:
based on identifying a second event causing entry into a group mode in which multiple users participate in a conversation, enter the group mode,
identify an input for names corresponding to the multiple users to assign the names respectively corresponding to the multiple users in the group mode, and
in the group mode, based on identifying at least one of the names corresponding to the multiple users in the first voice input, receive the second voice input subsequent to the first voice input, rather than outputting the first response.

14. The electronic device of claim 1, wherein the instructions, when executed by the at least one processor individually or collectively, further cause the electronic device to:
identify a gesture of the user using the camera,
while the gaze toward the screen of the display is not identified, based on the gesture being a first gesture, output the first response associated with the first voice input,
while the gaze toward the screen of the display is not identified, based on the gesture being a second gesture, receive the second voice input subsequent to the first voice input, rather than outputting the first response, and
while the gaze toward the screen of the display is not identified, based on the gesture being a third gesture, terminate the conversation mode.

15. The electronic device of claim 1,
wherein the electronic device includes a foldable device, and
wherein the instructions, when executed by the at least one processor individually or collectively, further cause the electronic device to:
in a group mode in which multiple users participate in a conversation, identify a first gaze direction of a first user using a first camera of the electronic device,
in the group mode, identify a second gaze direction of a second user using a second camera of the electronic device,
identify a first utterance of the first user in the voice inputs,
while the first utterance is identified, based on the first gaze direction being directed toward the screen of the display, output a response associated with the first utterance, and
while the first utterance is identified, ignore information about the second gaze direction of the second user.

16. The electronic device of claim 9, wherein the instructions, when executed by the at least one processor individually or collectively, further cause the electronic device to:
establish a communication connection between the electronic device and a wearable device via communication circuitry of the electronic device,
obtain voice data for an utterance of the user from the wearable device,
identify a second distance between the wearable device and the user,
based on the first distance being greater than or equal to the reference distance and the second distance being greater than or equal to the reference distance, output a response associated with the voice data, and
based on the first distance being greater than or equal to the reference distance and the second distance being less than the reference distance, receive a subsequent voice input, rather than outputting the response associated with the voice data.

17. The electronic device of claim 1, wherein the instructions, when executed by the at least one processor individually or collectively, further cause the electronic device to:
in an image acquired using the camera of the electronic device, set a point corresponding to a mouth of a user as a tracking point,
identify a movement of the mouth of the user by tracking a position of the tracking point corresponding to the mouth of the user, and
ignore voice inputs identified while the movement of the mouth of the user is not identified.

18. The electronic device of claim 1,
wherein the instructions, when executed by the at least one processor individually or collectively, further cause the electronic device to:
control a display of the electronic device to display a button for obtaining an input, and
wherein the at least one condition for outputting the first response includes identifying the input through the button.

19. A method performed by an electronic device, the method comprising:
operating in a conversation mode in which a voice agent executed by the electronic device interacts with voice inputs received through a microphone;
after receiving a first voice input, identifying whether at least one condition for outputting a first response associated with the first voice input is satisfied;
based on the at least one condition for outputting the first response being satisfied, outputting the first response associated with the first voice input; and
based on the at least one condition for outputting the first response not being satisfied, receiving a second voice input subsequent to the first voice input, instead of outputting the first response,
wherein the at least one condition for outputting the first response comprises identifying that a gaze of a user of the electronic device, obtained using a camera, moves toward a screen of a display.

20. One or more non-transitory computer-readable storage media storing one or more computer programs including computer-executable instructions that, when executed by one or more processors of an electronic device individually or collectively, cause the electronic device to perform operations, the operations comprising:
operating in a conversation mode in which a voice agent executed by the electronic device interacts with voice inputs received through a microphone;
after receiving a first voice input, identifying whether at least one condition for outputting a first response associated with the first voice input is satisfied;
based on the at least one condition for outputting the first response being satisfied, outputting the first response associated with the first voice input; and
based on the at least one condition for outputting the first response not being satisfied, receiving a second voice input subsequent to the first voice input, instead of outputting the first response,
wherein the at least one condition for outputting the first response comprises identifying that a gaze of a user of the electronic device, obtained using a camera, moves toward a screen of a display.
